(19) United States
(12) Patent Application Publication
(10) Pub. No.: US 2026/0205339 A1
(43) Pub. Date: Jul. 16, 2026

(54) SBFD SRS

(71) Applicant: Fraunhofer-Gesellschaft zur Foerderung der angewandten Forschung e.V., Munich (DE)

(72) Inventors: Thomas WIRTH, Berlin (DE); Priyanka DEY, Berlin (DE); Thomas HAUSTEIN, Berlin (DE)

(21) Appl. No.: 19/429,507

(22) Filed: Dec. 22, 2025

(30) Foreign Application Priority Data
Dec. 20, 2024 (EP) 24222428.5

(51) Int. Cl. H04L 27/26; H04B 7/06; H04L 5/00

(52) U.S. Cl. CPC H04L 27/261; H04B 7/0626; H04L 5/0005

(57) ABSTRACT

Disclosed is a transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources. The transceiver device is to operate based on an association between a sounding reference signal, SRS, transmitted by the transceiver device and a first reference signal.

### CROSS-REFERENCE TO RELATED APPLICATIONS

This application claims priority from European Patent Application No. 24222428.5, which was filed on Dec. 20, 2024, and is incorporated herein in its entirety by reference.

Embodiments of the present application relate to the field of wireless communication, and more specifically, to enhancing wireless communication in the field of wireless communication networks. Aspects of the present invention relate to apparatus and methods for enhancements related to SRS.

### BACKGROUND OF THE INVENTION

FIG. 1 is a schematic representation of an example of a terrestrial and/or non-terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards, e.g., 6G. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure.

FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UEs is shown in cell 106₄ which is served by base station gNB₄. The arrows 108₁, 108₂ and 108₃ schematically represent uplink/downlink connections for transmitting data from a user UE₁, UE₂ and UEs to the base stations gNB₂, gNB4 or for transmitting data from the base stations gNB₂, gNB₄ to the users UE₁, UE₂, UE₃.

Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UEs as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(b) by the arrows pointing to “core”. The core network 102 may be connected to one or more external networks. Further, some or all of the respective base station gNB₁ to gNB₅ may connected, e.g., via the S1 or X2 interface or the Xn interface in NR, with each other via respective backhaul links 116₁ to 116₅, which are schematically represented in FIG. 1(b) by the arrows pointing to “gNBs”. Embodiments described herein are not limited to terrestrial networks, TNs, but relate also to networks being implemented, at least in parts, as non-terrestrial network, NTN, as shown in FIG. 1 with reference to a satellite S₁ that may operate, for example, to bridge communication between different base stations, to serve one or more UE and/or a cell on the ground, e.g., as a non-terrestrial base station, to communicate with a different satellite.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard or a 6G standard.

The wireless network or communication system 100 depicted in FIG. 1 may by a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above-described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

Therefore, the device described in this disclosure may be a UE, wherein the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, a reduce capability device, RedCap, machine type communication UE, MTC-UE, mobile termination of an IAB-node, MT-IAB, a relay, a relay UE, a remote UE, a terrestrial UE, a non-terrestrial UE, NTN-UE, e.g., a plane, a high-altitude platform, a drone, or a spectrum controller, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, station (STA), access point (AP), node or mesh node, or mesh point, or Mesh AP, or any sidelink capable network entity.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

In an in-coverage scenario in which two UEs directly communicating with each other are both connected to a base station, the base station gNB has a coverage area which, basically, corresponds to the cell schematically represented in FIG. 1. The UEs directly communicating with each other may be both in the coverage area of the base station gNB. Both UEs are possibly connected to the base station, e.g., a gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

In an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. UEs may directly communicate with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the out-of-coverage scenario does not necessarily mean that the respective mode 2 UEs (in NR) or mode 4 UEs (in LTE) are outside of the coverage of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area, in addition to the NR mode 1 or LTE mode 3 UEs also NR mode 2 or LTE mode 4 UEs are present.

Naturally, it is also possible that one of the UEs is covered by the gNB, i.e. connected with Uu to the gNB, wherein the second UE is not covered by the gNB and only connected via the PC5 interface to the first UE, or that the second vehicle is connected via the PC5 interface to the first vehicle UE but via Uu to another gNB.

With an increase of an amount of communication and with an increase of requirements, flexibility of communication is an important issue for wireless communication allowing to adapt to specific needs and to increase an overall efficiency.

There is, thus, a need to improve wireless communications.

It is noted that the information in the above section is only for enhancing the understanding of the background of the invention and therefore it may contain information that does not form conventional technology and is already known to a person of ordinary skill in the art.

### SUMMARY

An embodiment may have a transceiver device such as a user equipment, UE, configured for operating in a wireless communication network providing a plurality of time resources in a time-frequency grid, the plurality of time resources including a first subset of time resources being sub-band full duplex, SBFD, time resources and a second subset of time resources being non-SBFD time resources; wherein the transceiver device is to operate based on an association between a sounding reference signal, SRS, transmitted by the transceiver device and a first reference signal.

Another embodiment may have a transceiver device such as a user equipment, UE, configured for operating in a wireless communication network providing a plurality of time resources in a time-frequency grid, the plurality of time resources including a first subset of time resources being sub-band full duplex, SBFD, time resources and a second subset of time resources being non-SBFD time resources; wherein the transceiver device is to transmit a sounding reference signal, SRS; wherein the transceiver device includes a plurality of antenna elements to perform a MIMO layer transmission, e.g., when SRS usage is beamManagement and/or wherein the transceiver device is to maintain different sounding reference signal, SRS, resource sets and to simultaneously transmit a plurality of SRS, each SRS being from a different SRS resource set.

According to another embodiment, a method for operating a transceiver device such as a user equipment, UE, in a wireless communication network providing a plurality of time resources in a time-frequency grid, the plurality of time resources including a first subset of time resources being sub-band full duplex, SBFD, time resources and a second subset of time resources being non-SBFD time resources, may have the steps of: operating the transceiver device based on a spatial relation between the SRS and
a second reference signal or
a second reference signal being the first reference signal or a different reference signal.

### BRIEF DESCRIPTION OF THE DRAWINGS

Embodiments of the present invention will be detailed subsequently referring to the appended drawings, in which:

FIG. 1a-b shows a schematic representation of an example of a wireless communication system;

FIG. 2 shows a schematic representation of a wireless communication system comprising a transceiver, like a base station or a relay, and a plurality of communication devices, like UEs, according to an embodiment;

FIG. 3 shows a schematic representation of a resource allocation for SBFD and non-SBFD slots according to a first configuration in a wireless communication network, according to embodiments;

FIG. 4 shows a schematic representation of a resource allocation for SBFD and non-SBFD slots according to a second configuration in a wireless communication network, according to embodiments;

FIG. 5 shows a schematic representation of a resource allocation for SBFD and non-SBFD slots in a wireless communication network, according to embodiments;

FIG. 6 shows a schematic representation of an association between a reference signal and SRS in a wireless communication network, according to embodiments;

FIG. 7 shows a schematic representation of an association between a reference signal and a plurality of SRS occasions in a wireless communication network, according to embodiments;

FIG. 8 shows a schematic representation of another association between a reference signal and a plurality of SRS occasions in a wireless communication network, according to embodiments;

FIG. 9 shows a schematic representation of an association between a reference signal, which is repeated, and SRS in a wireless communication network, according to embodiments;

FIG. 10 shows a schematic representation of another association between a reference signal, which is repeated, and SRS in a wireless communication network, according to embodiments;

FIG. 11 shows a schematic representation of an indication of link direction for SBFD symbols in a wireless communication network, according to embodiments;

FIG. 12 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals or namings even if occurring in different figures.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

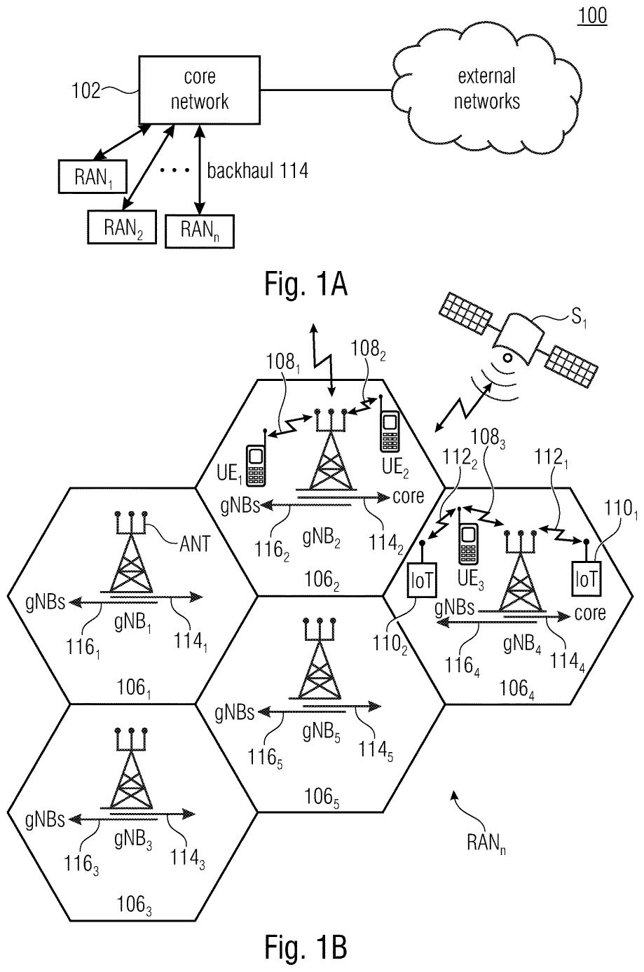

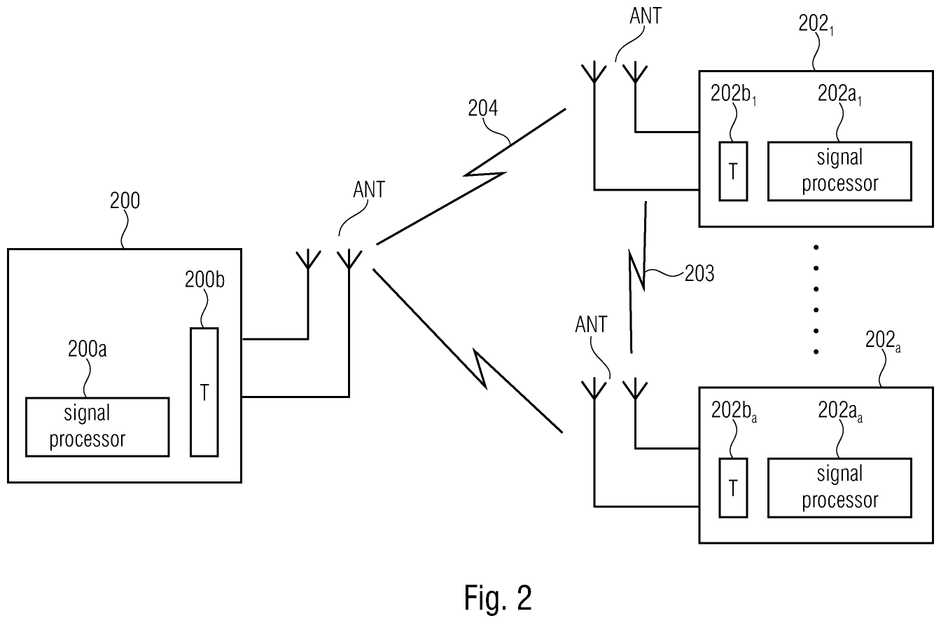

Embodiments of the present invention may be implemented in a wireless communication system or network as depicted in FIG. 1 including a transceiver, like a base station, gNB, or relay, and a plurality of communication devices, like user equipment's, UEs. FIG. 2 is a schematic representation of a wireless communication system comprising a transceiver 200, like a base station or a relay, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the Uu interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

A base station (BS) capable of subband full duplex (SBFD) can perform uplink (UL) and downlink (DL) in the same time resources but different frequency resources known as subbands (SBs). The user equipment (UE) in the network is half duplex (HD) capable. The UE is configured with UL and DL SBs to perform either DL or UL at a time. The number of frequency domain DL/UL resources in a symbol configured with SBs (SBFD symbol) is smaller as compared to the number of frequency domain DL/UL resources in a symbol not configured with these SBs (non-SBFD symbol) for the same bandwidth due to sharing of DL and UL resources in frequency domain in the SBFD symbols. Further, the interference profile of the SBFD symbols is also different as compared to the non-SBFD symbols due to the presence of Cross Link Interference (CLI). In New Radio (NR) technology, there are various signals or channels which are periodic or repetitive in nature. These are in general configured by the BS or gNB in a way that parameters like frequency domain resource allocation and modulation order are provided same for all the occasions of the signal/channel. With SBFD enabled in the network, these parameters will be same across SBFD and non-SBFD symbols. However, as stated above, the number of resources, interference profile etc., are different for SBFD and non-SBFD symbols. Hence, using the same parameters is not an efficient way of implementing SBFD. Legacy procedures should be enhanced specific to SBFD to handle such cases and implement SBFD in an efficient way.

Subband full duplex (SBFD) is a technique using which a wireless communication node can perform transmission and reception simultaneously in the time domain but in different frequency resources within the same band. The separate frequency resources for transmission and reception are known as subbands (SBs). E.g., a gNB or a base station (BS) in New Radio (NR) technology capable of SBFD is able to perform uplink (UL) and downlink (DL) at the same time but in different SBs which are non-overlapping with each other. The user equipment (UE) can be half duplex (HD) capable, that is it performs UL and DL in orthogonal time frequency resources.

Note, that a physical resource block, PRB, related to the actual transmitted signal, which may be located relative to a reference point A on a given resource grid. For this, the reference point A coincides with subcarrier 0 of common resource block, CRB, 0 for all subcarrier spacings. The resource grid may consist of a number of subcarriers, e.g., 12 subcarriers in frequency domain, and a number of OFDM symbols in time domain. In general, a PRB is defined by a start subcarrier, a number of subcarriers, and a subcarrier spacing, defined by the numerology. The numerology sets the subcarrier spacing and is defined per bandwidth part, BWP. The resource blocks are aligned across numerologies, such that two resource blocks at a subcarrier spacing s, occupy the same frequency range as one resource block at a subcarrier spacing of 2s. Furthermore, we may use resource block and physical resource block interchangeably. Finally, also the term virtual resource block, VRB, may be used, which contain the modulation symbols that are mapped to the PRBs in the bandwidth parts used for transmission. Note that VRBs may be mapped interleaved or non-interleaved to the PRBs, depending on the configuration.

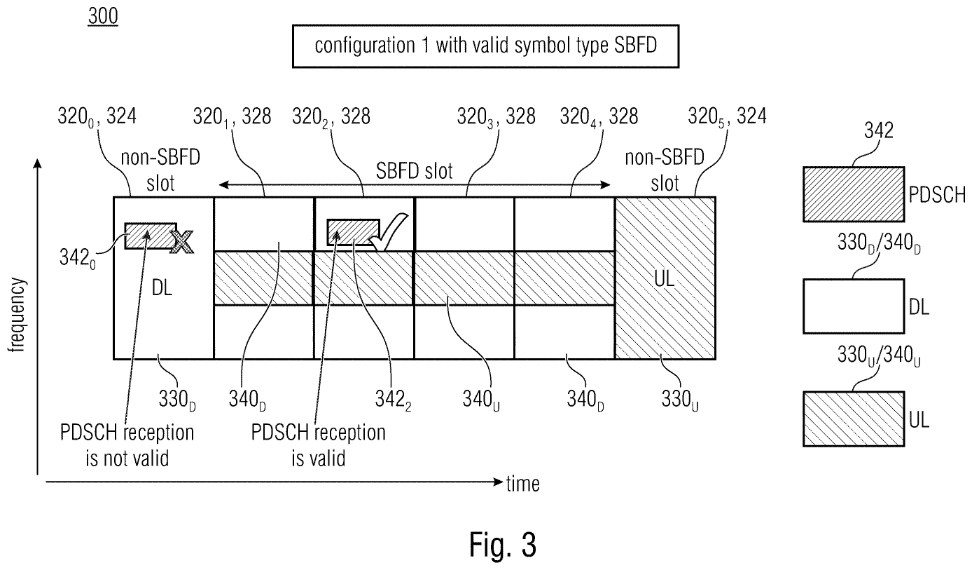

The discussion on implementation of SBFD at the gNB in NR with HD UEs in the network was initiated during the Release 18 Study Item phase. In Release 19, the Work Item Phase was initiated with the objective of discussing enhancements at the gNB and the user equipment (UE) side for the implementation of SBFD. FIG. 3 shows, in addition to non-SBFD configurations, an SBFD configuration in time and frequency domain. Slot 0 is a DL slot, slots 1-4 are SBFD slots and slot 5 is an UL slot. D and U are DL and UL respectively. The SBFD slots shown in FIG. 3 have the configuration of DUD, where D is the DL SB and U is the UL SB. The frequency domain configuration can also be, for example, UDU instead of DUD. In this illustration, the slot is said to be SBFD since all the symbols in the slot have DL and UL SBs. A symbol will be called an SBFD symbol if it is configured with DL and UL SBs. Optionally, there may be a guard band in between the D and U SBs to mitigate the effect of interference from the UL SB to the DL SB. The presence of the guard band may depend on the implementation at the gNB and/or UE. Thus, any slot/symbol which has the DL and UL SBs configured in frequency domain are known as the SBFD slots/symbols. Similarly, the only DL slot (slot 0) and the only UL slot (slot 5) are known as the non-SBFD slots since they are not configured with SBs.

FIG. 3 exemplary depicts a schematic representation 300 of a provision of a plurality of time resources in a time-frequency grid in a wireless communication network, in accordance with embodiments. Here, in a time-frequency grid, the horizontal direction denotes the time domain and the vertical direction denotes the frequency domain.

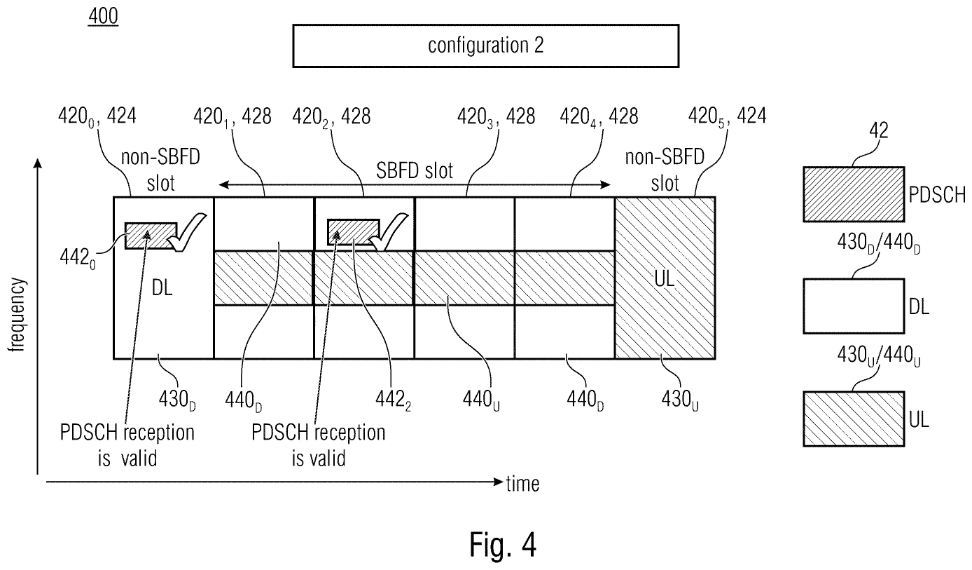

FIG. 4 exemplary depicts another schematic representation 300 of a provision of a plurality of time resources in a time-frequency grid in a wireless communication network, in accordance with embodiments. Here, in a time-frequency grid, the horizontal direction denotes the time domain and the vertical direction denotes the frequency domain.

In particular, FIGS. 3 and 4 exemplary depict a plurality of time resources as a plurality of time slots 320₀₋₅, 420₀₋₅, that is slots numbered from 0 to 5 for wireless communication in the wireless communication network. The time slots 320_{#}, 420_{#} are shown to have equal slot lengths (e.g., or slot duration). For example, each of the time slots 420_{#} may comprise a plurality of symbols usable, or configurable (or e.g., available) for wireless communication in the wireless communication network.

The time slots may each be allocated a portion or a part of available frequency resources (e.g., available frequency spectrum or available bandwidth). For instance, the time slots may be associated with a resource block, RB, or a frequency unit comprising a plurality of subcarriers. According to embodiments, a frequency resource may be one or more of: a channel, system bandwidth, a subchannel, a subband, a bandwidth part, BWP, a component carrier, CC, one or more subcarriers, a physical resource block, PRB, a fixed or variable amount of bandwidth and a fixed or varying frequency or location in a frequency grid, one or more pairs or sets of frequency resources, and a frequency core. For example, the fixed or variable amount of bandwidth and a fixed or varying frequency may be related to hopping across the frequency grid on consecutive time resources. For example, the one or more pairs or sets of frequency resources may be used in the same or different time resources.

In accordance with embodiments, a plurality of time resources 320₀₋₅, 420₀₋₅ comprise a first subset of time resources 320₁₋₄, 420₁₋₄ being sub-band full duplex, SBFD, time resources 328, 428 and a second subset of time resources 320_{0,5}, 420_{0,5} being non-SBFD time resources 324, 424. That is, the first subset of time resources 320₁₋₄, 420₁₋₄ may be time slots or time resources which are associated with one or more bands configured for signalling or communicating in more than one specific link direction (e.g. UL as well as DL). For example, the time slots 320₁₋₄, 420₁₋₄ are each associated with the plurality of subbands 440 which may be used for uplink, UL, as well as for downlink, DL.

As exemplary shown in FIGS. 3 and 4, each of the SBFD time resources 320₁₋₄, 420₁₋₄ each comprise the plurality of sub-bands 340, 440 in a DUD configuration (indicated here in the order of increasing frequency). Thus, the plurality of subbands within a single time slot 328, 428 allow, or enable, for a full-duplexing configuration for communication in the wireless communication network. The plurality of subbands 340, 440 may be a portion (or e.g., a smaller portion, a sub-portion or a slice) of the band 330, 430 in the frequency-domain. Although a plurality of subbands could be overlapping, these are shown to be non-overlapping (e.g., orthogonal) in FIGS. 3 and 4.

Further, a second subset of the time resources, or time slots, 320_{0,5}, 420_{0,5} may be associated with band 324, 424 configured for signalling or communication in one specific link direction. For example, the time slot 0 may be associated with a band 330_{D}, 430_{D} that may be used for downlink and the time slot 5 may be associated with a band 330_{U}, 430_{U} that may be used for uplink, UL, depicted in FIGS. 3 and 4.

In particular, FIG. 3 depicts a scenario in which, according to a first configuration, (e.g., configuration 1) a transceiver device (e.g., UE) restricts communication to a specific type. This specific type may be one of a first type and a second type or further types of communication from a set of types of communication (e.g, wherein the set of types of communication may be associated with, e.g., configuration 1 and configuration 2 depicted in FIGS. 3 and 4 respectively) available to, or configurable by, the transceiver device. In FIG. 3, this specific type of communication relates to signalling or communication being valid for a valid symbol type for the first subset of time resources 320₁, 320₂, 320₃, 320₄.

In particular, FIG. 4 depicts a scenario in which, according to a second configuration, (e.g., configuration 2) a transceiver device (e.g., UE) restricts communication to one or more specific types. The one or more specific types may comprise, or encompass, both a first type and a second type, or at least two or more of further types of communication from a set of types of communication (e.g, wherein the set of types of communication may be associated with, e.g., configuration 1 and configuration 2 depicted in FIGS. 3 and 4 respectively) available to, or configurable by, the transceiver device. In FIG. 4, the one or more specific types of communication relate to signalling or communication being valid for a valid symbol type for the first subset of time resources 420₁₋₄ and being valid for another valid symbol type for the second subset of time resources 420_{0,5}.

The transceiver device (e.g., UE) operates according to: the first configuration (e.g. configuration 1 as exemplarily depicted in FIG. 3) or the second configuration (e.g. configuration 2 as exemplarily depicted in FIG. 4) or further types of configurations from a set of types of configurations (e.g, wherein the set of types of configurations may comprise, e.g., configuration 1 and configuration 2 depicted in FIGS. 3 and 4 respectively) available to, or configurable by, the transceiver device, based on a received message and/or based on a determination result obtained by the transceiver device (e.g., UE). That is, either the message or the determination result or both the message and the determination result may be involved, or used, or be a basis for the transceiver device operate according to a configuration.

For example, the received message may be signalled or communicated from a base station. For example, the determination result may comprise one or more of wireless symbol type being provided to the transceiver device. That is, the transceiver device operates according to the first or the second configuration or the further types of configurations based on the determination result, wherein the determination result may be derived from a valid symbol type being valid for the time resource. For example, the configuration 1 in FIG. 3 relates to the valid symbol type being SBFD. This means that the transceiver device (e.g., UE) may transmit or receive a signal or channel in SBFD symbols or SBFD slots 328, 428. For example, the transceiver device (e.g. UE) may transmit or receive a signal or channel only or exclusively in SBFD symbols or SBFD slots 328, 428. In this regard, the SBFD symbol is the valid symbol type for configuration 1 as shown and, therefore, the transceiver device operates according to the first configuration wherein the communication in the wireless communication network is restricted to the first subset of time resources 320₁₋₄, 420₁₋₄ as being SBFD time resources. The alternative where the transceiver device may transmit or receive a signal or channel only or exclusively in non-SBFD resources or non-SBFD symbols or non-SBFD slots 324, 424 is also feasible.

As exemplary depicted in FIG. 3, the PDSCH reception 342₀ is not valid in the first time slot 320₀ belonging to the second subset of time resources being non-SBFD time resources. In contrast to the PDSCH reception 342₀, the PDSCH reception 342₂ is valid in a third time slot 320₂ (e.g., an SBFD slot 328) belonging to the first subset of time resources being SBFD time resources.

FIG. 4 exemplary depicts a second configuration wherein the transceiver device (e.g., UE) uses both the first subset of time resources (i.e., SBFD) and the second subset of time resources (i.e., the non-SBFD time resources) for communication within the wireless communication network. Thus, as shown in FIG. 4, the PDSCH reception 442₀ is valid in a first time slot 420₀ among the plurality of time resources 420₀₋₅ and the PDSCH reception 420₂ is valid in the third time slot 420₂ among the plurality to time resources in the time-frequency grid. That is, in accordance with configuration 2 or the second configuration, signals or channels in both symbol types SBFD and non-SBFD symbols may be valid within the time slot or across one or more time slots.

As explained earlier, the operation of the transceiver device according to the first configuration or the second configuration may be based on a received message or communication or signalling from another entity such as a base station and/or based on a determination result obtained by the transceiver device itself. For example, for configuration 2 schematically represented in FIG. 4, the determination result may comprise SBFD symbol type being valid as well as non-SBFD symbol type being valid for the PDSCH reception 442_{0,2}. Additionally or alternatively, the determination result may be derived based on a measurement performed by the transceiver device (e.g., UE).

In accordance with embodiments, and as instanced in FIGS. 3 and 4, it may be that the transceiver device is adapted to implement one of the first and second configurations, that is, one of the configuration 1 and configuration 2, for a downlink, DL. Additionally, or alternatively, in accordance with embodiments, the transceiver device may be adapted to individually implement one of the first and second configurations, that is, one of the configuration 1 and configuration 2, for an uplink, UL.

In accordance with embodiments, the transceiver device may report a selected first configuration or a selected second configuration, or parameters thereof, to one or more of: a base station, a network entity such as a core network function, CNF, or another transceiver device, or UE.

In accordance with embodiments, the transceiver device may reject, or not make a selection of, a first configuration or a second configuration such as the configurations depicted in FIGS. 3 and 4 and report this to one or more of: a base station, a network entity such as a core network function, CNF, or another transceiver device, or UE.

In this regard, in accordance with embodiments, one or more configurations implemented for the DL is provided with the transceiver device or the one or more configurations are determined as part of the determination result per DL bandwidth part, BWP. Additionally, or alternatively, the one or more configurations implemented by the UL may be provided with a transceiver device or the one or more configurations may be determined as part of the determination result per UL BWP. For example, the one or more configurations implemented for the DL/UL or determined as part of the determination result per DL/UL BWP may be based on a radio resource configuration, RRC. Further, the configuration, or the one or more configurations, may indicate a valid symbol type per DL BWP. Additionally or alternatively, the configuration, or the one or more configurations may indicate a valid symbol type per UL BWP.

The transceiver device may implement or determine the configuration, or the one or more configurations, independent from one or more of a frequency resource or a signal. It may be that the transceiver device implements or determines a further configuration per one or more of a frequency resource, per signal, response on a request, or where the condition is met or threshold passed. For example, the condition or the threshold may relate to a conditional configuration change, CCC.

In accordance with embodiments, the transceiver device may select either the first configuration or the second configuration or the transceiver device may be configured to not select either the first configuration or the second configuration. This means that the transceiver device may be restricted to not use, or make use of one of the configurations or the set of the configurations available to the transceiver device based on a criterion. In other words, a selection, or a lack thereof, of a configuration from, or among, the set of configurations available, or operable, or usable, or configurable by the transceiver device may be conditioned on a criterion. For example, in accordance with embodiments, the criterion could be one or more of: a channel condition, a condition based on a measurement, a position of the transceiver device, a QoS criterion, a capability of a transceiver device, a condition based on a threshold (or e.g., a measurement threshold) and a condition based on assistance information received or transmitted by the transceiver device. It may be that the channel condition or the criterion based on a measurement may relate to SNR, interference, RSRP, RSSI, RSRQ, ACLR, cross-link interference, CLI, or the like.

For example, the position of the transceiver device may correspond to a geo-location or zone within the cell of the wireless communication network that the transceiver device operates in. For example, the QoS criterion may relate to packet delay, PDB, or latency requirement such as URLLC requirement or a reliability criterion. For example, the criterion being based on a threshold may comprise the criterion being based on a received signal strength or from a base station, CLI, SINR, with interference coming from another base station or from another UE. For example, the criterion may be based on assistance information wherein the assistance information comprises information received by a base station, BS, or information received from another UE, or transceiver device.

In regard to the valid symbol type being SBFD in configuration 1 and the valid symbol type being SBFD and non-SBFD in configuration 2, a valid symbol type being valid for the time resource may be explicitly configured or pre-configured by the transceiver device. Alternatively, the transceiver device may use a symbol type, e.g., either SBFD or non-SBFD as default for the valid symbol type being valid for the time resource.

This means that, for example, the valid symbol type being SBFD in configuration 1 may be explicitly configured or pre-configured or may be the default valid symbol type for the time resource. In configuration 2, for example, the valid symbol type being SBFD as well as non-SBFD may also be either explicitly configured or pre-configured or may be the symbol types used as default. The valid symbol type or valid symbol types may be signalled by another device such as a base station, or a network entity such as a core network CN, or another UE for transceiver device. Further, in accordance with embodiments, the valid symbol type may be configured by a particular type of signalling, or a certain type of signalling, using one or more of the following: a higher layer, RRC, such as RRC IEs, MAC-CE, PHY such as via downlink, DCI, uplink, UCI, or sidelink, SCI, control information. For example, the signalling as a particular type or as a certain type, may be a certain cast type, e.g., unicast, groupcast, multicast, or broadcast.

In accordance with embodiments, the threshold, such as a measurement threshold, based on which a selection of a configuration in which the transceiver device may operate may comprise one or more of a configured and/or pre-configured signalling, may be based on a measurement performed or carried out by the transceiver device, or the threshold could be based on a determination of an SINR headroom. For example, it may be that the configured and/or preconfigured signalling may be signalling or communication received from a base station or from another transceiver device such as a UE. For example, the SINR headroom may refer to the SINR headroom at the UE, e.g., in downlink or it may refer to SINR headroom at the base station, e.g., in uplink. The configuration 1 and 2 exemplarily depicted in FIGS. 3 and 4 are simply examples of a set of configurations that the transceiver device may operate and thus, the first configuration and/or second configuration may be one or more of configured instructions or signalling by the transceiver device, or the first configuration and/or second configuration may be one or more of pre-configured signalling or instruction, or they could be determined based on a capability of the transceiver device.

In accordance with embodiments, the transceiver device may be configured with the method, or the received method, received by the transceiver device from at least one of a base station, a network, another UE, and an over the top communication or signalling mechanism.

Although in FIGS. 3 and 4 the plurality of time resources have been depicted to be time slots, a time resource may be one or more of, or at least one of, an absolute time, a symbol, a slot, a subframe, a radio frame, and a hyperframe. For example, the absolute time may comprise a time duration of 13 or 28 milliseconds. For example, a symbol may be an OFDM symbol. For example, the slot may refer to or comprise 14 OFDM symbols or sub-slots, or half-slots, or mini-slots.

In accordance with embodiments, the transceiver device may be adapted to execute time resource measurements. The time resource measurement may be based on a counting of a time resource, for example, slot counting, or any time resource operable or configurable by the transceiver device. For example, as exemplarily depicted in FIGS. 3 and 4, the time resource measurement executed by the transceiver device may be based on counting of SBFD time slots and non-SBFD time slots. That is, the time resource measurement may be based on counting (or e.g. grouping) of time resources.

FIGS. 3 and 4 exemplarily depict the first configuration (i.e., configuration 1) and the second configuration (i.e., configuration 2) respectively. In addition or as an alternative to these scenarios, the transceiver device may be configured or pre-configured with a default configuration, wherein the default configuration may be the first configuration, or the second configuration, or a configuration supported by its capability.

Additionally or alternatively, in accordance with embodiments, the transceiver device may be configured to change, or override, configurations, such as configurations 1 and 2 exemplarily shown in FIGS. 3 and 4. For example, the transceiver device may be configured to change or override the default configuration. Further, for example, the transceiver device may be configured to change or override the configuration based on a configuration previously received. For example, the transceiver device may change or override the configuration to the first configuration or to the second configuration. That is, in the case where the transceiver device was previously configured with a second configuration, the transceiver device may change or override the configuration to be the first configuration, or in case the transceiver device was previously configured with the first configuration, the transceiver device may change or override the configuration to be the second configuration. For example, this change or overriding of the said configuration may depend on communication or signalling received from a base station or from another transceiver device such as a UE, or the network.

According to embodiments, the transceiver device may determine that a valid symbol type has been provided and therefore may operate according to the first configuration, e.g., configuration 1, based thereon, or depending thereon. This determination that the valid symbol type is provided based on, or from, the message, e.g., received message, or the determination without. The valid symbol type being provided may either be common for DL and UL or it may be valid for DL/UL BWP or it may be provided per channel or signal. That is the valid symbol being provided may either be common for both downlink and uplink signalling or it may be provided for a bandwidth part related to the uplink and downlink signalling or it may be provided depending on the channel or signal received or transmitted.

In accordance with embodiments, in absence of a valid symbol type being provided with the transceiver device or that the valid symbol type may not be determined based on the determination result, the transceiver device may operate according to the second configuration. Therefore, the in the scenario where the provision of the valid symbol type to the transceiver device or its determination is not feasible, the transceiver device may use both the first subset of the time resources and the second subset of the time resources for communication in the wireless communication network.

When the valid symbol type, which is provided with the transceiver device or determined as part of, or based on, or using, the determination result, indicates both the first type and the second type of communication in the wireless communication network, the transceiver device may operate according to the second configuration, e.g., configuration 2 as depicted in FIG. 4. Alternatively, when the valid symbol type, which is provided to the transceiver device or determined as part of, based on, or using the determination without it, indicates both the first type and the second type of communication in the wireless communication network, the transceiver device may operate according to the first communication, e.g., configuration 1 as depicted in FIG. 3.

In accordance with embodiments, when the transceiver device comprises an incompatibility to operate according to the second configuration, a transceiver device may ignore a request to operate according to the second configuration. That is, the transceiver device may ignore requests to operate according to the second configuration based on an incompatibility, or a degree of incompatibility of the transceiver device with its operation in, or per, the second configuration. Alternatively, the transceiver device may ignore a request to operate according to the first configuration based on an incompatibility, or a degree of incompatibility, of the transceiver device with its operation according to, or, the first configuration. Thus, the determination result obtained by the transceiver device may comprise information relating to its incompatibility for an operation in either the first configuration or the second configuration. It may be, that the transceiver device either ignores the request to operate according to one of the first and second configurations, or selects the other of the first and the second configuration, based on which ever configuration the transceiver device is more compatible with, or less incompatible with.

On the FIGS. 3 and 4 exemplary depict a PDSCH reception 342, 442, details and explanations described in relation to the PDSCH signalling are transferable to other signalling(s) or communications type the transceiver device may be configured for. Therefore, in the following, some embodiments and details are described in relation to further signalling(s) or communications that the transceiver device may perform.

The transceiver device may determine the further configuration for channel-state information reference signals, CSI-RS in downlink. The further configuration may, for example, be a part of the first and/or second configuration or may be a different configuration from the first and second configuration altogether.

The transceiver device may determine the further configuration for sounding reference signals, SRS, for uplink transmission. The further configuration may, for example, be a part of the first and/or second configuration or may be a different configuration altogether from the first and the second configurations.

The transceiver device may determine the further configuration for sounding reference signals, SRS for cross-link interference, CLI, measurements. The further configuration may, for example, be a part of the first and/or second configuration or may be a different configuration altogether from the first and the second configuration. Although the transceiver device determining the further configuration has been described exemplary for CLI-RS in downlink, SRS for uplink, SRS for CLI measurements, the transceiver device may determine the further configuration for other signalling(s) or communication(s) it may be configured for.

The transceiver device may be configured for ignoring, or skipping, or not decoding, or not receiving, or dropping, or puncturing the further configuration per time- and/or frequency-resource or per signal. The ignoring, or skipping, or not decoding, or not receiving, or dropping, or puncturing the further configuration may be performed, for example, under a predefined condition. The transceiver device may not be expected to receive the further configuration per time resource and/or frequency resource or per signal. The expectation of the transceiver device not receiving the further configuration may, for example, be specified or carried out under a predefined condition. The transceiver device may override the configuration with the further configuration pre time and/or frequency resource or per signal. For example, the transceiver device may override the configuration with the further configuration under a predefined condition, or criterion.

In accordance with embodiments, the predefined condition, or criterion may be the transceiver device having configured and/or pre-configured configuration. For example, it may be that the transceiver device has a configured and/or pre-configured configuration per bandwidth part, BWP. For example, it may be that the transceiver device has a configured and/or pre-configured configuration for large frequency resources. For instance, the UE, or the transceiver device, may have a configuration per channel and does not require a configuration for a sub-channel. For example, the transceiver device may have a configured and/or pre-configured common configuration for both downlink, DL, and uplink, UL or DL and SL or UL and SL or DL and UL and SL.

In accordance with embodiments, the predefined condition, or criterion may be a power saving criterion or condition such as relating to the transceiver device performing DRX, or the predefined condition or criterion may be based on the capability of the transceiver device such as the transceiver device's (or, e.g. the UE's) reduced capability, RedCap, or that the transceiver device or the UE may not support a further configuration. The just-described predefined conditions or criterions may be combined with each other and therefore, the predefined condition or criterion may be at least one of the already described instantiations.

In accordance with embodiments, the further configuration may indicate a valid symbol type either per frequency resource or per signal. It may be that the further configuration indicates a valid symbol type even per time resource or in response to a request or when a condition is met such as a threshold having been met or passed.

In accordance with embodiments, the transceiver device may implement a pre-defined configuration as a default configuration in absence of or prior to a message and/or the determination result. This means that in case the message and/or the determination result may not be present, or obtainable, the transceiver device may implement the predefined configuration as a default configuration, or if the message and/or the determination result may not have been received, or obtained, the transceiver device then implements a pre-defined configuration as the default configuration. For example, the implementation of the predefined configuration as a default configuration may be conditioned to be carried out at a specific time period prior to the reception of the message and/or the obtainment of the determination result. For example, the specific time period may be pre-configured, or configurable by the transceiver device on signalling a communication within the wireless communication network. For example, the predefined configuration may be one of the first configuration and the second configuration.

The transceiver device may implement an indicated configuration, the indicated configuration being the predefined configuration or the predefined configuration being a default configuration of the transceiver device, based on the method (i.e., the method received by the transceiver device) or the determination result. For instance, the indicated configuration could be one of the first configuration and the second configuration, as exemplary depicted as configuration 1 and 2, respectively in FIGS. 3 and 4. Further, the transceiver device may ignore the indicated configuration based on the message and/or the determination result. For instance, it may be that the first configuration has a higher priority than the second configuration, therefore the transceiver device may ignore the second configuration based on the message indicating information that the first configuration may have a higher priority than the second configuration or vice versa. For example, it may be that the current first configuration or the current second configuration may have a higher priority and the transceiver device then may ignore the indicated configuration based on a message indicating a set information in regards to the first or second configuration having a higher priority than the first or the second configuration. For example, it may be that the transceiver device ignores the indicated configuration based on the determination result such as when the current first configuration or the current second configuration achieves a better performance. For instance, the current first configuration or the current second configuration may achieve a better performance with respect to QoS, such as throughput latency, package loss, bit error rate, BER, or the like. Thus, the transceiver device may ignore whichever configuration based on the determination result that achieves, or obtains, a worse performance, or is associated with worse performance, or efficiency, parameters, or metric.

Additionally, or alternatively, in the course of ignoring the indicated configuration (e.g., default configuration) it may be that the transceiver device temporarily deviates from the indicated configuration such as the default configuration and may return to the indicated configuration such as the default configuration based on the method or the determination result. That is, the transceiver device may perform a fallback operation, wherein it deviates or switches from the default configuration or the indicated configuration and may eventually return to the indicated configuration or the default configuration. For example, the transceiver device may implicitly determine when to return to the default configuration, or the indicated configuration, by applying a predefined amount of time or time resources, or a predefined number of transmissions or a predefined number of receptions. That is, the temporary deviation from the default or the indicated configuration performed by the transceiver device may be an implicit fallback. Alternatively, in accordance with embodiments, the transceiver device may explicitly determine when to return to the default configuration, or the indicated configuration, based on a reception of a respective signal, wherein the reception of the respective signal may be based on a predetermined event or a transmission success or a transmission failure. That is, the transceiver device may perform an explicit fallback in the course of deviating, or temporarily deviating, or temporarily switching off from the default, or indicated, configuration and then returning to the default, or indicated, configuration. For example, the transmission success and/or the transmission failure may relate to a predefined number of successful or unsuccessful transmissions, wherein the successful or the unsuccessful transmissions may be based on ACK and/or NACK. For example, the transmission success and/or the transmission failure may relate to a predefined number of successful or unsuccessful receptions, e.g., successful or unsuccessful receptions may be based on decoding errors or they may be generated based on not acknowledgement messages, NACK.

The transceiver device may perform a random access or an initial access, such as PRACH, to a network. Additionally, the transceiver device may: Not be connected to a base station such as in RRC_IDLE state, or be in RRC_INACTIVE state, or be in the state of performing the random access, or a pole of or a part of the random access procedure, such as waiting for a RACH response.

In the course of performing a random access or an initial access procedure, the transceiver device may receive the first configuration and/or the second configuration. For example, it may be indicated with the message or received message, i.e., the received message based on which the transceiver may operate according to the first or the second configuration, a broadcast channel, BCH, for performing the random access or the initial access procedure. For example, the indication that the transceiver device may receive the first and/or the second configuration as part of, or within, the received message may be carried out prior to performing the random access or initial access procedure. Additionally or alternatively, in the course of performing the random access or the initial access procedure, the transceiver device may be preconfigured with the first configuration or the second configuration, such as the capability. This means, for example, that the transceiver device may already have stored within either the first configuration or the second configuration which is communicated to the wireless communication network through capability information of the transceiver device. Additionally or alternatively, in the course of the transceiver device performing the random access or initial access procedure, the transceiver device may receive the first configuration or the second configuration. For example, this means that the transceiver device may receive a full configuration or an updated configuration being the first or the second configuration during the random access procedure. For example, the transceiver device may receive the first or the second configuration in four-step RACH via message 2, MSG 2, or message 4, MSG 4, or in two-step RACH via message B, MSG B.

Further, control messages and procedures may be associated with at least one of another band or another component carrier or another radio access technology, RAT. For example, a configuration message may come from an LTE component carrier, a non-stand-alone, NSA. Alternatively, it may be that the configuration message may be shared among UEs or transceiver devices via Bluetooth, BLE or WiFi, or that the configuration message may be retrieved from a server in the Internet via an appropriate air interface, e.g., WiFi or a satellite link, e.g., NTN, or a fixed wireless access, FWA, link.

Although FIGS. 3 and 4 exemplary depict signalling or communication of the transceiver device relating to a PDSCH reception 342, 424, details and explanations described so far in relation to the PDSCH reception 324, 424 may be transferred onto any other signalling or communication that the transceiver device may be configured for receiving or transmitting, such as PUSCH, CSI and reporting thereof, PUCCH, or the like. In this regard, further details of such signalling or communication with the transceiver device will be configured for are represented in more detail.

For example, the transceiver device may derive information related to a PDSCH 342, 442 signalling either from or based on the received message or the determination result. For instance, the transceiver device may derive the information related to the PDSCH signalling 342, 442 for one or more of DL BWP, UL BWP, channel. The PDSCH signalling 342, 442 may be PDSCH repetition (as exemplary depicted in FIGS. 3 and 4) or multi-PDSCH. For example, the PDSCH signalling 342, 442 may be provided in or derived from RRC IEs such as BWP, BWP-downlink, BWP downlink dedicated, BWP downlink common, PDSCH-Config, PDSCH-ConfigCommon, PDSCH-ServingCellConfig, ServingCellConfig, Serving Cell ConfigCommon, Serving Cell ConfigCommon SIV, Downlink ConfigCommon, SIB or CSI resource or CSI report related configurations.

Additionally or alternatively, the transceiver device may derive signal information related to a SPS PDSCH either from or based on the received message or the determination result. For example, the transceiver device may derive the signal information related to the SPS PDSCH for one or more DL BWP, UL BWP, or channel or the like. For example, the signal information related to a PDSCH may comprise a configuration being explicitly provided in SPS-Config. In addition, for example, the transceiver device may follow, or operate according to, the configuration explicitly provided in SPS-Config. Alternatively, the transceiver device may follow the configuration as provided in or derived from at least one of the aforementioned RRC IEs for PDSCH and the transceiver device may ignore the configuration explicitly provided in or derived from SPS-Config. For example, it may be that in the absence of an explicit configuration provided or derivable by the transceiver device, the transceiver device may follow the configuration according to the information related to the PDSCH signalling, as described earlier. It should be noted that SPS or semi-persistent scheduling may also be realized by providing configured grants, CG, and by providing a CG-Config, which may also be used to convey, or indicate, a link direction, which is to be used for transmission in a SBFD or non-SBFD slot or symbol or subframe or radioframe. That is, the provision of CG, such as a CG-Config or information related thereto, may indicate the link direction for signalling, or communication, using SBFD or non-SBFD resources, such as slots, symbols, subframes, or radioframes thereof.

The transceiver device may derive information related to channels and/or signals, e.g., a control signalling or data transmission, either from or based on the received message or the determination result. That is, the derived information could be related, or associated, with either one or more channels, or one or more signals, or one or more channels and one or more signals. For example, the one or more channels could be transport channels, such as DL-SCH, or UL-SCH. For example, the one or more signals could be at least one of: PDSCH, PDCCH, DM-RS (PDSCH DM-RS), PT-RS, HARQ_ACK, PUSCH, PDCCH, DM-RS (PUSCH DM-RS), SRS. For example, the transceiver device may derive the information related to the PUSCH signalling for one or more of DL BWP, UL BWP, channel and the like. For example, the PUSCH signalling may be provided in or derived from radio resource control information elements, RRC IEs, such as BWP, BWP-uplink, BWP-uplink dedicated, BWP-uplink Common, PUSCH-Config, PUSCH-ConfigCommon, PUSCH-ServingCellConfig, ServingCellConfig, ServingCellConfigCommon, ServingCellConfigCommon SIB, UplinkConfigCommon, UplinkConfigCommon SIB or from SRS related configurations.

The transceiver device may derive information related to a configure grant, CG, signalling either from or based on the received message or the determination result. The transceiver device may determine the information related to the configure grant signalling for one or more of DL BWP, UL BWP, frequency resources and the like. Further, the transceiver device may obtain a configuration explicitly provided in or derived from a ConfiguredGrantConfig information. That is, the information related to the configure grant, CG, which may have been derived by the transceiver device from the receive message or the determination result may comprise the ConfiguredGrantConfig information. Further, the transceiver device may follow, or operate according to, the configuration explicitly provided in or derived from ConfiguredGrantConfig. Alternatively, it may be that the transceiver device may follow, or operate according to, the configuration as provided in or derived from information related to a PUSCH and to ignore the configuration explicitly provided in or derived from ConfiguredGrantConfig. It may be that in absence of an explicit configuration being provided in or being derived from ConfiguredGrantConfig, the transceiver device may follow, or operate according to, a configuration provided in or derived from information related to PUSCH.

The transceiver device may be adapted to derive the configuration based on a CSI-RS resource. Additionally or alternatively, the transceiver device may be adapted to derive the configuration based on a CSI report. For example, the configuration may be derived by the transceiver device based on a content of the CSI report and/or based on a used CSI-RS resource.

Although referring herein to slots, embodiments relate to time resources. When referring, for example, to channels or subbands, also other frequency resources may be subject of embodiments, e.g., a frequency resource may be one or more of
a channel,
a system bandwidth,
a subchannel,
a subband,
a bandwidth part, BWP,
a component carrier, CC, e.g., a primary CC or a secondary CC,
one or more subcarriers,
a physical resource block, PRB,
a fixed or variable amount of bandwidth at a fixed or varying frequency/location in a frequency grid, e.g. hopping across the frequency grid on consecutive time resources,
one or more pairs or sets of frequency resources, wherein the sets of frequency resources are to be used in the same or different time resources,
a frequency comb.

### Determination of Configuration for Channels and Signals

The following details may also be referred to as related to SBFD configuration.

The UE can perform UL transmissions for various channels/signals across sub-band full duplex, SBFD and non-SBFD symbols in different slots, e.g., PUSCH, PUSCH repetitions, multi-PUSCH, TBoMS, SRS etc. Similarly, in DL, the UE can receive various channels/signals across SBFD and non-SBFD symbols in different slots, e.g., PDSCH, PDSCH repetition, multi-PDSCH, CSI-RS etc. In relation to how the UE receives the signals/channels in different slots, the gNB provides 2 types of configurations to the UE:

That is, the UE may receive, e.g., the above-mentioned PDSCH, PDSCH repetition, multi-PDSCH, CSI-RS etc., in SBFD symbols and/or non-SBFD symbols in the same or different slots in a given DL BWP.

As stated above, a similar operation may be executed by the UE for uplink operations, e.g., uplink transmissions, in SBFD symbols and/or non-SBFD symbols in the same or different slots, e.g., PUSCH, PUSCH repetitions, multi-PUSCH, TBoMS, SRS etc., in a given UL BWP.

Configuration 1: In this configuration, the UE transmits/receives the signal/channel in only one type of symbol, either SBFD or non-SBFD. This can be within a slot or across slots. The type of symbol in which transmission/reception is allowed is known as the valid symbol type for configuration 1 as shown in FIG. 3. For example, FIG. 3 relates to Configuration 1.

Configuration 2: The UE can transmit/receive the signal/channel in both the symbol types, SBFD and non-SBFD symbols. This can be within a slot or across slots. It is shown in FIG. 4. For example, FIG. 4 relates to Configuration 2.

The configurations can be provided to the UE by the gNB or determined by the UE in various ways as listed below.
Configuration (1 or 2) is provided/derived per DL/UL bandwidth part (BWP), in Radio Resource Configuration (RRC). That is, one configuration is applicable to the DL signals/channels and another configuration is applicable for UL signals/channels.
   No other configuration is provided/derived per channel/signal.
   Configurations might be still provided/derived per channel/signal. E.g., a further configuration is provided for CSI-RS resources which might be different from the configuration of the DL.
      UE ignores the configuration per channel/signal under certain conditions.
      Configuration per channel/signal can override the per DL/UL BWP configuration.
      Valid symbol type is also provided per DL/UL BWP.
      Valid symbol type is provided for a particular signal/channel.
If configuration (1 or 2) per DL/UL BWP is not provided, e.g., the field is missing, or value is empty
   configurations are provided/derived per channel/signal,
   Some default configuration is considered, e.g., configuration 1. This will be applicable to all channels/signals unless some explicit configuration is received by the UE.
Only the valid symbol type is provided per DL/UL BWP or per channel/signal. If this is present, then the configuration derived is configuration 1, otherwise it is configuration 2.
If the valid symbol type is provided per DL/UL BWP or per channel/signal as “both”, then the configuration derived is configuration 2.
If UE is capable only of operating in configuration 1, the configuration is not explicitly provided by the gNB. In another way, the UE ignores the configuration provided and operates only in configuration 1.
If UE is capable of both configurations, the configuration it will be operating in is explicitly provided.
The UE continues to operate in a default configuration (as defined in specification) until it receives/derives a configuration. It then operates in the received/derived configuration.
UE operates, e.g., in absence of a received configuration, i.e., when the UE is not configured, in a specific configuration 1 or configuration 2 for a given time, with fallback to a default configuration:
   Implicit: e.g., after a certain time or a number of transmissions, or
   Explicit:
      in case it receives a certain signal, e.g., control and/or data, e.g., a control signalling containing an RRC configuration for a configured grant in uplink, e.g., a Type 1 PUSCH, providing a valid symbol type for a transmission,
      event, e.g., a certain measurement value is above or below a configured or pre-configured threshold, e.g., a RSSI value, or in case of a handover or conditional handover, CHO, event is triggered
      transmission failures, e.g., a UE receives a number of NACKs, or fails to receive a feedback, e.g., ACK and/or NACK.

According to an embodiment, the transceiver device is to may be configured to ignore/skip/not decode/not receive/drop/puncture a further configuration. The reason for this may be one or more of the following:

1. High levels of interference: If there is a significant amount of interference on the subband frequencies being used for SBFD or SBFD symbols, the transceiver may not be able to effectively transmit and/or receive data.

2. Limited bandwidth availability: If there is limited bandwidth available for SBFD or SBFD symbols, the transceiver may not be able to achieve the desired data rates, delay requirements, and/or quality of service.

3. High levels of noise: If there is a high level of noise on the subband frequencies being used for SBFD or SBFD symbols, the transceiver may have difficulty distinguishing between the desired signal and the background noise.

4. Battery status of the transceiver, which may not have enough battery power, e.g., its battery power is below a configured/pre-configured threshold, so that it cannot operate efficiently in SBFD symbols.

5. Processing capability of the transceiver, e.g., the device may not have enough processing capabilities, because the device is already processing other signals, or, because the device may not have the computing power, to process the amount of signals needed. Thus, the device may be configured to drop or skip a processing based on its computing processing capabilities or based on its receiving capabilities, which may be limited due to its limited analogue RF components.

Furthermore, it may perform power-saving in these symbols, e.g., the transceiver performs DRX or just decodes a certain data chunk within the spectrum or subchannel, which may be less interfered and/or which may still fulfil the QoS-constraints of the UE and which may need a much lower processing power.

What the predefined condition may be:

According to an embodiment, the predefined condition is one or more of:
the transceiver device having a configured and/or pre-configured configuration,
the transceiver device having a configured and/or pre-configured configuration per BWP
the transceiver device having a configured and/or pre-configured configuration for larger frequency resource, e.g., the UE has a configuration for channel, and thus does not require a configuration for a subchannel,
the transceiver device having a configured and/or pre-configured common configuration for both uplink and downlink,
power saving, e.g., the transceiver device is performing discontinuous reception, e.g., DRX or eDRX,
based on a capability of the transceiver device, e.g., are UE reduced capability, RedCap, may not support a further configuration,
There may be a hierarchy or order in frequency domain, e.g., which may be ranked from high to low according to:
1. System bandwidth,
2. Component Carrier,
3. Bandwidthpart, BWP,
4. Subband,
5. Subchannel,
6. Physical resource block, PRB,
7. Subcarrier.

Or any other order or sub-order may be applied.

According to an embodiment, the transceiver device is to implement or to determine the configuration independent from one or more of
a frequency resource,
a signal.

According to an embodiment, the transceiver device is to implement or determine a further configuration per one or more of
a frequency resource,
per signal,
response on a request,
when a condition is met, threshold passed, e.g., a conditional configuration change, CCC.

According to an embodiment, a frequency resource is one or more of
a channel,
a system bandwidth,
a subchannel,
a subband,
a bandwidth part, BWP,
a component carrier, CC,
one or more subcarriers,
a physical resource block, PRB,
a fixed or variable amount of bandwidth at a fixed or varying frequency/location in a frequency grid, e.g. hopping across the frequency grid on consecutive time resources,
one or more pairs or sets of frequency resources, wherein the sets of frequency resources are to be used in the same or different time resources,
a frequency comb.

Details of configurations provided or derived per DL BWP/UL BWP/channel/signal;
PDSCH
   Physical Downlink Shared Channel, PDSCH (including PDSCH Repetition, Multi-PDSCH)
      configuration is provided in or derived from Radio Resource Configuration, RRC, Information Elements, IEs, like BWP, BWP-Downlink, BWP-DownlinkDedicated, BWP-DownlinkCommon, PDSCH-config, PDSCH-ConfigCommon, PDSCH-ServingCellConfig, ServingCellConfig, ServingCellConfigCommon, ServingCellConfigCommonSIB, DownlinkConfigCommon, DownlinkConfigCommonSIB or CSI resource/report related configurations.
   Semi-Persistent Scheduling, SPS, or configured grant, CG, PDSCH
      Configuration is explicitly provided in SPS-config.
         UE follows the configuration explicitly provided in SPS-config.
         UE follows the configuration as provided in or derived from at least one of the above list for PDSCH (if present) and ignores the configuration explicitly provided in or derived from SPS-config.
         No explicit configuration is provided in or derived from SPS-config. Follows the configuration as provided in or derived from at least one of the above list for PDSCH.
Physical Uplink Shared Channel, PUSCH
   PUSCH (Includes Multi-PUSCH, Transport Block over Multiple Slots, TBoMS, PUSCH repetition)
      configuration is provided in or derived from RRC IEs like BWP, BWP-Uplink, BWP-UplinkDedicated, BWP-UplinkCommon, PUSCH-config, PUSCH-ConfigCommon, PUSCH-ServingCellConfig, ServingCellConfig, ServingCellConfigCommon, ServingCellConfigCommonSIB, UplinkConfigCommon, UplinkConfigCommonSIB or from SRS related configurations.
   Configured Grant, CG
      Configuration is explicitly provided in or derived from ConfiguredGrantConfig.
         UE follows the configuration explicitly provided in or derived from ConfiguredGrantConfig.
         UE follows the configuration as provided in or derived from at least one of the above list for PUSCH (if present) and ignores the configuration explicitly provided in or derived from ConfiguredGrantConfig.
      No explicit configuration is provided in or derived from ConfiguredGrantConfig. Follows the configuration as provided in or derived from at least one of the above list for PUSCH.
Channel State Information-Reference Signal, CSI-RS resource and CSI report.

According to an embodiment, the UE or transceiver device is adapted that the determination result comprises one or more of
derived from a valid symbol type being valid for the time resource, the valid symbol type being provided, e.g., if a valid symbol type is provided then the UE operates in the first configuration,
derived based on a measurement, e.g., see claim 1i.

According to an embodiment, the UE or transceiver device is adapted the first configuration and/or second configuration is one or more of
configured, e.g., based on a received message, e.g., a configuration message,
pre-configured,
determined based on a capability.

According to an embodiment, the UE or transceiver device is configured with the message by at least one of:
a base station, e.g., a gNB,
by the network, e.g., core network, CN,
by another UE, e.g., via sidelink,
over-the-top, e.g., via Internet.

According to an embodiment, the time resource is one or more of
an absolute time, e.g., 13 or 28 milliseconds,
a symbol, e.g., OFDM symbols, or a group of OFDM symbols,
a slot, e.g., 14 OFDM symbols, sub-slots, half-slots, or mini-slots,
a subframe,
a radioframe,
a hyperframe.

According to an embodiment, the UE or transceiver device is adapted to execute a time resource measurement, wherein the time resource measurement is based on counting of a time resource, e.g., slot counting etc.

According to an embodiment, the UE or transceiver device is adapted to perform a random access/initial access, e.g., Physical Random Access Channel, PRACH, to a network, e.g., and the transceiver device is
not connected to a base station, e.g., in RRC_IDLE state or
in RRC_INACTIVE state, or
performing PRACH procedure and waiting for a response from the base station, e.g., a RACH response.

According to an embodiment, the UE or transceiver device is to do one or more of
to receive the first configuration and/or the second configuration, e.g., indicated with the message, via a broadcast channel, BCH, e.g., via SIB, prior to performing a random access procedure,
pre-configured with the first configuration or the second configuration, e.g., via capability,
is to receive a first configuration or second configuration, e.g., a full configuration or an updated configuration, while performing random access, e.g.,
   in 4-step RACH via message 2, Msg2, or message 4, Msg4, or
   in 2-step RACH via message B, MsgB.

According to an embodiment, the device may perform a random access procedure within a non-SBFD symbol, receive a configuration update, so as to continue the random access procedure in a non-SBFD symbol or vice versa. This may allow to accelerate the overall random access procedure.

According to an embodiment, the control messages and procedures are associated with at least one of another band/another component carrier/another radio access technology, RAT, e.g. a configuration message comes from an LTE component carrier in non-stand-alone (NSA) or is shared among UEs via Bluetooth, BLE or WiFi, or is retrieved from a server in the Internet via WiFi.

According to an embodiment, the transceiver device is configured or pre-configured with the following default configuration:
the first configuration, or
the second configuration, or
a configuration supported by its capability.

According to an embodiment, the transceiver device is to change/overwrite a configuration, e.g., based on a configuration received, to
the first configuration, e.g., previously configured with the second configuration, or
the second configuration, e.g., previously configured with first configuration.

According to an embodiment, the transceiver device is to
select first configuration or the second configuration or
not to select the first configuration or the second configuration, e.g., restrict to not use one of the configurations,
   based on a criterion.

The selected configuration may be reported, e.g., to a basestation, a different network entity or the like. A BS can forward this configuration to another BS or to another UE, so that it may be aware of certain UEs operating in certain modes, which may cause interference.

According to an embodiment, the criterion is one or more of
a channel condition or based on a measurement, e.g., SNR, interference, RSRP, RSRQ, RSSI, ACLR, cross-link interference, CLI,
a position of the transceiver device, e.g., geo-location within the cell,
a QoS criterion, e.g., packet delay budget, PDB, or latency requirement, e.g., URLLC requirement, e.g., reliability,
a capability of the transceiver device,
based on a threshold, e.g., received signal strength, e.g., from a base station, CLI, SINR, with interference coming from another base station or from another UE,
based on assistance information, e.g., an information received by a base station, BS, or from another UE.

According to an embodiment, the threshold is one or more of
configured and/or pre-configured, e.g., by signaling from a base station,
based on a measurement at the transceiver device,
based on a determination of an SINR headroom, wherein the SINR headroom can refer to
   SINR headroom at the UE, e.g., in downlink, or
   SINR headroom at the base station, e.g., in uplink.

According to an embodiment, the transceiver device is to report the selected first configuration or second configuration or parameters thereof to one or more of
a base station,
a network entity, e.g., a core network function, CNF,
another UE.

This may be needed in case the base station sends a configuration message, e.g., a first or a second configuration, to the transceiver, and the transceiver confirms to operate in the configured mode or does not confirm to work in the configured mode, e.g., it sends a rejection message, since the UE may be in a certain:

1. High levels of interference: If there is a significant amount of interference on the subband frequencies being used for SBFD or SBFD symbols, the transceiver may not be able to effectively transmit and/or receive data.

2. Limited bandwidth availability: If there is limited bandwidth available for SBFD or SBFD symbols, the transceiver may not be able to achieve the desired data rates, delay requirements, and/or quality of service.

3. High levels of noise: If there is a high level of noise on the subband frequencies being used for SBFD or SBFD symbols, the transceiver may have difficulty distinguishing between the desired signal and the background noise.

4. Battery status of the transceiver, which may not have enough battery power, e.g., its battery power is below a configured/pre-configured threshold, so that it cannot operate efficiently in SBFD symbols.

5. Processing capability of the transceiver, e.g., the device may not have enough processing capabilities, because the device is already processing other signals, or, because the device may not have the computing power, to process the amount of signals needed. Thus, the device may be configured to drop or skip a processing based on its computing processing capabilities or based on its receiving capabilities, which may be limited due to its limited analogue RF components.

In a further embodiment, the transceiver may report to only work on either SBFD or non-SBFD symbols, or propose to work in a certain mode, depending on the above-described conditions, which is different to the configuration 1 or configuration 2 received from the base station. In a further embodiment, the transceiver may indicate a reason or cause of its preference, e.g., when sending this feedback to the base station, e.g., one of the reasons listed above in 1. —According to an embodiment, a valid symbol type being valid for the time resource is
explicitly configured or pre-configured, or
is one symbol type, e.g., either SBFD or non-SBFD, e.g., used as default, e.g., when the UE is not configured with configuration 2, the UE uses only one of the symbol types as a valid symbol type.

Examples of how the valid symbol type can be configured/signalled:

According to an embodiment, a valid symbol type being valid for the time resource is
signalled by another device, e.g., a base station, a network entity, CN, another UE,
configured by a certain type of signaling, e.g., broadcast or control, or dedicated signaling, using one or more of
   higher layer,
   RRC, e.g., RRC IEs,
   MAC-CE,
   PHY, e.g., via DCI.

According to an embodiment, the device may perform a random access procedure within a non-SBFD symbol, receive a configuration update, so as to continue the random access procedure in a non-SBFD symbol or vice versa. This will allow to accelerate the overall random access procedure.

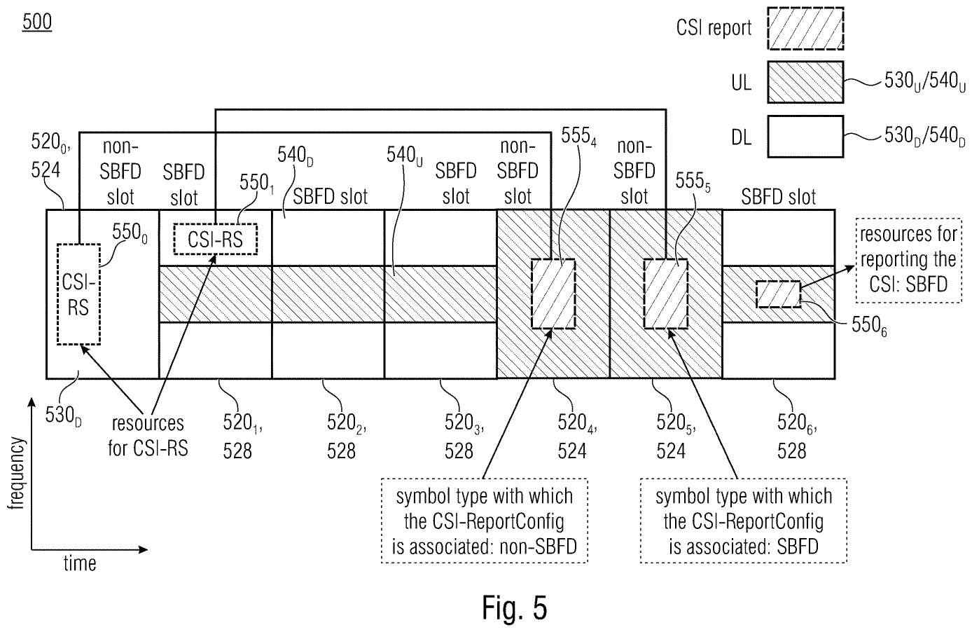

FIG. 5 exemplarily depicts a schematic representation 500 of resources for CSI-RS, resources for reporting the CSI and symbol type with which the CSI-Report Config is associated, in accordance with embodiments, using a time-frequency grid.

FIG. 5 depicts a plurality of time resources as a plurality of time slots 520₀₋₆, wherein a first subset 520₀, 520₄, 520₅ of the plurality of time resources are non-SBFD time resources, such as the exemplarily depicted non-SBFD time slots 524 and a second subset 520₁, 520₂, 520₃, 520₆ of the plurality of time resources are SBFD time resources such as the exemplarily depicted SBFD time slots 528.

In particular, FIG. 5 depicts a CSI-RS transmission occasion 550₀ occasioned, or scheduled, or configured to be within non-SBFD symbols of the non-SBFD time resource, such as the non-SBFD slot 520₀. Therefore, the transceiver device may receive a CSI-RS transmission associated with the CSI-RS resource 550₀ from an entity such as a BS (e.g. gNB). The CSI-RS resource 550₀ may be a configured instance of CSI-RS signaling that the transceiver device configures, for instance, using RRC signaling. As shown in FIG. 5, a CSI-report associated with the CSI-RS resource 550₀ could be identified using a CSI-ReportConfig 555₄, which is scheduled or occasioned or configured using non-SBFD symbols of a non-SBFD time resource, such as the non-SBFD slot 520₄. It may be that for the CSI-Report Config 550₀, the transceiver device may use CSI-RS transmission occasion 550₀ with non-SBFD symbols of the non-SBFD time resource 520₀ for CSI derivation (e.g. identification of the CSI Report). It may be that the CSI-Report Config 550₀ of the CSI-RS may be restricted to non-SBFD time resource(s).

Further, FIG. 5 depicts another CSI-RS transmission occasion 550₁ occasioned, or scheduled, or configured to be within SBFD symbols of a SBFD time resource, such as the SBFD slot 520₁. Therefore, the transceiver device may receive another CSI-RS transmission associated with the another or different CSI-RS resource 550₁ from an entity such as a BS (e.g. gNB). The another (different) CSI-RS resource 550₁ may be a configured instance of another CSI-RS signaling that the transceiver device configures, for instance, using RRC signaling. As shown in FIG. 5, another CSI-report associated with the another CSI-RS resource 550₁ could be identified using a CSI-ReportConfig 555₅, which is scheduled or occasioned or configured using non-SBFD symbols of a non-SBFD time resource, such as the non-SBFD slot 520₅. It may be that for the CSI-Report Config 550₁, the transceiver device may use CSI-RS transmission occasion 550₁ with SBFD symbols of the SBFD time resource 520₁ for CSI derivation (e.g. identification of the CSI Report). It may be that the CSI-Report Config 550₁ of the CSI-RS may be restricted to SBFD time resource(s).

Therefore, the CSI-ReportConfig 555 may be separate (e.g. distinct) for CSI-RS resources 550 of an SBFD time resource (e.g. the non-SBFD slot 520₀) and of a non-SBFD time resource (e.g. the SBFD slot 520₁). Alternatively, it may be that the CSI-Report Config 555 may be same for CSI-RS resources of SBFD as well as non-SBFD time resources.

The CSI-report may be associated with a CSI-RS signaling/communication being one of: triggered, scheduled, persistent, e.g., P-CSI, periodic, semi-persistent, e.g., SP-CSI, or aperiodic.

Further, FIG. 5 depicts a further CSI-report associated with a further CSI-ReportConfig 550₆ being occasioned, scheduled, or configured, within an SBFD time resource, such as SBFD symbols of a sub-band 540_{U} of a SBFD slot 520₆. It may be that for the further CSI-Report Config 550₆, the transceiver device may use either CSI-RS transmission occasion 550₁ with SBFD symbols of the SBFD time resource 520₁, or CSI-RS transmission occasion 550₀ with non-SBFD symbols of the non-SBFD time resource 520₀, or CSI-RS transmission occasions 550₀, 550₁ with SBFD symbols of the SBFD time resource 520₁ as well as non-SBFD symbols of the non-SBFD time resource 520₀.

Further, it may be that for the CSI-ReportConfig associated with CSI-RS restricted to a non-SBFD time resource, such as the CSI-ReportConfig 555₄, 555₅ the transceiver device may use CSI-RS transmission occasions either within the non-SBFD symbols or SBFD symbols or both SBFD and non-SBFD symbols, for CSI derivation.

Therefore, for the CSI-ReportConfig associated with CSI-RS being transmitted on a non-SBFD time resource and/or SBFD time resource, the transceiver device is to use for CSI derivation at least one of: CSI-RS transmission occasions restricted within non-SBFD symbols, CSI-RS transmission occasions restricted within SBFD symbols, CSI-RS transmission occasions within either SBFD or non-SBFD symbols, CSI-RS transmission occasions within both SBFD and non-SBFD symbols, CSI-RS transmission occasions within at least non-SBFD symbols, and CSI-RS transmissions occasions within at least SBFD symbols.

For example, the CSI-RS signalling may relate or be associated to a non-zero power CSI-RS, NZP CSI-RS, a zero power CSI-RS or a CSI-interference measurement, CSI-IM.

The transceiver device may, for example, omit determining or deriving the first and second configuration (e.g. configuration 1 and 2) for resources for a CSI-RS or resources for reporting the CSI when a symbol type with which the CSI-ReportConfig is associated is provided or derived. For example, the transceiver device may use the configuration for a CSI-RS signalling/communication or resources for reporting the CSI in accordance with the provided or derived symbol type from or based on the CSI-ReportConfig. Additionally, for example, the transceiver device may obtain the symbol type with which the CSI-ReportConfig is associated as being provided in or derived from at least one of: CSI-ReportConfig, BWP, BWP-Downlink, BWP-DownlinkDedicated, BWP-DownlinkCommon, PDSCH-config, PDSCH-ConfigCommon, PDSCH-ServingCellConfig, ServingCellConfig, ServingCellConfigCommon, ServingCellConfigCommonSIB, DownlinkConfigCommon, DownlinkConfigCommonSIB, CSI-MeasConfig or any other IE.

For example, in the case when a symbol type with which the CSI-ReportConfig is associated is provided to the transceiver device or derived by the transceiver device, the transceiver device may operate according to the symbol type. In the course of operating according to the symbol type, for instance, the transceiver device may possibly ignore or drop the first configuration and/or the second configuration for the resources for CSI-RS signalling/communication or, a part or a whole of the resources for reporting the CSI.

It might be that the transceiver device may send the CSI report on non-SBFD symbols of a non-SBFD time resource. Optionally, the transceiver may send a first part, or one or more first parts, of the CSI report on non-SBFD symbols of a non-SBFD time resource and a second or remaining part, or one or more second or remaining parts, of the CSI report on one or more of (e.g. at least one of): the next available resources, the next non-SBFD symbols, or the next SBFD symbols. Optionally, the transceiver device may send a first part, or one or more first parts, of the CSI report on SBFD symbols and a second or remaining part, or one or more second or remaining parts, may be sent on one or more of (e.g. at least one of): the next available resources, the next non-SBFD symbols, or the next SBFD symbols. Optionally, the transceiver device may send the CSI report on SBFD symbols of a SBFD time resource.

For example, the transceiver device may determine a valid symbol type according to or based on a signal or channel having the first configuration (e.g. configuration 1). For example, the signal or channel may be any of PBCH, PDCCH, PDSCH, PUSCH, PUCCH. For example, the transceiver device may receive CSI-RS on both SBFD symbols and non-SBFD symbols and may perform reporting only with respect to the valid symbol type of the first configuration. Alternatively, the transceiver device may receive CSI-RS only on the valid symbol type and may report or perform reporting only with respect to the valid symbol type of the first configuration.

For example, the transceiver device may be provided with or may derive a valid symbol type for the CSI report based on a signal or channel having the second configuration (e.g. configuration 2). For example, the signal or channel may be PBCH, PDCCH, PDSCH, PUSCH, PUCCH. Additionally, for example, the transceiver device may be provided with or derive whether to use the first configuration or the second configuration for the resources for CSI-RS 550 or resources for the CSI report 555.

It may be that the transceiver device determines that a symbol type with which the CSI-ReportConfig is associated with is SBFD. Further, in a case where no configuration for resources for CSI-RS may be provided or in a case where the second configuration (e.g. configuration 2) may be applied or operated in accordance with, the transceiver device processes the CSI-RS in SBFD and non-SBFD symbols. Optionally, the transceiver device could process the CSI-RS in SBFD symbols only.

Alternatively, it may be that the transceiver device determines that a symbol type with which the CSI-ReportConfig is associated with is non-SBFD. Further, in a case where no configuration for resources for CSI-RS may be provided or in a case where the second configuration (e.g. configuration 2) may be applied or operated in accordance with, the transceiver device processes the CSI-RS in SBFD and non-SBFD symbols. Optionally, the transceiver device may process the CSI-RS in non-SBFD symbols only.

For example, the transceiver device may determine that a symbol type with which the CSI-ReportConfig is associated is SBFD. Further, in a case where no configuration for resources for the CSI report may be provided or in a case where the second configuration (e.g. configuration 2) may be applied or operated in accordance with, the transceiver device transmits the CSI report in SBFD and non-SBFD symbols. Optionally, the transceiver device may transmit the CSI report in SBFD symbols only. Optionally, the transceiver device may follow a configuration of a different channel or signal like PUSCH/PUCCH for resources for CSI report.

For example, the transceiver device may determine that a symbol type with which the CSI-ReportConfig is associated with is non-SBFD. Further, in a case where no configuration for resources for the CSI report is provided or in a case where the second configuration (e.g. configuration 2) may be applied or operated in accordance with, the transceiver device transmits the CSI report in SBFD and non-SBFD symbols. Optionally, the transceiver device may transmit the CSI report in non-SBFD symbols only. Optionally, the transceiver device may follow a configuration of a different channel or signal like PUSCH/PUCCH for resources for CSI report.

For example, the transceiver device may determine that a symbol type with which the CSI-ReportConfig 550₆ is associated with is SBFD. Further, in a case where the first configuration (e.g. configuration 1) may be applied or operated in accordance with, the transceiver device processes the CSI-RS in SBFD and non-SBFD symbols. Optionally, the transceiver device may process the CSI-RS in SBFD symbols only.

For example, the transceiver device may determine that a symbol type with which the CSI-ReportConfig 550₆ is associated with is SBFD. Further, in a case where the first configuration (e.g. configuration 1) may be applied or operated in accordance with, the transceiver device may transmit the CSI report in SBFD and non-SBFD symbols. Optionally, the transceiver device may transmit the CSI report in SBFD symbols only. Optionally, the transceiver device may follow a configuration of a different channel or signal like PUSCH/PUCCH for resources for CSI report.

For example, the transceiver device may select CSI-RS resources 550 for calculation of CSI and reporting based on a symbol type with which the CSI-ReportConfig 555 is associated. Further, the transceiver device may select the CSI-RS resources 550 to process CSI-RS on both SBFD and non-SBFD symbols. For example, the transceiver device may derive, or determine, the symbol type with which the CSI-ReportConfig 555 is associated in at least one of a set of parameters, wherein the set of parameters comprise resourcesForChannelMeasurement, csi-IM-ResourcesForInterference, and nzp-CSI-RS-ResourcesForInterference. Further, the transceiver device may derive the symbol type from at least one of the set of parameters and may apply the same symbol type to at least one of the remaining parameters of the set of parameters.

It may be that a symbol type with which the CSI-ReportConfig is associated is not provided explicitly, such as in resourcesForChannelMeasurement, csi-IM-ResourcesForInterference and/or nzp-CSI-RS-ResourcesForInterference, the transceiver device may provide or derive the signal type from a different source of information. Further, the transceiver device may apply the signal type to at least one of: resourcesForChannelMeasurement, csi-IM-ResourcesForInterference, and nzp-CSI-RS-ResourcesForInterference. That is, the symbol type in CSI-ReportConfig may apply to NZP-CSI-RS resources which are associated with the CSI report. For example, the symbol type may apply to the resources configured for both channel measurement and interference measurement.

The transceiver device may be adapted to apply a symbol type with which the CSI-ReportConfig is associated and that is provided to the transceiver device or applicable for the CSI-RS resources for at least one of the parameters: resourcesForChannelMeasurement, csi-IM-ResourcesForInterference, and nzp-CSI-RS-ResourcesForInterference. Additionally, the transceiver device may apply a same symbol type for the other parameter; wherein the transceiver device may receive CSI-IM resources configured by csi-IM-ResourcesForInterference on both SBFD and non-SBFD symbols and to use the resources for CSI calculation and/or reporting.

The transceiver device may be adapted to simultaneously operate according to two valid CSI-ReportConfigs corresponding to the same CSI-RS resources. Among the two valid CSI-ReportConfigs, a first CSI-ReportConfig may be associated with SBFD symbols and a second CSI-ReportConfig may be associated with non-SBFD symbols. For example, it may be that the first and second CSI-ReportConfig are linked with each other. Further, the transceiver device may be adapted to report a first CSI report based on the first CSI-ReportConfig and a second CSI report based on the second CSI-ReportConfig together as a single report, such as on PUCCH or PUSCH.

For example, the transceiver device may be adapted to use resources for the CSI report that follow a symbol type with which the CSI-ReportConfig is associated or operated according to, provided or derived. For example, the transceiver device may be adapted to operate in a manner such that resources for the CSI report do not follow a symbol type with which the CSI-ReportConfig is associated. It may be that the resources for the CSI report are on at least one of SBFD symbols and non-SBFD symbols, and wherein a valid symbol type for the resources for the CSI report may be provided to or derived by the transceiver device. In addition, the transceiver device may be provided with the valid symbol type in CSI-ReportConfig or a different RRC IEs like PUCCH-config or PUSCH-config for reporting on PUCCH/PUSCH.

It may be that the resources for the CSI report and a symbol type with which the CSI-ReportConfig is associated are separately provided for at least one of the following types of report: triggered, periodic, scheduled, semiPersistentOnPUCCH, semiPersistentOnPUSCH, and aperiodic. In addition, the transceiver device may apply the valid symbol type to at least one of the aforementioned types of report, based or depending on the valid symbol type for the resources for the report being provided to the transceiver device.

For example, the transceiver device may be provided with the first configuration (e.g. configuration 1) or the second configuration (e.g. configuration 2) explicitly for resources for CSI-RS or resources for the CSI report. Alternatively, when only a valid symbol type field may be present for one of the resources for CSI-RS or resources for the CSI report, the transceiver device derives the first configuration (e.g. configuration 1) if a value is provided, and to otherwise derive the second configuration (e.g. configuration 2). That is, if the value is not provided, the transceiver device may derive the second configuration (e.g. configuration 2).

Further, the transceiver device may be adapted to be provided with or to derive whether to apply the first configuration (e.g. configuration 1) or the second configuration (e.g. configuration 2) for resources for CSI-RS only and to apply a same configuration to resources for the CSI report and vice versa. For instance, the first (e.g. configuration 1) or the second (e.g. configuration 2) configurations may be applied using a valid symbol type.

For example, the transceiver device may be provided with or to derive whether to apply the first configuration (e.g. configuration 1) or the second configuration (e.g. configuration 2) from an RRC IE. The RRC IE could be in BWP, BWP-Downlink, BWP-DownlinkDedicated, BWP-DownlinkCommon, PDSCH-config, PDSCH-ConfigCommon, PDSCH-ServingCellConfig, ServingCellConfig, ServingCellConfigCommon, ServingCellConfigCommonSIB, DownlinkConfigCommon, DownlinkConfigCommonSIB, CSI-MeasConfig or CSI-ReportConfig.

For example, the transceiver device may be provided with, or derive, whether to apply the first configuration (e.g. configuration 1) or the second configuration (e.g. configuration 1) from at least one of a set of parameters. The set of parameters may, for example, comprise resourcesForChannelMeasurement, csi-IM-ResourcesForInterference, and nzp-CSI-RS-ResourcesForInterference. Further, for example, the transceiver device may be adapted to provide with or to derive from at least one parameter of the set of parameters, and to apply the same configuration to at least one other parameter of the set of parameters as well.

For example, the transceiver device may be provided with, or to derive, whether to apply the first configuration (e.g. configuration 1) or the second configuration (e.g. configuration 2) from a different source of information. Further, for example, the transceiver device may apply the signal type to at least one of: resourcesForChannelMeasurement, csi-IM-ResourcesForInterference, and nzp-CSI-RS-ResourcesForInterference.

For example, the transceiver device may be provided with, or derive, whether to apply the first configuration (e.g. configuration 1) or the second configuration (e.g. configuration 2) from any one or two of a set of parameters. For example, the set of parameters may comprise: resourcesForChannelMeasurement, csi-IM-ResourcesForInterference, and nzp-CSI-RS-ResourcesForInterference. In addition, the transceiver device may apply a different configuration for a remaining parameter(s) of the set of parameters.

For example, the transceiver device may apply the first (e.g. configuration 1) or the second configuration (e.g. configuration 2) for the resources for CSI-RS or resources for the CSI report based on the configuration of another channel or another signal. For example, the transceiver device may apply a valid symbol type for the resources for CSI-RS or resources for the CSI report based on the configuration of another channel or another signal.

For example, the transceiver device apply a same configuration and a same valid symbol type for both the CSI-RS resources 550 and resources 555 for the CSI report.

Some details and features in regard to signaling or communication involving a sounding reference signal, SRS, for the transceiver device are now presented. Such details may be transferable and combinable with the details already described in this disclosure.

The transceiver device may be adapted to operate the first configuration (e.g. configuration 1) or the second configuration (e.g. configuration 2) for a sounding reference signal, SRS, as a configuration implemented in a different channel or signal, such as a PUSCH. In addition, it may be that in case of the first configuration being applied to the different channel or signal, the valid symbol type for SRS is the same as the valid symbol type for some other signal/channel, such as PUSCH. Further, the transceiver device may be adapted to be provided explicitly with a valid symbol type for SRS, such as provided in SRS-config.

For example, the transceiver device may be adapted to be provided implicitly whether to apply the first configuration (e.g. configuration 1) or the second configuration (e.g. configuration 2). That is, the transceiver device may be configured so as to allow an implicit indication if the first configuration or the second configuration is to be applied.

Further, based on a valid symbol type being provided to the transceiver device, the transceiver device may apply the first configuration (e.g. configuration 1) and in case of a lack of provision of the valid symbol type, the transceiver device may apply the second configuration (e.g. configuration 2).

For example, the transceiver device may be adapted to apply a same configuration. Additionally or alternatively, the transceiver device may be adapted to apply a same valid symbol type for a plurality or all types of SRSs. Optionally, the transceiver device may individually implement the configuration and/or the valid symbol. For example, the types of SRSs may refer to: aperiodic, or periodic, or triggered, or scheduled, or semi-persistent.

The types of SRS may refer to wideband, such as wideband SRS signals could be transmitted over a broader frequency bandwidth, allowing for enhanced channel estimation and improved interference rejection capabilities. Wideband SRS is designed to provide accurate channel state information across a wider frequency range for advanced signal processing and optimization. The types of SRS may refer to narrowband or subband, such as signalling/communication being restricted to a frequency resource.

Further, the types may refer to a usage of SRS, such as at least one of: codebook/non-codebook, beamforming, beam management, antenna switching and antenna selection.

For example, the transceiver device may be adapted to operate according to a default configuration defined for SRS. For example, the transceiver device may be adapted to interpret a configuration of a scheduling from a base station serving the transceiver device in order to derive, or for deriving or determining, the configuration for the SRS.

CSI reports can be associated with triggered/scheduled/periodic/semi-persistent/aperiodic CSI-RS. Each CSI report is identified with the help of a CSI-ReportConfig configuration in RRC. The CSI-ReportConfig can be separate for SBFD and non-SBFD CSI-RS resources. That is, one CSI-ReportConfig is associated with CSI-RS(s) is restricted to SBFD symbols only and the second CSI-ReportConfig is associated with CSI-RS(s) is restricted to non-SBFD symbols only. For a triggered CSI-RS, the gNB can trigger the UE to send a CSI report when certain conditions are met, such as a handover, beam change, or mobility event. For a scheduled CSI-RS, the UE may include CSI feedback in a scheduling request message sent to the gNB to request uplink resources for data transmission. This allows the UE to provide CSI feedback opportunistically when requesting resources.

For the CSI-ReportConfig associated with CSI-RS(s) restricted to SBFD symbols only, only CSI-RS transmission occasions within SBFD symbols are used for CSI derivation.

For the CSI-ReportConfig associated with CSI-RS(s) restricted to non-SBFD symbols only, only CSI-RS transmission occasions within non-SBFD symbols are used for CSI derivation. An illustration is shown in FIG. 5. It is to be noted that CSI-RS can imply non-zero power CSI-RS (NZP CSI-RS), zero power CSI-RS or CSI-interference measurement (CSI-IM) in all the subsequent bullet points.

For example, FIG. 5 may be referred to as an Illustration depicting resources for CSI-RS, resources for reporting the CSI and symbol type with which the CSI-ReportConfig is associated.

Various UE behaviour can be defined for CSI-RS resources and reporting.
Configuration (1 or 2) for the resources for CSI-RS or resources for reporting the CSI is not provided or derived.
   This is followed if a symbol type with which the CSI-ReportConfig is associated is provided or derived.
The symbol type with which the CSI-ReportConfig is associated is provided in or derived from at least one of CSI-ReportConfig, BWP, BWP-Downlink, BWP-DownlinkDedicated, BWP-DownlinkCommon, PDSCH-PDSCH-config, ConfigCommon, PDSCH-ServingCellConfig, ServingCellConfig, ServingCellConfigCommon, ServingCellConfigCommonSIB, DownlinkConfigCommon, DownlinkConfigCommonSIB, CSI-MeasConfig or any other IE.
If symbol type with which the CSI-ReportConfig is associated is provided or derived, then the UE ignores any configuration (1 or 2) for the resources for CSI-RS or resources for reporting the CSI.
The CSI report would need a certain bandwidth of frequency domain resources. However, the available frequency domain UL resources in SBFD symbols is less than in non-SBFD symbols. For certain reports, the available resources in SBFD symbols might not be enough. In that case,
   The report is sent on non-SBFD symbols, or
   Part of the report is sent on SBFD symbols and the other part is sent on the next available resources.
A signal/channel, e.g., PBCH/PDCCH/PDSCH/PUSCH/PUCCH has a configuration (1 or 2). If it is configuration 1, the valid symbol type is also defined.
   In this case, the symbol type with which the CSI-ReportConfig is associated cannot be the invalid symbol type for the signal/channel.
   Symbol type with which the CSI-ReportConfig is associated is not provided since it is only the valid symbol type.
   The UE can receive CSI-RS on both SBFD and non-SBFD symbols but can perform reporting only with respect to the valid symbol type.
   The UE can receive CSI-RS only on the valid symbol type.
   The UE can report CSI only on the valid symbol type.
A signal/channel, e.g., PBCH/PDCCH/PDSCH/PUSCH/PUCCH has a configuration (1 or 2). If it is configuration 2,
   A symbol type with which the CSI-ReportConfig is associated can be provided or derived.
   A configuration (1 or 2) can be provided or derived for the resources for CSI-RS or resources for reporting the CSI.
The symbol type with which the CSI-ReportConfig is associated is SBFD (and vice versa rules if it is non-SBFD),
   If there is no configuration for resources for CSI-RS or configuration is 2,
      The UE receives the CSI-RS in SBFD and non-SBFD symbols.
      The UE receives the CSI-RS only in SBFD symbols.
   If there is no configuration for resources for CSI report or configuration is 2,
      The UE reports the CSI in SBFD and non-SBFD symbols.
      The UE reports the CSI only in SBFD symbols.
      The UE follows the configuration of some other channel/signal like PUSCH/PUCCH for resources for CSI report.
   If the configuration for resources for CSI-RS is configuration 1,
      The valid symbol type provided or by default should be SBFD.
      If the valid symbol type provided/derived is non-SBFD, the UE receives the CSI-RS in both SBFD and non-SBFD symbols or only on SBFD symbols.
   If the configuration for resources for CSI report is configuration 1,
      The valid symbol type provided or by default should be SBFD.
      If the valid symbol type provided/derived is non-SBFD, the UE reports the CSI in both SBFD and non-SBFD symbols or only on SBFD symbols.
      The UE follows the configuration of some other channel/signal like PUSCH/PUCCH for resources for CSI report.
gNB configuration does not ensure that the CSI-RS associated with each CSI-ReportConfig is confined to either SBFD symbols or non-SBFD symbols only. Hence, the UE can receive CSI-RS on both SBFD and non-SBFD symbols. However, based on the symbol type with which the CSI-ReportConfig is associated, it chooses the CSI-RS resources on the given symbol type for calculation of CSI and reporting.
   The symbol type with which the CSI-ReportConfig is associated is provided in at least one of the 3 parameters; resourcesForChannelMeasurement, csi-IM-ResourcesForInterference, nzp-CSI-RS-ResourcesForInterference.
      If the symbol type is provided for at least one parameter, then it applies to the others as well. E.g., if the symbol type for resourcesForChannelMeasurement is SBFD, then the symbol type for csi-IM-ResourcesForInterference is also SBFD.
      The symbol type with which the CSI-ReportConfig is associated is not provided explicitly in resourcesForChannelMeasurement, csi-IM-ResourcesForInterference, nzp-CSI-RS-ResourcesForInterference. The symbol type is provided or derived from elsewhere and applied to at least one of resourcesForChannelMeasurement, csi-IM-ResourcesForInterference, nzp-CSI-RS-ResourcesForInterference. That is, the symbol type in CSI-ReportConfig may apply to NZP-CSI-RS resources that are associated with the CSI report, e.g., configured for both channel measurement and/or interference measurement.
      The symbol type with which the CSI-ReportConfig is associated is provided/applicable for the CSI-RS resources for any one or two of the parameters resourcesForChannelMeasurement, csi-IM-ResourcesForInterference, nzp-CSI-RS-ResourcesForInterference. The other parameter(s) need not follow the same symbol type. E.g., the symbol type of SBFD applies to resourcesForChannelMeasurement. However, the CSI-IM resources configured by csi-IM-ResourcesForInterference can be received on both SBFD and non-SBFD symbols and used for CSI calculation and reporting.
      The CSI-ReportConfigs corresponding to the same CSI-RS resources but one CSI-ReportConfig associated with the SBFD symbols and the other CSI-ReportConfig associated with the non-SBFD symbols are linked. Also, the UE reports them together as a single report on PUCCH or PUSCH.
The resources for the report also follow the symbol type with which the CSI-ReportConfig is associated provided or derived. E.g., report associated with SBFD symbol type is transmitted only on SBFD resources.
The resources for the report do not follow the symbol type with which the CSI-ReportConfig is associated.
   The resources can be on both SBFD and non-SBFD symbols.
   The valid symbol type for the resources for the report is provided or derived. It can be provided in CSI-ReportConfig, e.g., by the information element semiPersistentOnPUCCH or other RRC IEs like PUCCH-config or PUSCH-config for reporting on PUCCH/PUSCH.
   Separately provided for at least one of the following types of report; periodic, triggered, scheduled, semiPersistentOnPUCCH, semiPersistentOnPUSCH and aperiodic.
   One valid symbol type for the resources for the report is provided which is applicable to at least one of the above-mentioned types of report.
A configuration (1 or 2) is provided explicitly for the resources for CSI-RS or resources for reporting the CSI. In another way, only a valid symbol type field is present for the resources for CSI-RS or resources for reporting the CSI. If a value is provided, then configuration 1 is derived, otherwise it is configuration 2. Further, the configuration can be provided or derived (e.g., using valid symbol type) for resources for CSI-RS only and the same configuration is applicable to resources for reporting the CSI and vice versa.
   The configuration can be provided in or derived from an RRC IE, e.g., in BWP, BWP-Downlink, BWP-DownlinkDedicated, BWP-DownlinkCommon, PDSCH-config, PDSCH-ConfigCommon, PDSCH-ServingCellConfig, servingcellconfig, servingcellconfigcommon, servingcellconfigcommonSIB, downlinkconfigcommon, DownlinkConfigCommonSIB, CSI-MeasConfig or CSI-ReportConfig.
   The configuration can be provided in or derived from at least one of the 3 parameters; resourcesForChannelMeasurement, csi-IM-ResourcesForInterference, nzp-CSI-RS-ResourcesForInterference.
      If the configuration is provided in or derived from at least one parameter, then it applies to the others as well.
   The configuration is provided in or derived from elsewhere and applied to at least one of resourcesForChannelMeasurement, csi-IM-ResourcesForInterference, nzp-CSI-RS-ResourcesForInterference.
   The configuration is provided in or derived from any one or two of the parameters resourcesForChannelMeasurement, csi-IM-ResourcesForInterference, nzp-CSI-RS-ResourcesForInterference. The other parameter(s) need not follow the same configuration.
The configuration (1 or 2) for the resources for CSI-RS or resources for reporting the CSI follows the configuration of another channel/signal, e.g., PDSCH which can be provided in or derived from an RRC IE, e.g., in BWP, BWP-Downlink, BWP-DownlinkDedicated, BWP-DownlinkCommon, PDSCH-config, PDSCH-ConfigCommon, PDSCH-ServingCellConfig, servingcellconfig, servingcellconfigcommon, servingcellconfigcommonSIB, downlinkconfigcommon, DownlinkConfigCommonSIB, CSI-MeasConfig or CSI-ReportConfig. E.g., if the PDSCH follows configuration 1, then the resources for CSI-RS and/or resources for reporting the CSI also follows configuration1. In another example, if the PUCCH/PUSCH follows configuration 1, then the resources for reporting CSI also follow configuration1.
The valid symbol type for the resources for CSI-RS or resources for reporting the CSI follows the valid symbol type of another channel/signal, e.g., PDSCH which can be provided in or derived from an RRC IE, e.g., in BWP, BWP-Downlink, BWP-DownlinkDedicated, BWP-DownlinkCommon, PDSCH-config, PDSCH-ConfigCommon, PDSCH-ServingCellConfig, servingcellconfig, servingcellconfigcommon, servingcellconfigcommonSIB, downlinkconfigcommon, DownlinkConfigCommonSIB, CSI-MeasConfig or CSI-ReportConfig. E.g., if the valid symbol type for PDSCH is SBFD, then the valid symbol type for resources for CSI-RS and/or resources for reporting the CSI is also SBFD. In another example, if the valid symbol type for PUCCH/PUSCH is SBFD, then the valid symbol type for resources for reporting CSI is also SBFD.
If the configuration for the resources for CSI-RS is configuration 1 and the valid symbol type is e.g., SBFD, then the CSI-RS resources only on SBFD symbols are received and the CSI-RS on non-SBFD symbols are ignored. Similar rule applies for valid symbol type of non-SBFD.
   The reporting resources for CSI can also follow the configuration and valid symbol type of the resources for CSI-RS.
If the configuration for the resources for CSI-RS is configuration 2, then the CSI-RS resources on SBFD symbols and non-SBFD symbols are received.
   The reporting resources for CSI can also follow the configuration of the resources for CSI-RS.
If the configuration for reporting resources for CSI is configuration 1 and the valid symbol type is e.g., SBFD, then the CSI is reported only on SBFD symbols. Similar rule applies for valid symbol type of non-SBFD.
   The resources for receiving CSI-RS can also follow the configuration and valid symbol type of the reporting resources for CSI. In one case, the UE receives on both SBFD and non-SBFD symbols but calculate only on the valid symbol type. In another case, the UE only receives CSI-RS on the valid symbol type.
If the configuration for reporting resources for CSI is configuration 2, then the CSI is reported on SBFD symbols and non-SBFD symbols.
   The resources for receiving CSI-RS can also follow the configuration of the reporting resources for CSI.
Sounding Reference Signal, SRS:
   The configuration (1 or 2) of some other signal/channel applies to SRS. E.g., the configuration of PUSCH.
   In case of configuration 1, the valid symbol type for SRS is the same as the valid symbol type for some other signal/channel, e.g. PUSCH.
   In case of configuration 1, the valid symbol type for SRS is provided explicitly
      E.g., it can be provided in SRS-config.
   The configuration (1 or 2) is provided explicitly for SRS:
      The valid symbol type is provided explicitly.
   The configuration (1 or 2) is provided implicitly:
      If a valid symbol type is provided, then the configuration is 1, otherwise it is configuration 2.
   The same configuration (1 or 2) and/or valid symbol type is applicable for all types of SRSs or each type can have a separate configuration/valid symbol:
      Types can refer to aperiodic, periodic, triggered, scheduled or semi-persistent and/or
      Types can refer to the usage of SRS: codebook, non-codebook, beamforming, beam management, antenna switching and/or antenna selection.
   A default configuration is defined for SRS in the specification.
   No configuration is explicitly provided for SRS. E.g., the UE interprets the configuration from the gNB scheduling.

The UE might prefer a first configuration restricted to one symbol type, e.g.,
SBFD only
non-SBFD only.

It might even choose which one it prefers, e.g., SBFD symbols may have too much interference for this UE.

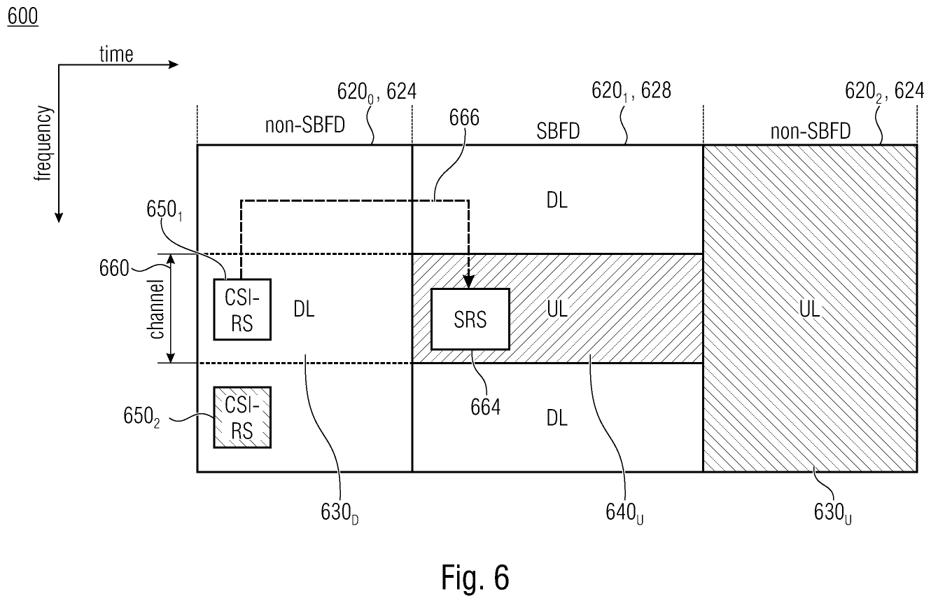

FIG. 6 exemplarily depicts a schematic representation 600 of an association between SRS signalling and a reference signal, in accordance with embodiments, using a time-frequency grid.

In accordance with embodiments, the transceiver device such as a user equipment, UE, may operate in a wireless communication network which provides a plurality of time resource in a time-frequency grid, such as a plurality of time slots 620₀-620₂, as exemplarily depicted. A first subset 620₀, 620₂ of the plurality of time resources are non-SBFD time resources, or non-SBFD time slots 624 while a second subset 6201 of the plurality of time resources are SBFD time resources, or SBFD time slots 628. That is, generally, the transceiver device may be configured with SBFD symbols or slots or resources as well as non-SBFD symbols or slots or resources.

A first time resource, or slot 620₀, of the first subset being non-SBFD time resources 624 is configured for downlink, DL, communication or signalling and a second time resource, or slot 620₂, of the first subset being non-SBFD time resources 624 is configured for uplink, UL, communication or signalling. That is, the first time resource 620₀ comprises a band 630_{D} associated with DL communication or signalling while the second time resource 620₂ comprises a band 630_{U} associated with UL communication or signalling.

A time resource, or slot 620₁, of the second subset being SBFD time resource(s) 628 is configured in a DUD configuration (specified in an order of increasing frequency). That is, the SBFD time resource 620₁ comprises at least one sub-band for DL communication or signalling 640_{D} and at least one sub-band for UL communication or signalling 640_{U}.

A channel 660 may correspond to a frequency slicing, or a subset of the frequency resources available to the transceiver device for communication or signalling. That is, the channel 660 may be a portion of the frequency resource associated with a non-SBFD time resource or a SBFD time resource. As exemplarily depicted in FIG. 6, the channel 660 may correspond to a frequency slice, or frequency resource, of a sub-band 640_{U} in a SBFD time resource 628.

The transceiver device may receive CSI-RS signalling or communication 650, i.e. first reference signal 650₁ and a second reference signal 650₂, wherein the first and second reference signals 650₁, 650₂ may be received or scheduled or arranged or configured in different portions, or parts, of frequency resources of the non-SBFD time resource 620₀. As exemplarily depicted, the first CSI-RS signalling or communication 650₁, i.e. first reference signal 650₁, is arranged to be in the channel 660, and the second CSI-RS signalling or communication 650₂, i.e. second reference signal 650₂, is arranged to be separate from the first reference signal 650₁ occupying a different frequency resources (e.g. higher valued as depicted, but could naturally be lower valued frequency resources) within the non-SBFD time resource 624. That is, an entity such as a BS or gNB may transmit the CSI-RS 650 as the first and second reference signals 650₁, 650₂ in different portions, or parts, of frequency resources of the non-SBFD time resource 620₀. Alternatively, the first reference signal 650₁ and the second reference signal 650₂, may also be received by the transceiver device (i.e. transmitted by the entity such as BS or gNB) in different portions, or parts, of frequency resources of a SBFD time resource. For example, it may be that the signals 650₁, 650₂ are received in different sub-bands of the SBFD time resource.

FIG. 6 exemplarily depicts a sounding reference signal, SRS, 664 which could be transmitted by the transceiver device in a UL sub-band 640_{U} of the SBFD time frequency resource. For example, the SRS 664 may be configured to be valid or operable or configurable for the SBFD time frequency resource. Alternatively, the SRS may be configured to be valid or operable or configurable for the non-SBFD time frequency resource. For example, the transceiver device may process the SRS resource 664 on one type of symbol, either SBFD or non-SBFD.

For example, it may be that the transceiver device is provided with a resource of the first reference signal 650 as having one valid symbol type being a same valid symbol type as that of the SRS 664.

In accordance with embodiments, an association 666 (e.g. or relationship, or dependency) between the first reference signal 650₁ (e.g. first CSI-RS 650₁) and the SRS 664, which is denoted by the dashed line, may be present, and thus, the transceiver device may operate, or carry out its communications(s) or signalling(s), based on (e.g. or depending on, or using) the said association 666. That is, the SRS 664 transmission may depend on or configured by the CSI-RS 650 being the first reference signal. It may be that the association 666 may be pre-existing or pre-configured with respect to the transceiver device, or alternatively, derived or determined by the transceiver device.

For example, the transceiver device may be adapted to associate the SRS 664, for example, a set of resources/resource set used for the SRS, on SBFD symbols with the first reference signal 650 being received on non-SBFD symbols, as shown in FIG. 6. Alternatively, the transceiver device may be adapted to associate the SRS, for example, a set of resources/resource set used for the SRS, on non-SBFD symbols with the first reference signal being received on non-SBFD symbols. For example, the transceiver device may be adapted to associate the SRS, e.g. a set of resources/resource set used for the SRS, with the first reference signal on any symbol type.

As exemplarily depicted in FIG. 6, the first reference signal, or first CSI-RS, 650₁ is configured to be within the same channel 666 as that configured for the SRS 664. That is, it may be that the first reference signal 650, or one or more parts thereof, may be configured to be in the same channel as that configured for the SRS 664.

Further, the transceiver device may be adapted so as to operate, or process, or consider, the association 664 as valid (or e.g. allowable, or operable) based on, or subjected to, a pre-defined validity criterion, or condition. For example, the pre-defined validity criterion, or condition, may be related to whether the first reference signal 650, or any of the reference signal(s) if multiple reference signals are signalled or communicated, is received within a bandwidth (e.g. bandwidth slice or portion or part; or e.g. a channel bandwidth, or bandwidth of channel 660) being similar, such as being same, as the UL bandwidth 640_{U} of the SBFD time resource 628. That is, the transceiver device may operate, or process, or consider, the association 666 as valid when the first reference signal and the SRS occupy the same bandwidth, or same channel bandwidth. Alternatively, the transceiver device may operate, or process, or consider, the association 666 as valid when the first reference signal and the SRS occupy different bandwidth, or different channel bandwidth. For example, in this regard, it may be that a difference between the starting frequency resources for the SRS 664 and the CSI-RS being the first reference signal 650 is less than a specific number of frequency resources. For example, the specific number of frequency resources may be a pre-defined number. It may even be that the specific number of frequency resources could be a number dynamically configured via signalling or communication prior to the signalling or communication of either the first reference signal or the SRS.

As exemplarily depicted, the second reference signal 650₂ is arranged, or configured, to be not within, or outside, the channel 660, and thus the transceiver device may ignore the second reference signal 650₂.

Further, the transceiver device may be adapted so as to not operate, or not consider, or ignore the association 664 based on, or subjected to, a pre-defined invalidity criterion, or condition. That is, the transceiver device may process or consider the association 664 as invalid depending on the pre-defined invalidity criterion or condition. For example, the pre-defined invalidity criterion, or condition, may be related to whether the first reference signal 650, or any of the reference signal(s) if multiple reference signals are signalled or communicated, is received within a bandwidth (e.g. bandwidth slice or portion or part; or e.g. a channel bandwidth, or bandwidth of channel 660) being similar, such as being same, as the UL bandwidth 640_{U} of the SBFD time resource 628. That is, the transceiver device may not operate, or not process, or not consider, the association 666 as valid, thereby ignoring it, when the first reference signal and the SRS occupy the same bandwidth, or same channel bandwidth. Alternatively, the transceiver device may not operate, or not process, or not consider, the association 666 as valid, thereby ignoring it, when the first reference signal and the SRS occupy different bandwidth, or different channel bandwidth. For example, in this regard, it may be that a difference between the starting frequency resources for the SRS 664 and the CSI-RS being the first reference signal 650 is less than a specific number of frequency resources. For example, the specific number of frequency resources may be a pre-defined number. It may even be that the specific number of frequency resources could be a number dynamically configured via signalling or communication prior to the signalling or communication of either the first reference signal or the SRS.

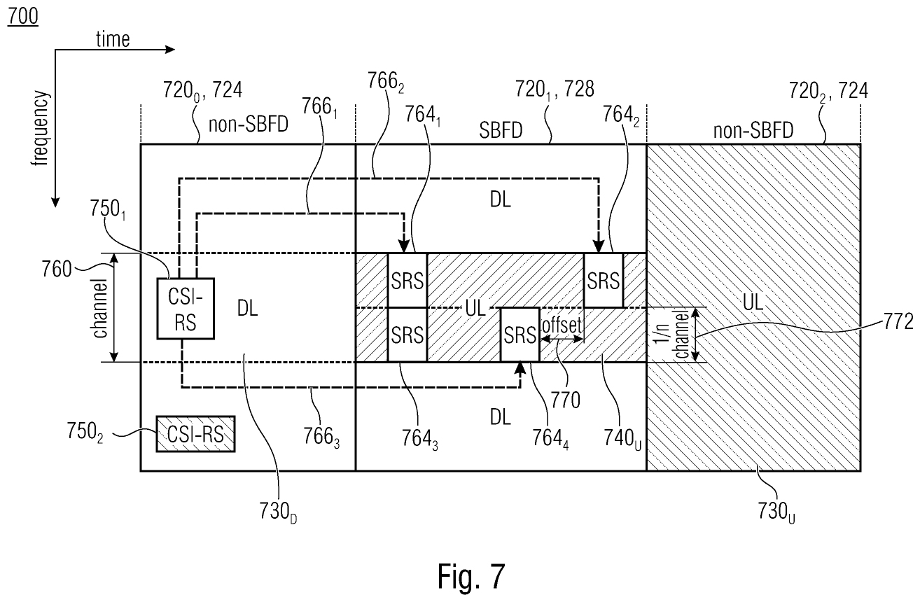

FIG. 7 exemplarily depicts a schematic representation 700 of a plurality of associations between SRS signaling(s) and a reference signal, in accordance with embodiments, using a time-frequency grid.

The plurality of time resources, depicted as time slots 7201, 7202, 7203, comprise a first subset 720₀, 720₂ of the plurality of time resources being non-SBFD time resources 724 and a second subset 720₁ of the plurality of time resources being SBFD time resources 728, being similar to the exemplarily depiction of FIG. 6. Therefore, such details and explanations in this regard are transferable onto the depiction of FIG. 7, and are thus not repeated for the sake of brevity and conciseness of this disclosure.

In contrast to FIG. 6, a plurality of SRSs 764₁, 764₂, 764₃, 764₄ are depicted in FIG. 7. Therefore, the transceiver device may operate based on, or in accordance with, a plurality of associations 766₁, 766₂, 766₃ between the first reference signal, that is CSI-RS 750₁ and the plurality of SRSs 764₁, 764₂, 764₃, 764₄. That is, the one or more SRSs 764₁, 764₂, 764₃, 764₄ are associated with (e.g. depend on) a single reference signal 750₁. Similar to FIG. 6, the second reference signal 750₂ may be ignored for communication or signalling performed by the transceiver device. This may be, for example, due to the second reference signal 750₂ not fulfilling the predefined validity condition of the association. Therefore, the second reference signal 750₂ is depicted without an association with the SRSs 764.

For example, the transceiver device may be adapted to transmit the plurality of SRSs 764₁, 764₂, 764₃, 764₄ within the UL BW 740_{U} of the SBFD time resource 720₁, 728, wherein the plurality of SRSs 764₁, 764₂, 764₃, 764₄ may be configured with a single SRS ID. Further, the plurality of SRSs 764₁, 764₂, 764₃, 764₄ could be configured without frequency hopping such as being repeated in time domain. Alternatively, the plurality of SRSs 764₁, 764₂, 764₃, 764₄ could be configured with frequency hopping.

For example, the transceiver device may be adapted to transmit the plurality of SRSs 764₁, 764₂, 764₃, 764₄ within the UL BW 740_{U} of the SBFD time resource 720₁, 728, wherein the plurality of SRSs 764₁, 764₂, 764₃, 764₄ may be configured with multiple SRS IDs. Further, the plurality of SRSs 764₁, 764₂, 764₃, 764₄ could be configured without frequency hopping such as being repeated in time domain. Alternatively, the plurality of SRSs 764₁, 764₂, 764₃, 764₄ could be configured with frequency hopping.

As exemplarily depicted, the one or more, or the plurality, of SRSs 764₁, 764₂, 764₃, 764₄ are arranged, or scheduled, or configured, for transmission, such as by the transceiver device, to be within a sub-band 740_{U} of the SBFD time frequency resource. That is, at least one of, or as shown all of, the one or more SRSs 764₁, 764₂, 764₃, 764₄ may be limited, or restricted, to a certain (e.g. predefined, configured or pre-configured) time and/or frequency location with a frequency band or a portion of available or configurable frequency resources. This frequency band, or portion of available or configurable frequency resources, as exemplarily shown in FIG. 7, could be a sub-band having a channel bandwidth 760.

In particular, as shown in FIG. 7, at least two 766₁, 766₃ of the SRSs 764₁, 764₂, 764₃, 764₄ may occupy, or scheduled, or arranged, or configured, a same portion of the time resource(s), wherein the at least two SRSs 766₁, 766₃ occupy, or scheduled, or arranged, or configured, so as to encompass together a whole of the channel bandwidth 760. That is, the at least two SRSs 766₁, 766₃ may together span the channel bandwidth 760 for their transmission. For example, the at least two SRSs 766₁, 766₃ may be arranged, or configured, to be in adjacent sub-channels or adjacent channels. In this regard, each of the at least SRSs 766₁, 766₃ configured for the same portion of the time resources may occupy, or scheduled, or arranged, or configured, for a distinct sub-channel into which the channel 760 may be divided or grouped into. That is, the sub-channel may cover, or occupy, a fraction, or portion, 772 of the channel bandwidth 760. It may be that this fraction 772 could be 1/n, wherein n is a number greater than 1. As exemplarily depicted in FIG. 7, this fraction or portion 772 is ½, wherein each of the two sub-channels occupy half of the channel bandwidth 760. It may also be that the number n may not be restricted to being equal to a number (e.g. a count) of the SRSs and thus, the number n may even be larger than the number of SRSs which occupy the same portion of the time resources and cover, or span, a part the overall channel bandwidth 760. Therefore, it may be that the bandwidth of the SRSs arranged or configured within the channel may be less or equal to the channel bandwidth 760.

Further, exemplarily depicted in FIG. 7, at least two 766₂, 766₄ of the SRSs 764₁, 764₂, 764₃, 764₄ may occupy, or scheduled, or arranged, or configured, different portions of the time resource within the sub-band 740_{U} of the SBFD resource 728. Therefore, the two SRSs 766₂, 766₄ may be offset, or shifted, 770 in time domain with respect to each other. Although the SRSs are exemplarily depicted to be offset, or shifted, 770 in time while belonging to different sub-channels of the channel 760, it may be that the SRSs are offset, or shifted, 770 in time while being configured or arranged, such as for transmission by the transceiver device, in a same sub-channel.

The offset 770 could be based, or depend, on a threshold, or a time threshold. For example, the threshold could be a minimum time length or a maximum time length such as a time duration of a SBFD resource. For instance, the threshold or time threshold could be specified or measured or defined as a time duration. The time duration could be in terms of: absolute time, fixed units, symbols, slots, half-slots, mini-slots, subframes, radioframes, hyperframes, or type. For example, the absolute time could be in terms of milliseconds. For example, the fixed units could be in terms of counting a number of resources such as 5 SRS resources. For example, the type could be related to a count of a certain transmission type, such as to count a number of SBFD symbols. In case, when more than at least two SRSs may be time shifted with respect to each other, further offsets may be present, in accordance with the above mentioned details.

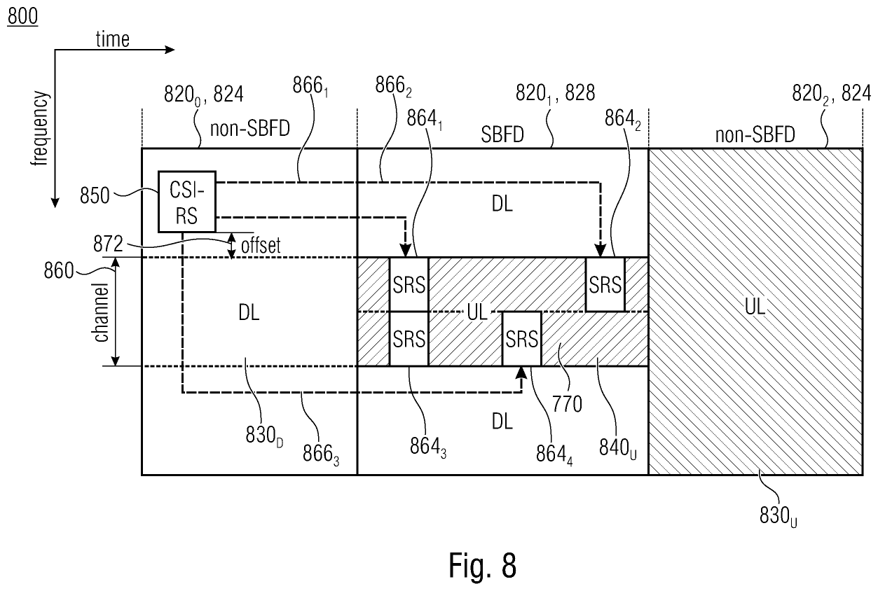

FIG. 8 exemplarily depicts a schematic representation 800 of a plurality of associations between SRS signaling(s) and a reference signal, in accordance with embodiments, using a time-frequency grid.

The plurality of time resources, depicted as time slots 820₁, 820₂, 820₃, comprise a first subset 820₀, 820₂ of the plurality of time resources being non-SBFD time resources 824 and a second subset 820₁ of the plurality of time resources being SBFD time resources 828, being similar to the exemplarily depiction of FIGS. 6 and 7. Therefore, such details and explanations in this regard are transferable onto the depiction of FIG. 8, and are thus not repeated for the sake of brevity and conciseness of this disclosure.

In contrast to FIGS. 6 and 7, a single reference signal 850 is depicted in FIG. 8. An offset 872 (e.g. frequency offset) indicating a frequency domain offset, or shift, between the first reference signal, i.e. CSI-RS 850 and the plurality of SRSs 864₁, 864₂, 864₃, 864₄ is depicted. The offset 872 is measured, or defined, or specified, relative to a position (e.g. start/starting position) of the channel 860 which corresponds to the UL sub-band 840_{U} in the SBFD time slot 820₁, 828 wherein, or within which, the SRSs 864₁, 864₂, 864₃, 864₄ are scheduled, or arranged, or configured. In this regard, the frequency offset 872 may be defined or measured or specified in relation to the frequency resources associated with the SRS transmission occasions 864₁, 864₂, 864₃, 864₄.

The frequency offset 872 could be based, or depend, on a threshold, or a frequency threshold. For example, the threshold could be a minimum amount of frequency resources or a maximum amount of frequency resources such as a frequency span of a SBFD resource, such as a frequency span of one or more sub-band(s) thereof. For instance, the threshold or frequency threshold could be specified or measured or defined in terms of frequency resources. The frequency resources could be one or more of: a channel, a system bandwidth, a subchannel, a subband, a bandwidth part, BWP, a component carrier, one or more subcarriers, a physical resource block, PRB, a fixed or variable amount of bandwidth at a fixed or varying frequency or location in a frequency grid, one or more pairs or sets of frequency resources, wherein the set of frequency resources are to be used in the same or different time resources, and a frequency comb.

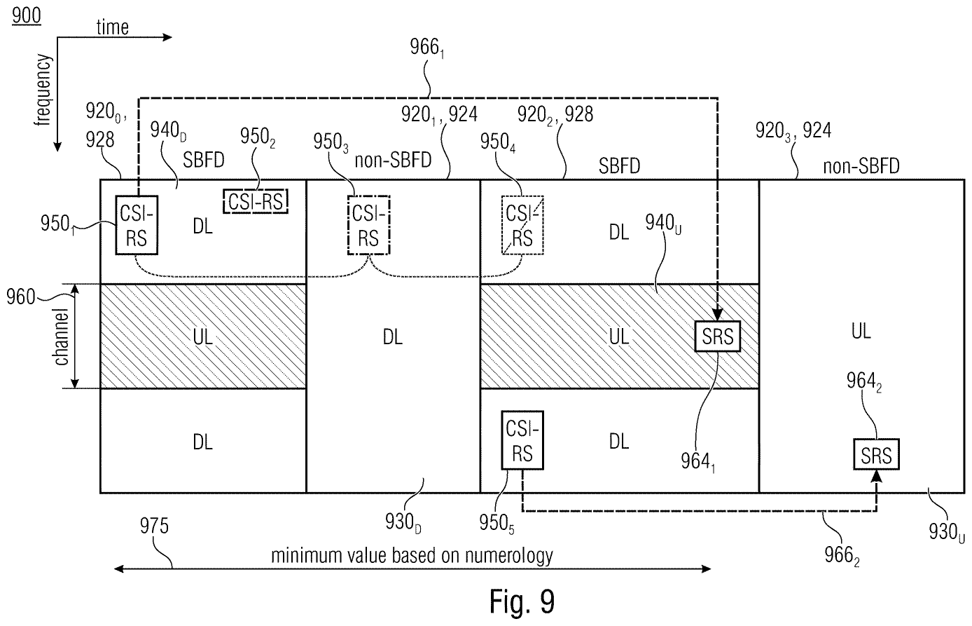

FIG. 9 exemplarily depicts a schematic representation 900 of associations between SRS signalling and reference signals, in accordance with embodiments, using a time-frequency grid. In particular, FIG. 9 presents an example of associated CSI-RS-SRS depending on the symbol type, such the symbol type being SBFD or non-SBFD symbol.

In accordance with embodiments, the transceiver device such as a user equipment, UE, may operate in a wireless communication network which provides a plurality of time resource in a time-frequency grid, such as a plurality of time slots 920₀-920₃, as exemplarily depicted. A first subset 920₁, 920₃ of the plurality of time resources are non-SBFD time resources, or non-SBFD time slots 924 while a second subset 920₀, 920₂ of the plurality of time resources are SBFD time resources, or SBFD time slots 928. That is, generally, the transceiver device may be configured with SBFD symbols or slots or resources as well as non-SBFD symbols or slots or resources.

A first time resource, or slot 920₁, of the first subset being non-SBFD time resources 924 is configured for downlink, DL, communication or signalling and a second time resource, or slot 920₃, of the first subset being non-SBFD time resources 924 is configured for uplink, UL, communication or signalling. That is, the first time resource 920₁ comprises a band 930_{D} associated with DL communication or signalling while the second time resource 920₃ comprises a band 930_{U} associated with UL communication or signalling.

Both time resources, or slots 920₀, 920₂, of the second subset being SBFD time resource(s) 928 are configured in a DUD configuration (specified in an order of increasing frequency). That is, the SBFD time resource 920₀, 920₂ each comprise at least one sub-band for DL communication or signalling 940_{D} and at least one sub-band for UL communication or signalling 940_{U}.

A channel 960 may correspond to a frequency slicing, or a subset (e.g. such as part of a bandwidth part or portion) of the frequency resources available to the transceiver device for communication or signalling. That is, the channel 960 may be a portion of the frequency resource associated with a non-SBFD time resource or a SBFD time resource. As exemplarily depicted in FIG. 9, the channel 960 may correspond to a frequency slice, or frequency resource, of a sub-band 940_{U} in a SBFD time resource 928.

In particular, FIG. 9 exemplarily depicts multiple transmission occasions of a first reference signal, such as CSI-RS, 950₁, 950₃, 950₄ and single transmission of a second reference 950₂ and of a third reference signal 950₅. For example, the multiple transmissions of the first reference signal relate to its repetitive nature, that is, the first reference signal 950₁, 950₃, 950₄ may be transmitted in the wireless communication network in a periodic or aperiodic or triggered or scheduled manner, and thus, for example, may be received by the transceiver device.

FIG. 9 exemplarily depicts that the association 966 between reference signal(s) 950 and SRS 964 may depend on a point in time (e.g. time position specified using any example of time resources described in this disclosure) when the reference signal(s), e.g. the first reference signal or other reference signal(s), are transmitted. Additionally, or alternatively, the association 966 between reference signal(s) 950 and SRS 964 may depend on a numerology. For example, the numerology may define the association 966.

For example, as depicted in FIG. 9, the second reference signal occasion 950₂ may not be associated with an SRS transmission 964 of the transceiver device. This may be due to criterion, or conditions, restricting or limiting the association with the second reference signal occasion 950₂ with the SRS transmission 964. Thus, the second reference signal occasion 950₂ may not be considered, or treated, as valid by the transceiver device.

As exemplarily depicted in FIG. 9, the second repeated instance 950₄ of CSI-RS transmission (e.g. being the first reference signal) may be transmitted in the same time resource 920₂, i.e. the SBFD slot 928, as the SRS 9641. For example, based on the first reference signal 950₄ being transmitted within a same symbol of the SBFD resource 920₂, 928, the transceiver device may be adapted to consider, or treat, or process, the first reference signal 950₄ as not being associated with, or depending on, or lacking an association or dependency with an SRS 964₁ within the same SBFD resource. In other words, depending on the time-position of the first reference signal, it may not be considered, or treated, valid for an association with the SRS 964₁ by the transceiver device. Further, this lack of association, or dependency, may arise due to a condition or criterion, such as the first reference signal 950₄ not fulfilling, or meeting, a criterion or condition related to a time offset (e.g. time gap). For example, as exemplarily depicted in FIG. 9, the time offset (e.g. time gap) could be a minimum time offset 975, specified in terms of a minimum number of symbols or time resources. That is, the association between first RS 950 and SRS 964 may be conditioned on a minimum number of symbols or time resources (e.g. at least a specific number of symbols or time resources) being present between the first RS 950 and the SRS 964. The minimum number of symbols or time resources, for example, may be pre-configured or, for example, be dynamically configured by the transceiver device prior to the first reference signal signalling or communication.

The association between the RSs and the SRSs may be subjected to multiple criterions, or conditions. For example, the first repeated instance 950₃ of CSI-RS transmission (e.g. being the first reference signal) may not be considered, or treated, or processed as valid in terms of its association with the SRS 964₁ when the association is conditioned on either that the reference signal and the SRS have a same symbol type (e.g. SBFD or non-SBFD) or that the first reference signal and the SRS have a minimum time offset, such as the minimum number of symbols or time resources between them. Although the condition on the association that the reference signal and the SRS have a symbol type may be combined with the minimum time offset, each may also be configured as a standalone criterion. The RS 950₃ may have a different symbol type than the SRS 964₁, as exemplarily depicted, the former has a non-SBFD symbol type while the latter has a SBFD symbol type.

FIG. 9 exemplarily depicts the third reference signal 950₅, being of a same kind as the first 950₁, 950₃, 950₄ and the second 950₂ reference signals, being associated, or comprising an association, 966₂ with the further SRS 964₂. Here the reference signal may not be conditioned on a minimum value of time resources, such as based on numerology. Further, the association 966₂ may be considered valid if the RS and the SRS have different symbol types. As exemplarily depicted in FIG. 9, the CSI-RS being the third RS 950₅ has a SBFD symbol type while its associated SRS has a non-SBFD symbol type.

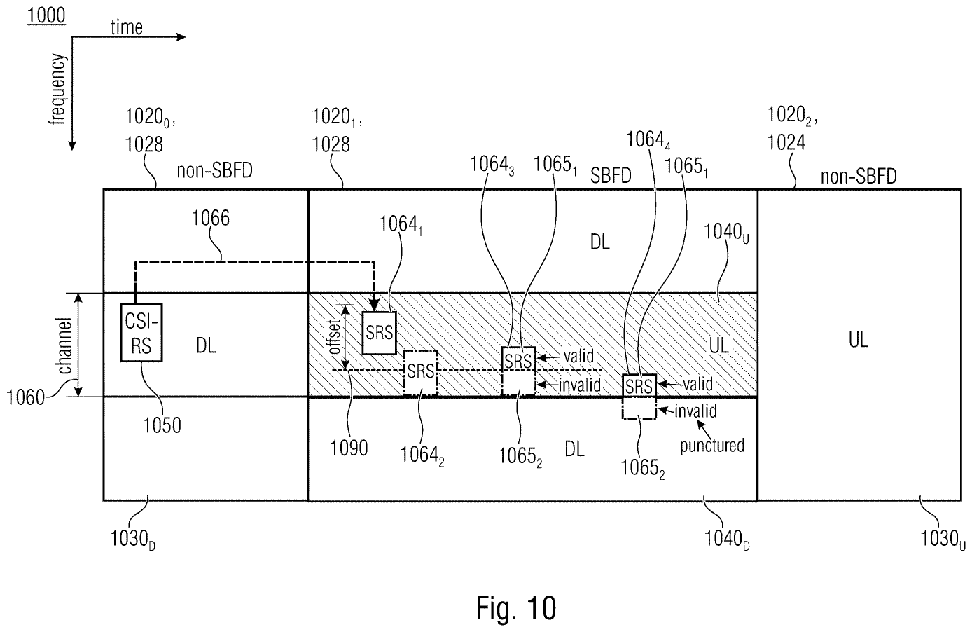

FIG. 10 exemplarily depicts a schematic representation 1000 of associations between SRS signalling and reference signals, in accordance with embodiments, using a time-frequency grid. In particular, FIG. 10 presents an example of associated CSI-RS-SRS wherein validity of the SRS may be subject to constraints.

In accordance with embodiments, the transceiver device such as a user equipment, UE, may operate in a wireless communication network which provides a plurality of time resource in a time-frequency grid, such as a plurality of time slots 1020₀-1020₂, as exemplarily depicted. A first subset 1020₀, 1020₂ of the plurality of time resources are non-SBFD time resources, or non-SBFD time slots 1024 while a second subset 10201 of the plurality of time resources are SBFD time resources, or SBFD time slots 1028. That is, generally, the transceiver device may be configured with SBFD symbols or slots or resources as well as non-SBFD symbols or slots or resources.

A first time resource, or slot 1020₀, of the first subset being non-SBFD time resources 1024 is configured for downlink, DL, communication or signalling and a second time resource, or slot 1020₂, of the first subset being non-SBFD time resources 1024 is configured for uplink, UL, communication or signalling. That is, the first time resource 1020₀ comprises a band 1030_{D} associated with DL communication or signalling while the second time resource 1020₂ comprises a band 1030_{U} associated with UL communication or signalling.

The time resource, or slot 1020₁ of the second subset being SBFD time resource(s) 1028 are configured in a DUD configuration (specified in an order of increasing frequency). That is, the SBFD time resource 1020₁ comprises at least one sub-band for DL communication or signalling 1040_{D} and at least one sub-band for UL communication or signalling 1040_{U}.

A channel 1060 may correspond to a frequency slicing, or a subset (e.g. such as part of a bandwidth part or portion) of the frequency resources available to the transceiver device for communication or signalling. That is, the channel 1060 may be a portion of the frequency resource associated with a non-SBFD time resource or a SBFD time resource. As exemplarily depicted in FIG. 10, the channel 1060 may correspond to a frequency slice, or frequency resource, of a sub-band 1040_{U} in a SBFD time resource 1028.

FIG. 10 exemplarily depicts multiple transmission occasions of a SRS 1064₁, 1064₂, 1064₃, 1064₄. For example, the multiple transmissions of the SRS 106₄ relate to its repetitive nature, that is, the SRS 1064₁, 1064₂, 1064₃, 1064₄ may be transmitted by the transceiver device in the wireless communication network in a periodic or aperiodic or triggered or scheduled manner.

A first reference signal, being CSI-RS, 1050 may be associated with, or have an association (e.g. dependency) 1066 with at least one SRS transmission occasion 1064₁ of the plurality of SRS transmission occasions 1064₁, 1064₂, 1064₃, 1064₄. In particular, FIG. 10 exemplarily depicts that the association of the plurality of SRS transmission occasions 1064₂, 1064₃, 1064₄ with the first RS (e.g. CSI-RS) 1050 may be constrained, or limited, or restricted, depending on a frequency position of the first RS 1050. For example, the transceiver device may be adapted to transmit the SRSs 1064 depending on a criterion, or condition, based on the frequency position of the first RS associated with the SRS transmission occasion.

For example, the condition, or criterion, may be related to a frequency offset 1090, or an offset, or portion, 1090 in a frequency domain or in terms of frequency resources. Additionally, or alternatively, this offset could also be in time domain or in terms of time resources. That is, the transceiver device may be adapted to transmit the SRS 106₄ within a certain frequency offset 1090 with respect to its associated first reference signal 1050. For example, the offset 1090 could be specified in frequency domain or in terms of frequency resources, which themselves could be any of the various examples of frequency resources described in this disclosure. For example, a starting point of the frequency offset 1090 may be same as a starting point of the first RS, such as CSI-RS, 1050. For example, an end point of the frequency offset 1090 may be larger than an end point of the first RS, such as CSI-RS, 1050. However, the end point of the frequency offset 1090 could even be same as that of the first RS 1050 or even smaller than that of the first RS. For example, the frequency offset 1090 may be configured to not exceed the channel bandwidth 1060, or to not exceed a bandwidth occupied by the first RS, or integer multiples of the said bandwidth. For example, the position of the frequency offset may be restricted to be in the same channel as that of the first RS and/or the sub-band 1040 of the SBFD resource that the SRS may be scheduled, or arranged, or configured for transmission by the transceiver device. For example, the offset 1090 may be pre-defined or pre-configured. Alternatively, it is feasible that this offset could be dynamically configured by the transceiver device prior to the signalling or communication associated with the first RS 1050.

As exemplarily depicted, the scheduled SRS occasion 1064₂ may violate the predefined offset in frequency (and/or in time). The scheduled SRS occasion 1064₂ may thus be considered or regarded as invalid with respect to the first RS 1050. That is, the transceiver device may be configured to consider, or regard, or treat or process, SRS occasion to be invalid if it violates the offset 1090. Thus, the transceiver device may be adapted to drop or ignore the SRS occasion 1064₂.

Further exemplarily depicted in FIG. 10, a part 1065₁ of the scheduled, or configured, SRS occasion 1064₃ may not violate, i.e. be within, the offset 1090 in frequency (and/or, although not depicted, in time) and an another part 10652 of the scheduled occasion 1064₃ may violate the offset 1090 in frequency (and/or, although not depicted, in time). The part 1065₁ scheduled SRS occasion 1064₂ may thus be considered or regarded as valid with respect to the first RS 1050 while the another part 10652 scheduled SRS occasion 1064₂ may thus be considered or regarded as invalid with respect to the first RS 1050. That is, the transceiver device may be configured to consider, or regard, or treat or process, the part 1065₂, or portion, SRS occasion to be invalid if it violates the offset 1090. Thus, the transceiver device may be adapted to drop or ignore the part 1065₂ SRS occasion 1064₂ and may use resources of, or belonging to the non-violating part 1065₁ of the SRS occasion 1064₃.

For example, the transceiver device may be adapted to determine whether to ignore the complete SRS occasion, such as the SRS occasion 1064₃, or to ignore or drop only the part, such as the another part 1065₂, which violates the offset 1090, i.e. exceeds the offset in its frequency and/or time span, based on criterion or condition. For example, the criterion or condition may be related, or depend, on a share, or a fraction, or a portion, of the violating part, such as the another part 1065₂, with regard to the overall SRS occasion, such as the SRS occasion 1064₃. Thus, it may be that, depending on the condition or criterion, a size of the violating part of the SRS occasion could be defined, depending on which the transceiver device may either ignore the respective violating part or the entirety of the SRS occasion. That is, if the size of the violating part (e.g. invalid with respect to the offset 1090) of the SRS occasion is below or smaller than a specific value, the transceiver device may ignore the violating part of the SRS occasion and if the size of the violating part (e.g. invalid with respect to the offset 1090) of the SRS occasion exceeds or is larger than a specific value, the transceiver device may ignore the an entirety, or whole, of the SRS occasion. For example, the size of the violating part of the SRS occasion could be configured or pre-configured/pre-defined.

For example, the part of the SRS occasion violating the offset (or invalid with respect to it) could be punctured so as to enable use of the resources belonging or associated with the said part for further signalling or transmission, such as transmissions of the transceiver device related to data and/or control. The resources belonging or associated with the said part could for example be resource elements, REs, in the positions of the said part.

Another exemplary depiction in FIG. 10 relates to the scheduled, or configured, SRS occasion 1064₄ being arranged, or configured, to overlap adjacently arranged sub-bands 1040_{U}, 1040_{D}. That is, the SRS occasion 1064₄ may be partially arranged in a first sub-band 1040_{U} as well as in a second sub-band 1040_{D} of a SBFD resource 1020₁, 1028. In such a case, the transceiver device may be adapted to consider, or regard, or process, a part, such as the part 1065₁ of the SRS occasion 1064₄, which is in a UL sub-band of the SBFD resource as valid while the transceiver device may be adapted to consider, or regard, or process, another part, such as the part 1065₂ of the SRS occasion 1064₄, as invalid for the SRS transmission in association with the RS 1050. Alternatively, it may be that the transceiver device may be adapted to consider, or regard, or process, the entirety, or whole, of the SRS occasion 1064₄ as valid despite its overlap with the DL sub-band 1040_{D} of the SBFD resource 1020₁, 1028. That is, the SRS occasion 1064₄ may be fully transmitted by the transceiver device in spite of being arranged or scheduled in parts, or partially, in the DL sub-band 1040_{D}. In this regard, the BS or gNB may, optionally, adapt its communication or signalling so as to not overlap with the part of the SRS transmission which extends into the DL sub-band.

Further, for example, the transceiver device may report a capability, wherein the capability indicates a measure of its ability to interpolate and/or extrapolate a channel, such as the exemplarily depicted channel 1090, in case the first reference signal 1050 and the SRS are in, or occupy, or configured, for different channel bandwidths or different frequency resources.

In relation to FIGS. 6-10, the present disclosure discusses further details and explanations which are readily transferable to the embodiments and examples presented so far.

It is emphasised that an association between one or more reference signals, such as the first reference signals, and SRS indicates the association between the one or more reference signals and a set of resources (or e.g. a resource set) used, or configured for signalling or communication, or intended for signalling or communication to be carried out, for SRS. That is, the association may define a relationship or a dependency between one or more resource elements comprised in the set of resources, or e.g. resource set, used, or employed, for the SRS transmission by the transmission device.

Further, for example, the transceiver device may be adapted to determine, or calculate, a precoder for SRS transmission, advantageously in case of periodic or semi-persistent scheduling of the reference signal, such as a semi-persistent or periodic CSI-RS, being a same symbol type as configured for the resource set used for the SRS. Therefore, the transceiver device may use CSI-RS resources being of a same symbol type as that of the SRS resources, benefitting from a calculation or determination or configuration of a precoder used for the SRS transmission.

For example, the transceiver device may operate according to a spatial relation (or e.g. spatial dependency) between the SRS and one or more reference signals in addition to the first reference signal, such as a second reference signal. For example, the second reference signal could be a same signal as the first reference signal or it could be a different signal than the first reference signal. For example, the second reference signal being different to the first reference signal could be SSB, or CSI-RS or a further SRS. The further SRS could have a different configuration such as SRS-ID compared to already scheduled or configured SRS.

The association between the SRS, in particular the resource set used for the SRS, and the first reference signal may depend, or be based on, symbol types of the SRS and of the first reference signal. The same consideration for the dependency of the association applies to the associations between SRS and any reference signals in addition to the first reference signal if signalled or communicated to the transceiver device.

For example, the transceiver device may be adapted to associate the SRS, e.g., a resource set used for the SRS, on SBFD symbols with the first reference signal being received on SBFD symbols. For example, the transceiver device may be adapted to associate the SRS, e.g., a resource set used for the SRS, on non-SBFD symbols with the first reference signal received on non-SBFD symbols. For example, the transceiver device may be adapted to associate the SRS, e.g., a resource set used for the SRS, with the first reference signal on any symbol type.

Further, the transceiver device may be adapted to associate the SRS, e.g., a resource set used for the SRS, with a most recent resource used for the first reference signal. For example, the most recent resource may satisfy, or fulfil, one or more, or all, applied timing conditions. For example, the applied timing conditions may relate to a minimum gap between the last symbol of the CSI-RS and the starting symbol of SRS. This minimum gap, e.g. specified in time and/or frequency domain, could be a specific number of OFDM symbols or a specific number of time resources. For example, the specific number of OFDM symbols or a specific number of time resources, such as ‘N’, could be defined in a specification.

In regard to the figures described in this disclosure, further details of the transceiver device, such as a user equipment, UE, in relation to SRS frequency hopping are now described. The transceiver device may transmit the SRS, and user frequency hopping, FH, for transmission. For example, the transceiver device may be adapted to be configured to transmit different SRS, or different parts of SRS in different frequency parts. The transceiver device may be adapted to be configured to transmit the different SRS or the different parts of SRS in different frequency parts by a base station such as a gNB. For example, the different frequency parts, or portions, may be parts, or portions, of the frequency resource. Further, the transceiver device may be adapted to be configured to transmit SRS or different parts of SRS additionally in different time domain resources. Here, the different examples of time resources already described in the disclosure constitute examples for the time resource in relation to the transceiver device using frequency hopping for transmission of the SRS. Additionally, the frequency resource in relation to the transceiver device using the frequency hopping for transmission of the SRS may be any of the examples described in this disclosure in regard to frequency resources. For example, different parts of the frequency hopped SRS may be associated with different reference signal resources. For example, different reference signal resources here could be associated with CSI-RS resources, the CSI-RS resources may be used for precoder calculation, or determination, or the different reference signal resources could comprise different spatial relations. For example, the different spatial relations may be related to multiple SSB-IDs, wherein a different SSB may be associated with a different beam.

It may be that the SRS is valid for only one symbol type out of a SBFD symbol type and a non-SBFD symbol type. In such a case, the transceiver device may transmit all, or the entirety, a whole of, the frequency hopped SRS resources on the symbol type that is considered valid, e.g., the valid symbol type.

Further, it may be that the SRS is valid for one symbol type and at least a part of the frequency hopped SRS is scheduled differently than the valid symbol type. That is, the symbol type of the part of the frequency hopped SRS may be different than the valid symbol type, i.e., the symbol type that is considered, or regarded, or processed as a valid symbol type. In such a case, the transceiver device may be adapted to perform one or more of: dropping, or ignoring, a frequency hopped SRS in the invalid symbol type, or postponing a frequency hopped SRS in the invalid symbol type, for example, postponing the frequency hopped SRS in the invalid symbol type may mean scheduling the frequency hopped SRS to the next available valid symbol. Further, the transceiver device may be adapted to transmit the frequency hopped SRS despite having been transmitted in the invalid symbol type. In such a case, the transceiver device transmitting the frequency hopped SRS being transmitted in the invalid symbol type, the frequency resources used for such a transmission may be frequency resources corresponding to the valid symbol type. Alternatively, the frequency resources used for such a transmission may correspond to that of the invalid symbol type either with, or without, modifications. For example, the modifications may relate to the valid symbol type of the SRS being SBFD and the frequency hopped SRS being on, or used, non-SBFD symbols, than the resources which may be used for transmission of the SRS on the non-SBFD symbols may be configured to be the same as the resources used for transmission of the SRS on the SBFD symbols. Additionally or alternatively, the modification may relate to the valid symbol type of the SRS being non-SBFD and the frequency hopped SRS using, or on, non-SBFD symbols, the resources which could be used for transmission of the SRS on the SBFD symbols may be truncated in such a manner that they are within, or in, the UL usable resource. For example, the UL usable resources may be the resources which are present, or extend, or lie in one or more overlapping parts of the UL BWP and the UL sub-band of the SBFD resources. For example, the one or more overlapping parts may be specified to be overlapping between the UL BWP and the UL sub-band in the frequency domain.

The transceiver device may be configured to transmit the SRS repeatedly and use a number of OFDM symbols in time domain. Further, the transceiver device may be adapted to receive a number, or a count, of OFDM symbols to be used for the repeated transmission of the SRS by a higher layer. Alternatively, the transceiver device may be configured, such as dynamically, by signaling a communication within the wireless communication network, or preconfigured, or pre-defined, with a configuration for performing the SRS transmission repeatedly. For example, the repeated SRS transmission may be periodic or aperiodic.

For example, the configuration according to which the transceiver device may be configured or preconfigured may include one or more of the following: a number of repetitions or a number of SRS occasions, a period, a minimum time or a minimum number of occasions, a maximum time or a maximum number of occasions, a pattern, an absolute time, and a symbol type. For example, the period may be a time between two SRS occasions, wherein the two SRS occasions belong to a repetition. For example, the minimum time or the minimum number of occasions may relate to the UE waiting until performing the repetition. For example, the maximum time or the maximum number of occasions may relate to the UE aborting, or ignoring, or dropping a SRS occasion, wherein the SRS occasions belongs to a repetition. For example, the pattern may relate to a repetition pattern, wherein the repetition pattern may relate to aperiodic repetition pattern, or a periodic repetition pattern. For example, the absolute time may be a time threshold such as until a transceiver device or a UE may wait for transmission of SRS repetitions. For example, the symbol type may include both non-SBFD symbols as well as SBFD symbols, or the symbol type may include just one of non-SBFD or SBFD symbol.

The transceiver device may receive the configuration which may be used for performing the repeated transmission of SRS by at least one of the following: RRC IEs, MAC CE, PHY signaling, assistance information, and a higher layer configuration. For example, the transceiver device may be configured by a base station such a gNB, a core network entity such as a CN, and another UE such as via a BS, or via a direction link such as PC5 sidelink interface. Further, the transceiver device may be adapted for handling a repetition of the SRS scheduled on a symbol being of type SBFD or of type non-SBFD. For example, the symbol may be invalid for transmitting the SRS, the transceiver device may transmit the repetition of the SRS on the invalid symbol. Alternatively, the transceiver device may either drop, or ignore, or postpone the repetition to a next available valid symbol. Additionally, or alternatively, if the symbol is invalid for transmission of the SRS, the transceiver device may not expect to receive a configuration scheduling to transmit the SRS on the invalid symbol.

In regard to the transmission of the reference signal being a sounding reference signal, few details of a base station operating in the wireless communication network as the transceiver device is operating in, are now described. The base station may operate based on an association between the SRS transmitted by a transceiver device served by the base station and a first reference signal. Additionally, the base station may operate based on a spatial relation between the SRS and a second reference signal being the first reference signal or the second reference signal being a different reference signal based on an uplink, UL, bandwidth of an SBFD time resource. The base station may be adapted to schedule transmission of a reference signal such as the SRS for a transceiver device. The base station may be adapted to schedule DL resources of the wireless communication network such that the base station does not transmit a DL in SRS resources overlapping with the DL resources.

In addition to the details and embodiments described in this disclosure so far, further details with respect to beam management are provided from the transceiver device perspective. The transceiver device may be configured to transmit the SRS and may comprise a plurality of antenna elements to perform a MIMO layer transmission. Additionally or alternatively, the transceiver device may maintain different SRS resource sets and may simultaneously transmit a plurality of SRS, wherein each SRS of the plurality of SRS may be from a different SRS resource set.

For example, the transceiver device may perform the MIMO layer transmission using the plurality of antenna elements when SRS usage is beam management. For example, the MIMO layer transmission may be part of a configured, or preconfigured, beam management. For example, the configured or preconfigured beam management could be a set of L1/L2 procedures to acquire and maintain a set of TRxB(s). For example, additionally or alternatively, the L1/L2 procedures may acquire and maintain UE beams that can be used for DL and UL transmission or reception. For example, the beam management may include at least one of the following aspects: beam determination, beam measurement, beam reporting and beam sweeping.

For example, the MIMO layer transmission may comprise at least one of: pre-coding, beam steering, beam sweeping, beam determination, beam measurement and beam reporting. For example, a first resource set, e.g., a first subset of the different SRS resource sets (e.g., a plurality of SRS resource sets), may be associated with SBFD symbols and a second resource set, e.g., a second subset of the different SRS resource sets (e.g., the plurality of SRS resource sets), may be associated with non-SBFD symbols. Further, it may be that all resources within the first resource set, that is the resource set for SBFD may comprise a valid symbol type of SBFD. Additionally or alternatively, it may be that all resources within the second resource set, that is the resource set for non-SBFD, may comprise a valid symbol type of non-SBFD. For example, resources of a respective resource set which may be associated with a particular symbol type may only comprise a valid symbol type to which its resource set is associated with.

There may be restrictions, or limitations, or conditions on signaling, or communication, such as transmission or reception, of configurations where SRS resources from the different resource sets for SBFD and non-SBFD symbols may need to be transmitted at the same time. For example, the transceiver device may be adapted to not transmit or receive a configuration where SRS resources from different resource sets for SBFD and non-SBFD symbols must be transmitted at the same time. Additionally or alternatively, there may be limitations, or restrictions, or conditions on signaling, or communication of configuration where SRS resources from different SRS resource sets for SBFD and non-SBFD symbols may be preferred or needed to be transmitted simultaneously. For example, the transceiver device may be adapted to not transmit or receive a configuration where SRS resources from different SRS resource sets from SBFD and non-SBFD symbols must be transmitted simultaneously. Additionally or alternatively, there may be restrictions, or limitations, or conditions on signaling, or communication, of configuration where SRS resources from different SRS resource sets for SBFD and non-SBFD symbols may need, or preferred, to be transmitted within the same time resource. For example, the transceiver device may be adapted to not transmit or receive a configuration where the SRS resources from the different SRS resource sets for SBFD and non-SBFD symbols must be within the same time resource. Additionally or alternatively, there may be restrictions, or limitations, or conditions on signaling, or communication, of configurations where SRS resources from different SRS resource sets for SBFD and non-SBFD symbols may need, or prefer, to be transmitted within the same type of symbol, such as a SBFD or a non-SBD symbol. For example, the transceiver device may be adapted to not transmit or receive a configuration where SRS resources from different SRS resource sets for SBFD and non-SBFD symbols must be transmitted within the same type of symbol, such as a SBFD symbol or a non-SBFD symbol. As an alternative, to the previously mentioned examples, the transceiver device may be adapted to receive a configuration where SRS resources from different SRS resource sets for SBFD and non-SBFD symbols are to be transmitted at the same, and/or simultaneously, and/or within the same time resource, and/or within the same type of symbol such as a SBFD or a non-SBFD symbol.

In case, the transceiver device may receive the configuration, the configuration indicating the signaling, or communication, of resources from different resource sets for SBFD and non-SBFD symbols being transmitted within a same time domain resource, the transceiver device may be adapted to transmit SRS for a single symbol type. For example, if the symbol on which the SRS is occasioned, or falls, may be SBFD, then the resources with respect to the SBFD resource set may be transmitted, or, if the symbol on which the SRS is occasioned, or scheduled, or configured, or falls is non-SBFD, then the resources with respect to non-SBFD resource set may be transmitted. Further, it may be that the transceiver device may be adapted to drop, or ignore, a subset or a whole, or all of the SRS resources associated with a specific symbol type. Additionally or alternatively, the transceiver device may be adapted to postpone the subset or the whole, or all of the SRS resources associated with the particular symbol type.

The transceiver device may maintain, or consider, or process, one or more resource sets, e.g., a first resource set or a second resource set, or a first subset or a second subset, as active for only one type of symbols during a period of time. For example, the one type of symbol may be a SBFD symbol or a non-SBFD symbol. For example, the maintenance or consideration or processing of the resource sets as active may relate to the resources belonging to the resource sets not being ignored or muted or dropped for signaling or communication by the transceiver device. For example, the period of time may be specified in terms of any of the described examples of time resources in this disclosure.

It may be that one or more resource sets of the different SRS resource sets for beam management may not be associated explicitly with either a SBFD symbol or a non-SBFD symbol. For example, it may be that at least one resource set of the different resource sets, e.g., the plurality of SRS resource sets, is not associated, or un-associated, with regard to SBFD symbols and non-SBFD symbols. That is, an explicit association, or dependency, may not be configured between at least one resource set of the different SRS resource sets in regard SBFD or non-SBFD symbols. Further, SRS resources within, or belonging to the at least one resource set may be valid only for one type of symbol such as either of SBFD or non-SBFD symbol. Alternatively, for example, SRS resources belonging to, or within, the at least one resource set may be valid for both symbol types. That is, the SRS resources may be valid for both SBFD and non-SBFD symbols. Further, the valid symbol type may be determined by the symbol type of the first SRS that is to be transmitted for an SRS resource. Additionally, or alternatively, in case of aperiodic SRS transmission, valid symbol type may be a symbol type in which the SRS is scheduled, or arranged, or configured, or explicitly informed, or communicated, or signalled, to the transceiver device. Further, a whole of, or all of other SRS resources, that is the SRS resources which may not be scheduled or explicitly informed to the transceiver device, within the resource set may follow a same valid symbol type.

For example, the transceiver device may transmit the SRS resources within the at least one resource set only for the valid symbol type. For example, the transceiver device may drop or ignore or mute, or postpone SRS resources within the at least one resource set of an invalid symbol type. For example, the transceiver device may itself determine the valid symbol type for each SRS resource of the at least one resource set. Alternatively, the transceiver device may be provided with the valid symbol type for each SRS resource within the at least one resource set.

In regard to the previously described figures and details thereof, further details and embodiments from the perspective of a transceiver device, such as a UE, are now presented to antenna switching. The transceiver device may transmit a SRS and may comprise a plurality of antenna ports, and may select at least one of the plurality of antenna ports for transmitting the SRS. In this regard, the transceiver device may transmit the SRS from each of the plurality of antenna ports or from a combination of antenna ports. For example, the transceiver device may allow a different node, such as a configuring base station or gNB, to select a best antenna port or best antenna ports for communication, or signaling. That is, the transceiver device may be provided an antenna port or one or more antenna ports for the SRS transmission. This provision of an antenna port or antenna ports may be carried out by communication or signaling received from a different node such as a base station or gNB. Further, it may be that the combination of antenna ports either determined by the transceiver device or provided to the transceiver device may be selected randomly. Alternatively, it may be that the combination of antenna ports either determined by the transceiver device or provided to the transceiver device may be selected based on a configured, or pre-configured pattern. For example, if the configured or pre-configured pattern may be an antenna selection pattern. For example, the antenna selection pattern may select at least one antenna, or at least one combination of antennas from, out of, a plurality of antennas, such as 2T4R. The antenna selection pattern may be configured to select antenna ports having a same TCI state. Alternatively, the antenna selection pattern may be configured to select antenna ports which are quasi co-located, QCL. That is, the antenna selection pattern may select antenna ports which have a same QCL.

In regard to antenna switching, or antenna management, the transceiver device may be adapted to maintain, or configure, separate SRS resource sets for different symbol types. For example, the transceiver device may maintain separate SRS resource sets for SBFD and non-SBFD symbols. It may be that during the course of communicating in the wireless communication network, the transceiver device may have at least one pair of resource sets to be active. Alternatively, in the course of communicating in the wireless communication network, it may be that the transceiver device configures the at least one pair of resource sets to be active. For example, it may be that one of the at least one pair of resource sets corresponds to SBFD symbols and other of the at least one pair of resource sets corresponds to non-SBFD symbols. Further, the at least one pair of resource sets may comprise a same port configuration. The transceiver device may maintain, or configure, separate configurations for SBFD and non-SBFD symbols for each SRS resource belonging to, or within, a resource set. For example, it may be that both symbol types that is SBFD and non-SBFD symbols, are valid for the resource set. For example, the transceiver device may maintain the resource set as not being explicitly associated, or linked to SBFD or non-SBFD symbols. However, the transceiver device may receive explicit configurations for SBFD and non-SBFD symbols. Alternatively, the transceiver device may itself derive a configuration associated with, or of, one symbol type from the configuration of other symbol type. Further, the transceiver device may derive the configuration based on determination rule, such as a rule defined in the specification.

The transceiver device may maintain, or configure, a common SRS resource set for both SBFD and non-SBFD symbols. Each SRS resource within the common SRS resource set may comprise a valid symbol, such as the valid symbol being defined and/or the valid symbol being derived. Further, the transceiver device may maintain the common SRS set as not being explicitly associated, or linked, to SBFD or non-SBFD symbols. Further, a valid symbol type for the SRS resource may be determined depending on the symbol type of the first SRS that is to be transmitted for an SRS resource. It may be that in case of aperiodic SRS, the valid symbol type may be the symbol type in which the SRS is scheduled, or configured, or arranged, or explicitly communicated, or signalled, or informed, to the transceiver device. Further, a whole of or all of the other SRS resources, that is the SRS resources which are not scheduled or configured or explicitly communicated or informed to the transceiver device, within the common SRS resource set, may follow a same valid symbol type. In the course of communicating the wireless communication network, the transceiver device may, at any time, either configure, or consider, or process at least one pair of resources belonging to, or within the common SRS resource set as active. It may be that one of the at least one pair of resources within the common SRS resource set corresponds to SBFD symbols and other of the at least one pair of resources within the common SRS resource set corresponds to non-SBFD symbols. Further, the at least one pair of resources within the common SRS resource set may comprise a same port number. It may be that a maximum value of SRS resources as indicated by a capability of the transceiver device may be increased relative to a legacy value.

Enhancements related to SRS

### A. Enhancements Related to Parameters: AssociatedCSI-RS and SpatialRelationInfo

UL transmissions can be of 2 types: codebook based, and non-codebook based. For non-codebook based UL transmission, the UE can calculate the precoder used for the transmission of SRS based on measurement of an associated Non-Zero Power, NZP CSI-RS resource provided using the parameter associatedCSI-RS. A UE can be configured with only one NZP CSI-RS resource for each of the SRS resource set(s) with higher layer parameter usage in SRS-ResourceSet set to ‘nonCodebook’ if configured.

Further, a configuration of the spatial relation between a reference RS and the SRS is provided to the UE by the gNB, where the higher layer parameter spatialRelationInfo contains the ID of the reference RS. This can be applicable to any usage of SRS. The reference RS may be a Synchronization signal/physical broadcast (SS/PBCH) block, CSI-RS or an SRS.

The association between the SRS and the CSI-RS or the spatial relation between the SRS and the reference RS can be done in the following ways (note: in the subsequent description ‘CSI-RS’ can be replaced with the ‘reference RS’ as well):
The SRS resource is valid only on one type of symbol, either SBFD or non-SBFD
   In one way, the gNB provides the CSI-RS resource such that it has only one valid symbol type; the same or different valid symbol type as that of the SRS. In another way, the gNB provides the CSI-RS resource such that it has CSI-RS on both SBFD and non-SBFD symbols.
      The UE considers the association to be valid
         As depicted in FIG. 6, a UE can be configured with SBFD and non-SBFD symbols or slots. Furthermore, a gNB may transmit CSI-RS symbols in different parts of a downlink slot, e.g., in different time and/or frequency locations. Furthermore, a gNB can configure a UE supporting SBFD to transmit corresponding SRS in an UL part of a SBFD symbol or slot. For this, the SRS may be associated with a CSI-RS with certain restrictions. In one embodiment, the associated CSI-RS need to be configured with certain restrictions, e.g., within the same channel. For example, FIG. 6 may relate to Associated CSI-RS-SRS is associated with a CSI-RS

For example, FIG. 6 may be related to associated CSI-RS-SRS being associated with a CSI-RS.
The UE ignores the association
   If certain conditions are satisfied, e.g.,
      The channel bandwidth of the CSI-RS and the SRS are different. E.g., the difference between the starting frequency resource of the SRS and the CSI-RS is more than a specific number of frequency resources.
      Furthermore, one or more SRS may be associated with one or more CSI-RS. SRS may be limited to a certain time and/or frequency location within the frequency band. In one example as shown in FIG. 7, SRS may be localized in frequency domain, such that a channel/subchannel is only covered by a certain part, e.g., a half-channel or 1/n-th of a channel, or one or more subchannels located within the channel. Furthermore, SRS may be time-shifted within a channel or subchannel. In addition, SRS may be associated with a time offset, or an offset value indicating a time offset between one or more SRS. The offset value may depend on a threshold, e.g., a minimum or maximum value. Depending on the position of the SRS, a further SRS may be transmitted within the same symbol type, e.g., SBFD symbol, or may be dropped from the transmission, e.g., automatically dropped.

For example, FIG. 7 may relate to associated CSI-RS-SRS being in different parts, or channels, or subchannels, being associated with a CSI-RS.
Furthermore, CSI-RS and SRS may be located in different parts of the frequency spectrum, e.g., in a different channel and/or subchannel, e.g., in an adjacent channel. In addition, there may be an offset defined between CSI-RS and associated SRS in time and/or frequency domain, as depicted in FIG. 8.

For example, FIG. 8 may relate to associated CSI-RS-SRS being in different subbands or subchannels.
CSI-RS may be transmitted in a periodic or aperiodic matter. Furthermore, SRS association may depend on the point in time, when a CSI-RS is transmitted. E.g., in case CSI-RS is transmitted within the same symbol of a SBFD symbol, this CSI-RS may not be associated with an SRS within the same SBFD symbol. In some cases, there may be a minimum time offset, which limits this association, e.g., the CSI-RS needs to be at least k symbols prior to the symbol of the associated SRS. Finally, the association may be limited to a certain symbol type, e.g., CSI-RS and associated SRS has to be transmitted of a symbol having the same symbol type, e.g., SBFD-only or non-SBFD-only. Finally, a CSI-RS transmitted in the DL part of a SBFD symbol may only be associated with a SRS in a non-SBFD symbol, which may be transmitted in a number of k symbols. The association may also depend on the numerology, e.g., the numerology may define a minimum time gap, which defines the association. This is shown in FIG. 9. In case the SRS transmission is delayed, the association may be dropped, or even the SRS transmission may be dropped.

For example, FIG. 9 may relate to associated CSI-RS-SRS depending on the symbol type, e.g., SBFD or non-SBFD symbol.
In another embodiment, the SRS, e.g., a resource set used for the SRS, of an associated CSI-RS may be constraint in its frequency position. SRS may be configured to be only transmitted within a certain frequency offset with respect to its associated CSI-RS. In case an SRS violates the offset or range definition, the SRS may be marked as invalid, see the SRS marked by reference numeral 1064₂ in the FIG. 10, and may be dropped from a transmission or ignored. Furthermore, SRS may only be partially marked as invalid, depending on a constraint. E.g., in case a smaller part of a SRS is invalid, only the smaller part will be ignored. In case a larger part of the SRS is invalid, the complete SRS may be ignored. In another embodiment, the invalid part of a SRS can be punctured, such that the resource elements, REs, in that position can be used for other transmissions, e.g., data and/or control. Furthermore, the invalid part may only be punctured in case it leaks out of the transmission direction of a channel, e.g., the invalid part that falls into the DL part of a SBFD frame is punctured. In another embodiment, the SRS is transmitted in full even if it partially overlaps with the DL subband. The gNB can schedule DL such that it does not transmit any DL in the SRS resources overlapping with the DL resources.
   in case the violating part is below a configured or pre-configured threshold, e.g., 20% of the part of the SRS in the violating part, the non-violating part can be considered as valid.

For example, FIG. 10 may relate to associated CSI-RS-SRS-constraints on the validity of SRS.
The CSI-RS resource can be absent or partially available within the UL subband where the SRS is to be transmitted.
   The UE reports a capability which indicates that the UE is not capable of interpolating or extrapolating channel if the CSI-RS and SRS are in different channel bandwidths.
      The UE associates the SRS on SBFD symbols with the CSI-RS on SBFD symbols, i.e., the symbol type or link direction used within the SBFD symbol.
The UE associates the SRS, i.e., the used resource set, with the most recent CSI-RS resource satisfying all timing conditions, e.g., the minimum gap between the last symbol of the CSI-RS and the starting symbol of SRS is ‘N’ OFDM symbols where ‘N’ is defined in the specification.
The UE associates the SRS on non-SBFD symbols with the CSI-RS on non-SBFD symbols.
   The UE associates the SRS with the most recent CSI-RS resource satisfying all timing conditions, e.g., the minimum gap between the last symbol of the CSI-RS and the starting symbol of SRS is ‘N’ OFDM symbols where ‘N’ is defined in the specification.
The UE associates the SRS with CSI-RS on any symbol type
   The UE associates the SRS with the most recent CSI-RS resource satisfying all timing conditions, e.g., the minimum gap between the last symbol of the CSI-RS and the starting symbol of SRS is ‘N’ OFDM symbols where ‘N’ is defined in the specification.
   This may allow the UE to benefit in case of periodic or semi-persistent scheduling to use only CSI-RS in the same symbol type as configured for the SRS resource set to calculate the precoder used for the transmission of SRS.
The UE ignores the association with the CSI-RS resources on a particular symbol type
   If certain conditions are satisfied, e.g.,
      The channel bandwidth of the CSI-RS and the SRS are different. E.g., the difference between the starting frequency resource of the SRS and the CSI-RS is more than a specific number of frequency resources.
      The CSI-RS resource is absent or partially available within the UL subband where the SRS is to be transmitted
      The UE reports a capability which indicates that the UE is not capable of interpolating or extrapolating channel if the CSI-RS and SRS are in different channel bandwidths.

### B. SRs Frequency Hopping (FH)

SRS FH can be configured by the gNB to allow sounding of the total UE channel with SRS transmitted in parts of the channel in different time domain symbols as shown in FIG. 7.
Different parts of the frequency hopped SRS can be associated with different CSI-RS resources or can have different spatial relations.
If the SRS is valid only for one symbol type, then all the frequency hopped SRS resources are expected to be on the valid symbol type.
If the SRS is valid only for one symbol type, all the frequency hopped SRS might not be on the valid symbol type.
   The frequency hopped SRS in the invalid symbol type is dropped
   The frequency hopped SRS in the invalid symbol type is postponed. It can be postponed to the next available valid symbol
   The frequency hopped SRS in the invalid symbol type is also transmitted. The frequency resources used for this transmission can be the frequency resources corresponding to the valid symbol type. In another embodiment, the frequency resources are corresponding to the invalid symbol type with/without some modifications. E.g., the valid symbol type of the SRS is SBFD and the frequency hopped SRS is on non-SBFD symbols, then the resources used for transmission of the SRS on the non-SBFD symbols is the same as the resources used for transmission of the SRS on the SBFD symbols. In another example, the valid symbol type of the SRS is non-SBFD and the frequency hopped SRS is on non-SBFD symbols, then the resources used for transmission of the SRS on the SBFD symbols is truncated such that they are within the UL usable resources (where UL usable resources are the resources which lies in the overlapping parts of UL BWP and UL subband).

Note that it is covered by the embodiments that different parts of the frequency hopped SRS are associated with different reference signal resources such as associated CSI-RS resources for precoder calculation, or comprise different spatial relations, e.g., multiple SSB-IDs, a different SSB may be associated with a different beam.

With regard to truncating, The SRS sequence may be truncated, for example, in the following ways:
The whole sequence is generated according to the configuration but only the resources within the UL usable resources are filled.
The sequence is generated based on the number of UL usable resources and then filled within the UL usable resources,

The parts which may not fit into the UL usable resource will be removed or punctured.

### C. Repetition of SRS

In NR, SRS can be repeated over R number of OFDM symbols in time domain, where R is configured by higher layers.
When SRS is configured to be repeated, the repetition is not expected to fall on an invalid symbol.
Repetition of an SRS on an invalid symbol is allowed.
If the repeated SRS falls on an invalid symbol, then it is either dropped or postponed to the next available valid symbol.
   D. SRS with usage “beamManagement”

In case of SRS with usage “beamManagement”, only one SRS resource within an SRS resource set can be transmitted at a given instant of time. However, SRS resources from different SRS resource sets can be transmitted at the same time. The same time may relate to a simultaneous action and/or within the same time resource and/or within the same type of symbol, e.g., a SBFD or a non-SBFD symbol.

It is possible to have separate resource sets for SBFD symbols and for non-SBFD symbols. All resources within the resource set for SBFD will have a valid symbol type of SBFD and the similar will hold true for resource sets for non-SBFD. In that case, configurations, e.g., resource configurations for resource sets for SBFD symbols and for non-SBFD symbols might be very different even with the same time domain behaviour and in the same BWP. E.g., the frequency domain resources for SBFD and non-SBFD symbols will be different.

Hence, the following UE behaviour can be applicable:
Separate resource sets for SBFD symbols and for non-SBFD symbols
The UE does not expect to transmit/receive a configuration where SRS resources from different SRS resource sets for SBFD and non-SBFD symbols must be transmitted at the same time.
If the UE receives a configuration where SRS resources from different SRS resource sets for SBFD and non-SBFD symbols must be transmitted at the same time.
   The UE transmits only SRS for single symbol type
      E.g., if the symbol on which the SRS falls is SBFD, then the resources with respect to SBFD resource set is transmitted.
   The UE drops all the SRS resources in the symbol.
With this usage, resource set(s) of only one type, e.g., for SBFD symbols, can be active during a period of time.
In another embodiment, a resource set for “beamManagement” is not associated explicitly with either SBFD or non-SBFD symbols.
   The SRS resources within a resource set is valid only for one symbol type
      E.g., the valid symbol type is determined by the symbol type of the first SRS to be transmitted for an SRS resource. In case of aperiodic SRS, the valid symbol type will be the symbol type in which the SRS is scheduled or explicitly informed to the UE. In one method, all the other SRS resources within the resource set follow the same valid symbol type. The SRS resources within the resource set are transmitted only in the valid symbol type. The SRS resources in the invalid symbols are either dropped or postponed.
      The valid symbol type is provided for each SRS resource.
   The UE does not expect to transmit/receive a configuration where SRS resources from different SRS resource sets where the valid symbols for the different resource sets/resources are SBFD for some and non-SBFD for the others, and must be transmitted at the same time.
   If the UE receives a configuration where SRS resources from different SRS resource sets are for SBFD and non-SBFD symbols must be transmitted at the same time,
      The UE transmits only SRS for single symbol type
         E.g., if the symbol on which the SRS falls is SBFD, then the resources with respect to SBFD resource set is transmitted.
      The UE drops all the SRS resources in the symbol
   Each SRS resource with a resource set can have different valid symbol types.
   Separate configurations for SBFD and non-SBFD symbols for each SRS resource and both the symbol types are valid
      SRS with Usage “AntennaSwitching”

In this case, the UE transmits SRS from each of its antenna ports so that the gNB can select the best antenna ports for communication. E.g., in a 1 transmitter, 2 receiver case; each SRS resource with a single port corresponding to different transmit antenna in different OFDM symbols is transmitted. For 2 transmitters, each SRS resource has 2 ports and the pair of ports on each SRS resource is different and transmitted on different symbols. At least one of the three following options may be implemented according to embodiments.
Separate SRS resource sets for SBFD and non-SBFD symbols
   A pair of resource sets is configured/activated where one corresponds to SBFD symbols and the other corresponds to non-SBFD symbols.
      The pair of resource sets have similar/same port configurations
Separate configurations for SBFD and non-SBFD symbols for each SRS resource and both the symbol types are valid
   Resource sets are not linked to SBFD or non-SBFD symbols.
   The configurations for SBFD and non-SBFD symbols can be provided explicitly or configuration of one symbol type derived from the other based on certain rules.
      The rules can be defined in the specification.
   Since, the gNB knows which symbols are SBFD and which are not, it can derive the CSI for both SBFD and non-SBFD symbols using the same SRS resource.
Each SRS resource within the resource set has a valid symbol defined/derived
   Resource sets are not linked to SBFD or non-SBFD symbols.
   E.g., the valid symbol type is determined by the symbol type of the first SRS to be transmitted for an SRS resource. In case of aperiodic SRS, the valid symbol type will be the symbol type in which the SRS is scheduled or explicitly informed to the UE. In one method, all the other SRS resources within the resource set follow the same valid symbol type. The SRS resources within the resource set are transmitted only in the valid symbol type.
   A pair of resources within a resource set is configured/activated where one corresponds to SBFD symbols and the other corresponds to non-SBFD symbols.
      The pair of resources have the same port numbers.
      The maximum value of SRS resources as indicated by UE capability can be increased as compared to the legacy value to accommodate this.

The combination of antenna ports may be selected
randomly, or
based on a configured or pre-configured pattern, e.g., antenna selection pattern, e.g., select 2 out of 4 antennas, e.g. 2T4R, e.g., selecting antenna ports having the same TCI state or which are quasi co-located, QCL. T4R may be interpreted as 2 TX-antennas/ports (2T) and 4 RX antennas/ports (4R).

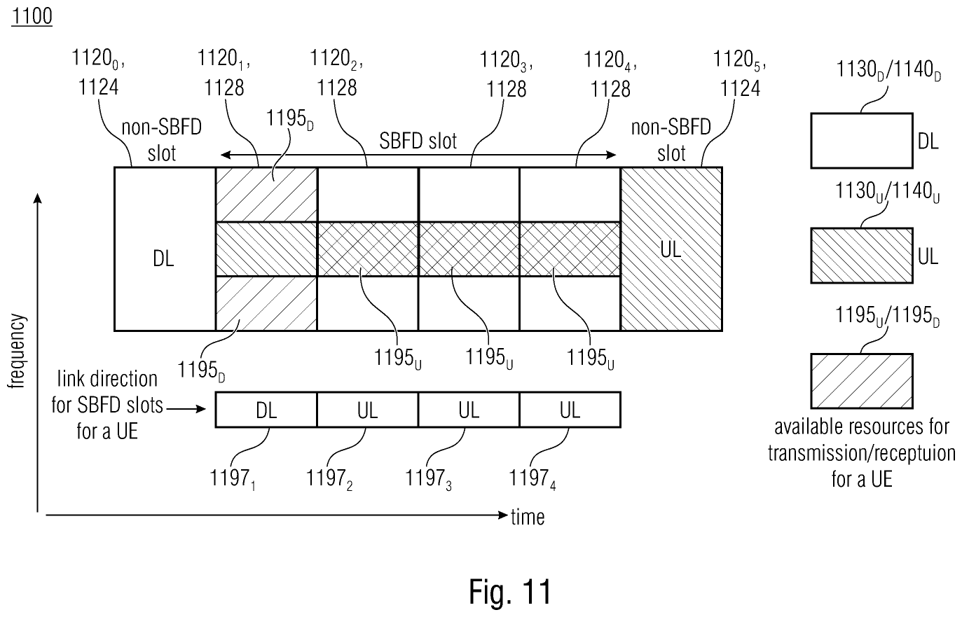

FIG. 11 exemplarily depicts a schematic representation 1100 of SBFD resources and non-SBFD resources and indication of link directions for a transceiver device, in accordance with embodiments, using a time-frequency grid. In particular, FIG. 10 presents an example of link directions for SBFD symbols.

In accordance with embodiments, the transceiver device such as a user equipment, UE, may operate in a wireless communication network which provides a plurality of time resource in a time-frequency grid, such as a plurality of time slots 1120₀-1120₅, as exemplarily depicted. A first subset 11200, 11205 of the plurality of time resources are non-SBFD time resources, or non-SBFD time slots 1124 while a second subset 11201, 11202, 11203, 11204 of the plurality of time resources are SBFD time resources, or SBFD time slots 1128. That is, generally, the transceiver device may be configured with SBFD symbols or slots or resources as well as non-SBFD symbols or slots or resources.

A first time resource, or slot 11200, of the first subset being non-SBFD time resources 1124 is configured for downlink, DL, communication or signalling and a second time resource, or slot 1120₅, of the first subset being non-SBFD time resources 1124 is configured for uplink, UL, communication or signalling. That is, the first time resource 1120₀ comprises a band 1130_{D} associated with DL communication or signalling while the second time resource 1120₅ comprises a band 1130_{U} associated with UL communication or signalling.

The time resources, or slots 1120₁, 1120₂, 1120₃, 1120₄ of the second subset being SBFD time resource(s) 1128 are configured in a DUD configuration (specified in an order of increasing frequency). That is, the SBFD time resource 1120₁, 1120₂, 1120₃, 1120₄ comprise at least one sub-band for DL communication or signalling 1140_{D} and at least one sub-band for UL communication or signalling 1140_{U}.

FIG. 11 exemplarily depicts link direction indications, or instructions, 1197₁₋₄ that indicate for a transceiver device to transmit UL or receive DL in a respective, or corresponding, SBFD resource 1120₁₋₄. Thus, it may be that the transceiver device, such as a UE, may receive link direction information, wherein the link direction information indicates to it which link direction to use for signalling or communication in a SBFD resource. The link direction information may comprise instructions for the transceiver device indicating the link directions 1197. The transceiver device may operate in accordance with the received link direction information, e.g. the received instructions indicating the link directions 1197₁₋₄.

As exemplarily depicted, for the first SBFD resource, slot, 1120₁, 1128, the transceiver device may be instructed, by way of link direction indication (e.g. or an instruction thereto) 1197₁ to use the DL sub-bands 1195_{D} for reception. In contrast, for the SBFD resources 1120₂₋₄, 1128, the transceiver device may be instructed, by way of link direction indications (e.g. or instructions thereto) 1197₂₋₄ to use the UL sub-bands 1195_{U} for transmission.

For example, the link direction, or indications thereof or instructions indicating therefor, may be received with a semi-static signalling. For example, the semi-static signalling may comprise one or more of, i.e. at least one of: information provided, or e.g. configured, or indicated, or signalled, in or derived from Radio Resource Configuration, RRC; a legacy TDD dedicated configuration in RRC, e.g., TDD-UL-DL-ConfigDedicated or TDD-UL-DL-ConfigCommon; control signal, e.g., the control signal giving, or providing, by way of explicit indication or implicit indication, the link direction. For example, the information provided, or e.g. configured, or indicated, or signalled, in or derived from Radio Resource Configuration, RRC may comprise BWP-DownlinkDedicated, or BWP-UplinkDedicated, or both.

Alternatively, for example, the link direction, or indications thereof or instructions indicating therefor, may be received with a dynamic signalling. For example, the dynamic signalling may comprise one or more of: a legacy slot format indicator (SFI), a control signal, e.g., the control signal giving, or providing, by way of explicit indication or implicit indication the link direction. For example, the dynamic signalling could comprise a legacy SFI configuration in RRC. In addition, the transceiver device may use a downlink control information, DCI, for a dynamic scheduling of the link direction and/or the SBFD-symbols.

For a semi-static signalling of the link direction, such as involving use of the control signal, the signalling of the link direction may be provided, or indicated (e.g. explicitly or implicitly) for every time resource, or for every symbol, or for a combination of time resources and symbols, or for time resources where TDD dedicated configuration is provided or indicated, or only for SBFD time resources.

The transceiver device may ignore, or drop or skip, or mute, the instructions in a non-SBFD time resource. For example, if link direction is provided, or indicated, for non-SBFD time resources, the transceiver device may ignore, or drop or skip, or mute the non-SBFD time resources

The transceiver device may operate in accordance with the instructions provided, or indicated, in non-SBFD symbols and may ignore a dedicated TDD configuration, if provided in association with the non-SBFD symbols.

It may be that the transceiver device receives the instructions using a TDD dedicated configuration, such as TDD-UL-DL-ConfigDedicated. Further, the transceiver device may receive the instructions to relate to Flexible, F, symbols only that are configured by TDD common configuration, e.g., TDD-UL-DL-ConfigCommon. Furthermore, the transceiver device may use the link direction for an SFBD symbol that is indicated in the instruction.

The transceiver device may receive the instructions indicating which specific time resources to use or employ for communication, or signalling, in a particular direction, e.g., uplink or downlink or sidelink. For example, the specific time resources for communication in a particular direction may be any, or one or more of, or at least one of: an indicated resource, which could either be only in time or only in frequency or both in time and frequency; a resource opportunity next after (or e.g. succeeding) or next with a known difference (or e.g. succeeding with a known difference) after an indicated resource; a resource opportunity with a suitable difference after an indicated resource; a resource opportunity in regular intervals; and a resource opportunity in a regular or irregular interval structure derived from a functional relation.

For example, the indicated resource in time and/or frequency could be a slot, a frame, a symbol such as BWP, PRB, one or more subcarriers. For example, the suitable difference may be derived, or determined, or obtained, or decided, by the transceiver device. Alternatively, the suitable difference may be random, or it could be based on a signal processing procedure. For example, the signal processing procedure could be time needed to receive and decode an indication message, wherein the indication message indicates the suitable difference. For example, for the resource opportunity being in regular intervals, the regular intervals may be related to, or be, semi-static differences in time and/or frequency. For example, for the resource opportunity being in a regular or irregular interval structure derived from a functional relation, the functional relation could be one or more differences in time and/or frequency, wherein the one or more differences are obtained, or calculated, or determined, or derived, based on, or using, a hopping sequence.

For example, the transceiver device may use the link direction either after a minimum time gap, or offset, or a maximum time gap, or offset, wherein the minimum time gap, or offset, and the maximum time gap, or offset, are specified or indicated with respect to the time the link direction indication was received, i.e. a time of a reception of the link direction indication. For example, the time gap could be any of the time resources described in this disclosure, such as any of an absolute time, e.g., 13 or 28 milliseconds; an implicit time period derived from a referenced time unit, e.g. a time gap, symbol period, sample distance, period between signal repetitions; a symbol, e.g., OFDM symbols, a slot, e.g., 14 OFDM symbols, sub-slots, half-slots, or mini-slots; a subframe; a radioframe; and a hyperframe. Further, the time gap, or offset, may be configured (e.g. dynamically configured) or pre-configured, or predefined, or indicated based on a capability of the transceiver device, such as UE capability.

For example, the transceiver device may interpret, or regard, or consider, the instructions for a non-SBFD symbol in a legacy way/manner. For example, the transceiver device may operate according to separate link directions provided for DL symbols configured by TDD common configuration, such as based on TDD-UL-DL-ConfigCommon. Further, it could be that the TDD common configuration relates to SBFD symbols only. Alternatively, the TDD common configuration may relate to both SBFD and non-SBFD symbols, wherein the transceiver device may drop or skip or ignore the TDD common configuration in non-SBFD symbols.

The transceiver device may receive the instructions associated with DL and Flexible, F, symbols configured by the TDD common configuration. Further, the transceiver device may use the link direction for an SFBD symbol that is indicated, either implicitly or explicitly, in the instruction. Furthermore, the transceiver device may regard, or consider, or interpret the instructions for a non-SBFD symbol in a legacy way/manner.

The transceiver device may use a SFBD symbol of a DL subband for downlink if the link direction is DL, and may use a SFBD symbol of an UL subband for uplink, if the link direction is UL.

The transceiver device may implement at least one collision handling rule in absence of an indicated link direction. That is, if the indicated link direction is not provided to or received by the transceiver device, the at least one collision handling rule may be carried out or performed or implemented.

For example, in case of a conflict between the semi-static or dynamic signalling of the link direction and a DCI, the transceiver device may follow, or operate in accordance with a legacy rule between TDD common, TDD dedicated, SFI and DCI. Alternatively, in case of the conflict, the transceiver device may follow, or operate in accordance with the instructions according to the DCI. Additionally, or alternatively, for example, the transceiver device follow, or operate in accordance with a legacy rule between TDD common, TDD dedicated and SFI, in case of a conflict between the semi-static signalling and the dynamic signalling of the link direction.

For example, the transceiver device follows, or operates in accordance with a scheduling of a DCI format to receive PDSCH over multiple time resource, such as slots, and the transceiver device may receive the instructions indicating that the link direction is uplink, for at least one symbol thereof, and perform PDSCH reception contradicting the link direction. Therefore, despite the indication link direction being UL for the at least one symbol, the transceiver device may perform PDSCH reception (or e.g. other DL signalling or communication needing reception which may be scheduled in similarity to PDSCH) in conformity with the scheduling of the DCI format.

For example, the transceiver device may follow, or operate in accordance with a scheduling of a DCI format to receive PDSCH over multiple time resource, such as slots, and the transceiver device may receive the instruction(s) for a time resource from the multiple time resources, such as for at least one symbol from a set of symbols, wherein the instruction indicate that the transceiver device, such as a UE, is scheduled for PDSCH reception in the time resource which is an uplink symbol, the transceiver device (e.g. the UE) may not be expected to receive the PDSCH in the time resource.

For example, the transceiver device may follow, or operate in accordance with a scheduling of a DCI format to receive PDSCH over multiple time resource, such as slots, and the transceiver device may receive the instruction(s) for a time resource from the multiple time resources, such as for at least one symbol from a set of symbols, wherein the instruction(s) indicates that the transceiver device, such as a UE, is scheduled for PUSCH transmission in the time resource which is an downlink symbol, the transceiver device (e.g. the UE) may still transmit the PUSCH in the time resource.

For example, the transceiver device may follow, or operate in accordance with a scheduling of a DCI format to receive PDSCH over multiple time resource, such as slots, and the transceiver device may receive the instruction(s) for a time resource from the multiple time resources, such as for at least one symbol from a set of symbols, wherein the instruction(s) indicates that the transceiver device, such as a UE, is scheduled for PUSCH transmission in the time resource which is an downlink symbol, the transceiver device (e.g. the UE) may still receive the PDSCH in the time resource.

For example, the transceiver device may follow, or operate in accordance with a scheduling of a DCI format to transmit PUSCH over multiple time resource, such as slots, and the transceiver device may receive the instruction(s) for a time resource from the multiple time resources, such as for at least one symbol from a set of symbols, wherein the instruction(s) indicates that the transceiver device, such as a UE, is scheduled for PUSCH transmission in the time resource which is an downlink symbol, the transceiver device (e.g. the UE) may not transmit, e.g. ignore, or drop, or skip, the PUSCH in the time resource or may postpone the PUSCH to another time resource, e.g. reschedule to the another time resource.

For example, the transceiver device may follow, or operate in accordance with a scheduling of a DCI format to transmit PUSCH over multiple time resource, such as slots, and the transceiver device may receive the instruction(s) for a time resource from the multiple time resources, such as for at least one symbol from a set of symbols, wherein the instruction(s) indicates that the transceiver device, such as a UE, is scheduled for PUSCH transmission in the time resource which is an downlink symbol, the transceiver device (e.g. the UE) may still transmit, e.g. ignore, or drop, or skip, the PUSCH in the time resource and may not postpone, or e.g. reschedule, the PUSCH to another time resource.

For example, the transceiver device may receive information indicating, in an implicit or an explicit manner, whether the link direction is provided, or e.g. indicated, or to be used. For instance, the information indicating whether the link direction is provided or to be used could be received by the transceiver device from another device, such as another transceiver device or UE. The information indicating if the link direction is provided or to be used could be based on an assistance message, or based on a measurement. For example, the transceiver device may detect a certain signal and may obtain (e.g. predict) the link direction and may operate accordingly. For instance, the obtainment, or e.g. prediction, of the link direction may be performed or done using AI. Further, the transceiver device may request the link direction from the base station or from another device, such as another transceiver device or UE. Additionally, or alternatively, the transceiver device may report a capability information indicating a capability to use SBFD symbols.

The transceiver device may ignore, or skip, or drop, or disregard the instructions related to the link direction based on, or depending on, the transceiver device being configured with one or more types of signals or one or more types of channels, such as grant free UL transmissions. Further, for example, the transceiver device may ignore, or skip, or drop, or disregard, the instructions related to the link direction within (e.g. only within) a predefined, preconfigured or predetermined period and/or during a period in which the one or more types of signals or one or more types of channels are active, such as a grant free UL transmission being active. Furthermore, the transceiver device my ignore, or skip, or drop, or disregard, the instructions related to the link direction completely, or entirely, in all symbols or only in UL symbols.

For example, the transceiver device may either determine (e.g. either by itself or based on signalling or communication in the network) or receive information indicating a list of time resources and/or symbols where the link direction is not applicable or operable or configurable and to operate accordingly. The provision of this information to the transceiver device may be from a base station serving the transceiver device, or another entity in the wireless communication network of the transceiver device. For example, based on this information, the transceiver device may not use the symbols or time resources which are associated with the information indicating the transceiver device to not make use of. Alternatively, the transceiver device may still determine or receive the information indicating the list of time resources and/or symbols where the link direction is not applicable or operable or configurable and may ignore the information, such as by using the indicated time resources and/or symbols.

For example, the link direction may be valid in terms of at least one mini-slot or at least one half-slot or at least one subslots. For example, the at least one subslots may relate to least one group of symbols within a slot. For example, the link direction may be indicated for the transmission of PRACH, such as PRACH Msg1 or PRACH Msg3. For example, the link direction may be provided, or indicated within the PRACH procedure. This may within a control signal transmitted by the base station, such as one or more, or at least one, of: a PRACH occasion, a PDSCH Msg2, e.g., Random Access Response, and a PDSCH Msg4, contention resolution.

### Explicit Indication of Link Direction

When a UE is configured with UL subbands in certain symbols, the UE can either transmit within the UL subband or receive in the DL subband in those symbols based on the gNB configuration or scheduling. This is due to the half-duplex constraint at the UE. The UE can decide whether to transmit or receive based on one or more of dynamic gNB scheduling, UL/DL direction of configured channel/signal and explicit link direction. E.g., as shown in FIG. 11, the UE is configured with a combination of SBFD and non-SBFD symbols/slots. Further, the UE is also provided with an explicit link direction which tells the UE whether to transmit/receive in the SBFD slots/symbols.

For example, FIG. 11 may be related to link direction for SBFD symbols.

Link direction can be given using semi-static or dynamic signal. E.g., semi-static signal can be legacy TDD dedicated config in RRC/a new control signal and dynamic signal can be legacy slot format indicator (SFI)/a new control signal.
Semi-static link direction
   Using new signal
      Provided for every slot/symbol/combination of slots and symbols
         Ignored in the non-SBFD symbols,
         Valid in the non-SBFD symbols and TDD dedicated is ignored or not provided,
         Provided only for SBFD symbols.
   Using TDD dedicated configuration
      Provided in a legacy way (only for Flexible (F) symbols configured by TDD common configuration)
         For SBFD symbols, the direction indicated is the link direction,
         For non-SBFD symbols, interpretation happens in legacy way,
         Separate link direction is provided for DL symbols configured by TDD common configuration,
         Only for SBFD symbols,
         Both SBFD and non-SBFD symbols,
         Link direction is ignored in non-SBFD symbols.
      Provided for DL and F symbols configured by TDD common configuration
         For SBFD symbols, the direction indicated is the link direction,
         For non-SBFD symbols, interpretation happens in legacy way.
   For SBFD symbols, if link direction is DL, then symbols are available for DL. If link direction is UL, then symbols are available for UL.
Dynamic link direction (e.g., using SFI)
   Same rules as that of semi-static link indication. Only SFI is used instead of TDD dedicated.
Dynamic scheduling is done using downlink control information (DCI).
If link direction is not given, then collision handling rules are followed,
   It can be not given for the UE or just missing for a slot/symbol.
Conflict between semi-static/dynamic link direction and DCI
   Follow legacy rules between TDD common/TDD dedicated/SFI and DCI,
   Direction provided in DCI never conflicts with any link direction provided.
Conflict between semi-static and dynamic link direction,
   Follow legacy rules between TDD common/TDD dedicated and SFI.
      If a UE is scheduled by a DCI format to receive PDSCH over multiple slots, and if the link direction, indicate that, for a slot from the multiple slots, at least one symbol from a set of symbols where the UE is scheduled PDSCH reception in the slot is an uplink symbol, the UE still receives the PDSCH in the slot.
      If a UE is scheduled by a DCI format to receive PDSCH over multiple slots, and if the link direction, indicate that, for a slot from the multiple slots, at least one symbol from a set of symbols where the UE is scheduled PDSCH reception in the slot is an uplink symbol, the UE does not receive the PDSCH in the slot.
      If a UE is scheduled by a DCI format to transmit PUSCH over multiple slots, and if the link direction, indicates that, for a slot from the multiple slots, at least one symbol from a set of symbols where the UE is scheduled PUSCH transmission in the slot is a downlink symbol, the UE still transmits the PUSCH in the slot.
      If a UE is scheduled by a DCI format to transmit PUSCH over multiple slots, and if the link direction, indicates that, for a slot from the multiple slots, at least one symbol from a set of symbols where the UE is scheduled PUSCH transmission in the slot is a downlink symbol, the UE does not transmit the PUSCH in the slot.
      The gNB indicates to the UE, explicit or implicit, if link direction is provided or to be used. E.g., the gNB can inform the UE whether TDD dedicated config will be used in legacy way or used as link direction.
      The gNB provides explicit link direction to the UE when one or more of the following applies:
         The UE explicitly asks for it,
         The UE reports a certain capability information,
         The type of service is not of a particular type like URLLC.
      The link direction is ignored when the UE is configured with certain types of signals/channels e.g., grant free UL transmissions.
         This can be ignored only within the period in which the grant free UL transmission is active.
         Further, the link direction can be completely ignored in all symbols or only in UL symbols.
         In another embodiment, the gNB does not provide explicit link directions to the UE if it has grant free UL transmissions configured or the UE is of a specific type/category that can be reported by the UE, e.g., RedCap, URLLC etc.
         In another embodiment, the gNB provides a list of slots/symbols where the link direction is not applicable. Otherwise, these slots/symbols can also be derived at the UE based on certain conditions.
      Link direction can be given/derived in terms of mini-slots or subslots (some groups of symbols within a slot). For example, or from another UE, explicitly or implicitly, information indicating if link direction is provided, or based on an assistance message, or based on a measurement, e.g., the transceiver device may detect a certain signal and predicts a link direction, e.g., using AI.

Although in the previous embodiments, the link direction was mentioned with regards to a downlink or an uplink direction, this application not necessarily needs to be limited to such a scenario. Furthermore, this may not even have to involve a wireless communication system including a base station, but embodiments can be applied to one or more of
a single device, e.g., a user equipment,
a plurality of devices communicating with each other, e.g., as in a device-to-device, D2D, or UE-to-UE communication via a sidelink interface, e.g., via PC5, e.g., a sidelink operating on flexible symbols, F, e.g., using an uplink or downlink frequency spectrum,
other types of devices, e.g., instructions received from a relay node, RN, from an IAB device, from a road-side unit, RSU, or from a device configuring frequency sensing or monitoring actions,
other radio access technologies, RATs, e.g., a WiFi node, e.g., AP or STA, working in licensed or unlicensed, e.g., shared spectrum.

Thus, in general, any device which can configure a transceiver to configure or switch or change its link direction by configuring the incoming and/or outgoing signals of a device is addressed in the embodiments of this application. Furthermore, any device which may also reconfigure the transceiver for a simultaneous operation on incoming and outcoming signals on a time/frequency grid may be addressed. Finally, the wireless interface described in these embodiments does not necessarily have to be used for communication, but it may also be used for spectrum sensing, measurements, interference detection, or for joint or integrated communication and sensing, ICAS.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

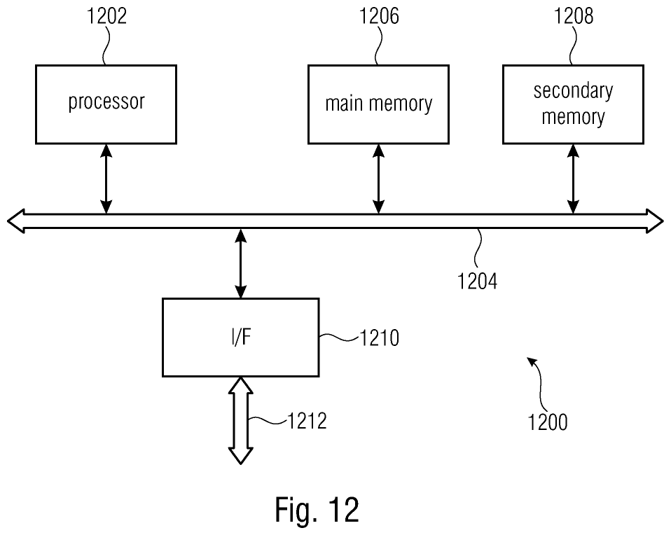

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 1200. The units or modules as well as the steps of the methods performed by these units may execute on one or more computer systems 1200. The computer system 1200 includes one or more processors 1202, like a special purpose or a general-purpose digital signal processor. The processor 1202 is connected to a communication infrastructure 1204, like a bus or a network. The computer system 1200 includes a main memory 1206, e.g., a random-access memory (RAM), and a secondary memory 1208, e.g., a hard disk drive and/or a removable storage drive. The secondary memory 1208 may allow computer programs or other instructions to be loaded into the computer system 1200. The computer system 1200 may further include a communications interface 1210 to allow software and data to be transferred between computer system 1200 and external devices. The communication may be in the form of electronic, electromagnetic, optical, or other signals capable of being handled by a communications interface. The communication may use a wire or a cable, fibre optics, a phone line, a cellular phone link, an RF link and other communications channels 1212.

The terms “computer program medium” and “computer readable medium” are used to generally refer to tangible storage media such as removable storage units or a hard disk installed in a hard disk drive. These computer program products are means for providing software to the computer system 1200. The computer programs, also referred to as computer control logic, are stored in main memory 1206 and/or secondary memory 1208. Computer programs may also be received via the communications interface 1210. The computer program, when executed, enables the computer system 1200 to implement the present invention. In particular, the computer program, when executed, enables processor 1202 to implement the processes of the present invention, such as any of the methods described herein. Accordingly, such a computer program may represent a controller of the computer system 1200. Where the disclosure is implemented using software, the software may be stored in a computer program product and loaded into computer system 1200 using a removable storage drive, an interface, like communications interface 1210.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The above described embodiments are merely illustrative for the principles of the present invention. It is understood that modifications and variations of the arrangements and the details described herein are apparent to others skilled in the art. It is the intent, therefore, to be limited only by the scope of the impending patent claims and not by the specific details presented by way of description and explanation of the embodiments herein.

In the following, additional embodiments and aspects of the invention will be described which can be used individually or in combination with any of the features and functionalities and details described herein.

A first aspect relates to a transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources; wherein according to a first configuration, the transceiver device restricts communication to one of the first type and the second type; and wherein according to a second configuration, the transceiver device uses both the first type and the second type for communication; wherein based on a received message, e.g., from a base station; and/or based on a determination result obtained by the transceiver device the transceiver device is to operate according to the first configuration or the second configuration.

According to a first another aspect when referring back to the first aspect, the transceiver device is adapted to derive the configuration, e.g., a symbol type, based on a CSI-RS resource and/or based on a CSI report, e.g., based on a content thereof and/or based on a used resource.

According to a second another aspect when referring back to one of the first aspect or the first another aspect, the transceiver device is to identify a CSI report using a CSI-ReportConfig configuration in RRC.

According to a third another aspect when referring back to the second another aspect, the CSI report is associated with a CSI-RS being one of triggered, scheduled, periodic, persistent, semi-persistent or aperiodic.

According to a fourth another aspect when referring back to any one of the first aspect to the third another aspect, the transceiver device is to obtain a symbol type with which a CSI-ReportConfig is associated as being provided in or derived from at least one of CSI-ReportConfig, BWP, BWP-Downlink, BWP-DownlinkDedicated, BWP-DownlinkCommon, PDSCH-config, PDSCH-ConfigCommon, PDSCH-ServingCellConfig, servingcellconfig, servingcellconfigcommon, servingcellconfigcommonSIB, downlinkconfigcommon, DownlinkConfigCommonSIB, CSI-MeasConfig or any other IE.

According to a fifth another aspect when referring back to any one of the first aspect to the fourth another aspect, the transceiver device is to determine that a symbol type with which a CSI-ReportConfig is associated is SBFD; wherein in a case where no configuration for resources for CSI-RS is provided or in a case where the second configuration is applied, the transceiver device is to process the CSI-RS in SBFD and non-SBFD symbols; or the transceiver device is to process the CSI-RS in SBFD symbols only; or
wherein the transceiver device is to determine that a symbol type with which a CSI-ReportConfig is associated is non-SBFD; wherein in a case where no configuration for resources for CSI-RS is provided or in a case where the second configuration is applied, the transceiver device is to process the CSI-RS in SBFD and non-SBFD symbols; or the transceiver device is to process the CSI-RS in non-SBFD symbols only.

According to a sixth another aspect when referring back to any one of the first aspect to the fifth another aspect, the transceiver device is to determine that a symbol type with which a CSI-ReportConfig is associated is SBFD; wherein in a case where no configuration for resources for the CSI report is provided or in a case where the second configuration is applied, the transceiver device is to transmit the CSI report in SBFD and non-SBFD symbols; or the transceiver device is to transmit the CSI report in SBFD symbols only; or to follow a configuration of a different channel or signal like PUSCH/PUCCH for resources for CSI report; or
wherein the transceiver device is to determine that a symbol type with which a CSI-ReportConfig is associated is non-SBFD; wherein in a case where no configuration for resources for the CSI report is provided or in a case where the second configuration is applied, the transceiver device is to transmit the CSI report in SBFD and non-SBFD symbols; or the transceiver device is to transmit the CSI report in non-SBFD symbols only; or to follow a configuration of a different channel or signal like PUSCH/PUCCH for resources for CSI report.

According to a seventh another aspect when referring back to any one of the first aspect to the sixth another aspect, the transceiver device is to determine that a symbol type with which a CSI-ReportConfig is associated is SBFD; wherein in a case where the first configuration is applied, the transceiver device is to process the CSI-RS in SBFD and non-SBFD symbols; or the transceiver device is to process the CSI-RS in SBFD symbols only.

According to an eighth another aspect when referring back to any one of the first aspect to the seventh another aspect, the transceiver device is to determine that a symbol type with which a CSI-ReportConfig is associated is SBFD; wherein in a case where the first configuration is applied, the transceiver device is to transmit the CSI report in SBFD and non-SBFD symbols; or the transceiver device is to transmit the CSI report in SBFD symbols only; or to follow a configuration of a different channel or signal like PUSCH/PUCCH for resources for CSI report.

According to a second aspect when referring back to any one of the first aspect to the eight another aspect, the determination result comprises one or more of
derived from a valid symbol type being valid for the time resource, the valid symbol type being provided, e.g., if a valid symbol type is provided then the UE operates in the first configuration,
derived based on a measurement, e.g., see the thirteenth aspect.

According to a third aspect when referring back to any one of the first aspect to the eighth another aspect, the first configuration and/or second configuration is one or more of
configured, e.g., based on a received message, e.g., a configuration message,
pre-configured,
determined based on a capability.

It is to be noted that in regard to the aspects, when referring back to any one of the first to third aspects and/or any one of the first to one or more subsequent aspects, the one or more subsequent aspects being subsequent to the third aspect, any one of the another aspects, i.e. any one of the first another aspect to the eight another aspect, are included when making the reference.

According to a fourth aspect when referring back to any one of the first to third aspects, the transceiver device is configured with the message by at least one of:
a base station, e.g., a gNB,
by the network, e.g., core network, CN,
by another UE, e.g., via sidelink,
over-the-top, e.g., via Internet.

According to a fifth aspect when referring back to any one of the first to fourth aspects, the time resource is one or more of
an absolute time, e.g., 13 or 28 milliseconds,
a symbol, e.g., OFDM symbols,
a slot, e.g., 14 OFDM symbols, sub-slots, half-slots, or mini-slots,
a subframe,
a radioframe,
a hyperframe.

According to a sixth aspect when referring back to any one of the first to fifth aspects, the transceiver device is adapted to execute a time resource measurement, wherein the time resource measurement is based on counting of a time resource, e.g., slot counting etc.

According to a seventh aspect when referring back to any one of the first to sixth aspects, the transceiver device is to perform a random access/initial access, e.g., PRACH, to a network, e.g., and the transceiver device is
not connected to a base station, e.g., in RRC_IDLE state or
in RRC_INACTIVE state or
in the state of performing a random access, e.g., waiting for a RACH response.

According to an eighth aspect when referring back to the seventh aspect, the transceiver device is to do one or more of
to receive the first configuration and/or the second configuration, e.g., indicated with the message, via a broadcast channel, BCH, e.g., via SIB, prior to performing a random access procedure,
pre-configured with the first configuration or the second configuration, e.g., via capability,
is to receive a first configuration or second configuration, e.g., a full configuration or an updated configuration, while performing random access, e.g.,
   in 4-step RACH via message 2, Msg2, or message 4, Msg4, or
   in 2-step RACH via message B, MsgB.

According to a ninth aspect when referring back to the eighth aspect, control messages and procedures are associated with at least one of a another band/another component carrier/another radio access technology, RAT, e.g. a configuration message comes from an LTE component carrier in non-stand-alone (NSA) or is shared among UEs via Bluetooth, BLE or WiFi, or is retrieved from a server in internet via WiFi.

According to a tenth aspect when referring back to any one of the first to ninth aspects, the transceiver device is configured or pre-configured with the following default configuration:
the first configuration, or
the second configuration, or
a configuration supported by its capability.

According to an eleventh aspect when referring back to any one of the first to tenth aspects, the transceiver device is to change/overwrite a configuration, e.g., based on a configuration received, to
the first configuration, e.g., previously configured with the second configuration, or
the second configuration, e.g., previously configured with first configuration.

According to a twelfth aspect when referring back to any one of the first to eleventh aspects, the transceiver device is to
select first configuration or the second configuration or
not to select the first configuration or the second configuration, e.g., restrict to not use one of the configurations, based on a criterion.

According to a thirteenth aspect when referring back to the twelfth aspect, the criterion is one or more of
a channel condition or based on a measurement, e.g., SNR, interference, RSRP, RSSI, RSRQ, ACLR, cross-link interference, CLI, . . .
a position of the transceiver device, e.g., geo-location within the cell,
a QoS criterion, e.g., packet delay budget, PDB, or latency requirement, e.g., URLLC requirement, e.g., reliability,
a capability of the transceiver device,
based on a threshold, e.g., received signal strength, e.g., from a base station, CLI, SINR, with interference coming from another base station or from another UE,
based on assistance information, e.g., an information received by a base station, BS, or from another UE,

According to a fourteenth aspect when referring back to the thirteenth aspect, the threshold is one or more of
configured and/or pre-configured, e.g., by signalling from a base station,
based on a measurement at the transceiver device,
based on a determination of an SINR headroom, wherein the SINR headroom can refer to
   SINR headroom at the UE, e.g., in downlink, or
   SINR headroom at the base station, e.g., in uplink.

According to a fifteenth aspect when referring back to any one of the twelfth to fourteenth aspects, the transceiver device is to report the selected first configuration or second configuration or parameters thereof to one or more of
a base station,
a network entity, e.g., a core network function, CNF,
another UE.

According to a sixteenth aspect when referring back to any one of the twelfth to fourteenth aspects, the transceiver device is to reject a first or second configuration and report this to one or more of
a base station,
a network entity, e.g., a core network function, CNF,
another UE.

According to a seventeenth aspect when referring back to any one of the first to sixteenth aspects, a valid symbol type being valid for the time resource is
explicitly configured or pre-configured, or
is one symbol type, e.g., either SBFD or non-SBFD, e.g., used as default.

According to an eighteenth aspect when referring back to any one of the first to seventeenth aspects, the valid symbol type is
signalled by another device, e.g., a base station, a network entity, CN, another UE,

According to a nineteenth aspect when referring back to any one of the first to eighteenth aspects, wherein the valid symbol type is
configured by a certain type of signalling, using one or more of
   higher layer,
   RRC, e.g., RRC IEs,
   MAC-CE,
   PHY, e.g., via DCI,

According to a twentieth aspect when referring back to any one of the first to nineteenth aspects, the signalling as a certain cast type, e.g., unicast, groupcast, multicast or broadcasts.

According to a twenty-first aspect when referring back to any one of the first to twentieth aspects, the transceiver device is adapted to implement one of the first and second configuration for a downlink, DL.

According to a twenty-second aspect when referring back to any one of the first to twenty-first aspects, the transceiver device is adapted to individually implement one of the first and second configuration for an uplink, UL.

According to a twenty-third aspect when referring back to the twenty-first aspect, e.g., based on a radio resource configuration, RRC, the configuration implemented for the DL is provided to the transceiver device or determined as part of the determination result per DL bandwidth part, BWP; and/or wherein the configuration implemented for the UL is provided to the transceiver device or determined as part of the determination result per UL BWP.

According to a twenty-fourth aspect when referring back to any one of the first to twenty-third aspects, the configuration indicates a valid symbol type per DL BWP and/or per UL BWP.

According to a twenty-fifth aspect when referring back to any one of the twenty-first to twenty-fourth aspects, the transceiver device is to implement or to determine the configuration independent from one or more of
a frequency resource,
a signal.

According to a twenty-sixth aspect when referring back to any one of the twenty-first to twenty-fifth aspects, the transceiver device is to implement or determine a further configuration per one or more of
a frequency resource,
per signal,
response on a request,
when a condition is met, threshold passed, e.g., a conditional configuration change, CCC.

According to a twenty-seventh aspect when referring back to the twenty-fifth or twenty-sixth aspect, a frequency resource is one or more of
a channel,
a system bandwidth,
a subchannel,
a subband,
a bandwidth part, BWP,
a component carrier, CC,
one or more subcarriers,
a physical resource block, PRB,
a fixed or variable amount of bandwidth at a fixed or varying frequency/location in a frequency grid, e.g. hopping across the frequency grid on consecutive time resources,
one or more pairs or sets of frequency resources, wherein the sets of frequency resources are to be used in the same or different time resources,
a frequency comb.

According to a twenty-eighth aspect when referring back to the twenty-sixth aspect, the transceiver device is to determine the further configuration, e.g., a part of the first and/or second configuration or a different configuration for channel-state information reference signals, CSI-RS in Downlink.

According to a twenty-ninth aspect when referring back to the twenty-sixth or twenty-eighth aspect, the transceiver device is to determine the further configuration for channel-state information reference signals, SRS for uplink transmission.

According to a thirtieth aspect when referring back to any one of the twenty-sixth to twenty-ninth aspects, the transceiver device is to determine the further configuration for channel-state information reference signals, SRS for crosslink interference CLI measurements.

According to a thirty-first aspect when referring back to any one of the twenty-sixth to thirtieth aspects, the transceiver device is configured for ignoring/skipping/not decoding/not receiving/dropping/puncturing the further configuration per time and/or frequency resource or per signal, e.g., under a predefined condition.

According to a thirty-second aspect when referring back to any one of the twenty-sixth to thirty-first aspects, the transceiver device is not expected to receive the further configuration per time resource and/or frequency resource or per signal, e.g., under a predefined condition.

According to a thirty-third aspect when referring back to any one of the twenty-fifth to thirty-second aspects, the transceiver device is to override the configuration with the further configuration per time and/or frequency resource or per signal, e.g., under a predefined condition.

According to a thirty-fourth aspect when referring back to any one of the thirty-first to thirty-third aspects, the predefined condition is one or more of:
the transceiver device having a configured and/or pre-configured configuration,
the transceiver device having a configured and/or pre-configured configuration per BWP,
the transceiver device having a configured and/or pre-configured configuration for larger frequency resource, e.g., the UE has a configuration for channel, and thus does not require a configuration for a subchannel,
the transceiver device having a configured and/or pre-configured common configuration for both uplink and downlink,
power saving, e.g., the transceiver device is performing DRX,
based on a capability of the transceiver device, e.g., are UE reduced capability, RedCap, may not support a further configuration,
. . . .

According to a thirty-fifth aspect when referring back to any one of the twenty-fifth to thirty-third aspects, the further configuration indicates a valid symbol type per frequency resource or per signal.

According to a thirty-sixth aspect when referring back to any one of the first to thirty-fifth aspects, the transceiver device is to implement a predefined configuration, e.g., one of the first configuration and the second configuration, as a default configuration in absence of or prior to a message and/or the determination result, e.g., when the UE is not configured with configuration 2, the UE only uses one of the symbol types as valid symbol types.

According to a thirty-seventh aspect when referring back to the thirty-sixth aspect, wherein the transceiver device is to implement the indicated configuration based on the message or the determination result.

According to a thirty-eighth aspect when referring back to the thirty-sixth or thirty-seventh aspect, the transceiver device is to ignore the indicated configuration based on
a message, e.g., the current first configuration or the second configuration has a higher priority, e.g., the first configuration has a higher priority than second configuration or vice versa, or
the determination result, e.g., the current first configuration or second configuration
achieves a better performance, e.g., with respect to QoS, e.g., throughput, latency, packet loss, bit error rate, BER, or
. . . .

According to a thirty-ninth aspect when referring back to the thirty-sixth aspect, based on the message or the determination result the transceiver device is to temporarily deviate from the default configuration and to then return to the default configuration.

According to a fortieth aspect when referring back to the thirty-ninth aspect, the transceiver device is to implicitly determine when to return to the default configuration by applying a predefined amount of time or time resources, a predefined number of transmissions, or a predefined number of receptions.

According to a forty-first aspect when referring back to the thirty-ninth or fortieth aspect, the transceiver device is to explicitly determine when to return to the default configuration based on receiving a respective signal, based on a predetermined event or a transmission success or transmission failure.

According to a forty-second aspect when referring back to the forty-first aspect, the transmission success and/or the transmission failure relates to a predefined number of successful or unsuccessful transmissions based on ACK and/or NACK.

According to a forty-third aspect when referring back to the forty-first or forty-second aspect, the transmission success and/or the transmission failure relates to a predefined number of successful or unsuccessful receptions, e.g., based on decoding errors, or generated not acknowledgement, NACK, messages.

According to a forty-fourth aspect when referring back to any one of the first to forty-third aspects, the transceiver device is to determine, from the message or from the determination result, a valid symbol type is provided, e.g., common for DL and UL or per DL/UL BWP or per channel/signal; and to operate according to the first configuration based thereon.

According to a forty-fifth aspect when referring back to any one of the first to forty-fourth aspects, in absence of a valid symbol type being provided to the transceiver device or of the determination result, the transceiver device is to operate according to the second configuration.

According to a forty-sixth aspect when referring back to the forty-fourth or forty-fifth aspect, based on a valid symbol type being provided to the transceiver device or determined as part of the determination result, the valid symbol type indicating both the first type and the second type, the transceiver device is to operate according to the second configuration.

According to a forty-seventh aspect when referring back to the forty-fourth or forty-fifth aspect, based on a valid symbol type being provided to the transceiver device or determined as part of the determination result, the valid symbol type indicating both the first type and the second type, the transceiver device is to operate according to the first configuration.

According to a forty-eighth aspect when referring back to any one of the forty-fourth to forty-seventh aspects, the transceiver device is to ignore a request to operate according to the second configuration based on an incompatibility of the transceiver device with the second configuration.

According to a forty-ninth aspect when referring back to any one of the forty-fourth to forty-eighth aspects, the transceiver device is to ignore a request to operate according to the first configuration based on an incompatibility of the transceiver device with the first configuration.

According to a fiftieth aspect when referring back to any one of the first to forty-ninth aspects, from the message or based on the determination result, the transceiver device is to derive, e.g., per one or more of DL BWP, UL BWP, channel, information related to a PDSCH, such as PDSCH Repetition, Multi-PDSCH, e.g., provided in or derived from RRC IEs like BWP, BWP-Downlink, BWP-DownlinkDedicated, BWP-DownlinkCommon, PDSCH-config, PDSCH-ConfigCommon, PDSCH-ServingCellConfig, ServingCellConfig, ServingCellConfigCommon, ServingCellConfigCommonSIB, DownlinkConfigCommon, DownlinkConfigCommonSIB or CSI resource/report related configurations.

According to a fifty-first aspect when referring back to any one of the first to fiftieth aspects, wherein from the message or based on the determination result, the transceiver device is to derive, e.g., per one or more of DL BWP, UL BWP, channel, signal information related to a SPS PDSCH, such as a configuration being explicitly provided in SPS-config.

According to a fifty-second aspect when referring back to the fifty-first aspect, the transceiver device is to follows the configuration explicitly provided in SPS-config; and/or to follow the configuration as provided in or derived from at least one of the above list for PDSCH and to ignore the configuration explicitly provided in or derived from SPS-config.

According to a fifty-third aspect when referring back to the fifty-first or fifty-second aspect, in absence of an explicit configuration, the transceiver device is to follow the configuration according to information related to a PDSCH.

According to a fifty-fourth aspect when referring back to any one of the first to fifty-third aspects, from the message or based on the determination result, the transceiver device is to derive, e.g., per one or more of DL BWP, UL BWP, channel, information related to a PUSCH such as Multi-PUSCH, TBoMS, PUSCH repetition, e.g., provided in or derived from radio resource control information elements, RRC IEs, like BWP, BWP-Uplink, BWP-UplinkDedicated, BWP-UplinkCommon, PUSCH-config, PUSCH-ConfigCommon, PUSCH-ServingCellConfig, ServingCellConfig, ServingCellConfigCommon, ServingCellConfigCommonSIB, UplinkConfigCommon, UplinkConfigCommonSIB or from SRS related configurations.

According to a fifty-fifth aspect when referring back to any one of the first to fifty-fourth aspects, from the message or based on the determination result, the transceiver device is to derive, e.g., per one or more of DL BWP, UL BWP, frequency resource, information related to a Configure Grant, CG.

According to a fifty-sixth aspect when referring back to the fifty-fifth aspect, the transceiver device is to obtain the configuration explicitly provided in or derived from a ConfiguredGrantConfig information.

According to a fifty-seventh aspect when referring back to the fifty-sixth aspect, the transceiver device is to follow the configuration explicitly provided in or derived from ConfiguredGrantConfig; or to follow the configuration as provided in or derived from information related to a PUSCH and to ignore the configuration explicitly provided in or derived from ConfiguredGrantConfig.

According to a fifty-eighth aspect when referring back to the fifty-sixth or fifty-seventh aspect, in absence of an explicit configuration provided in or derived from ConfiguredGrantConfig, the transceiver device is to follow a configuration as provided in or derived from information related to PUSCH.

According to a fifty-ninth aspect when referring back to any one of the first to fifty-eighth aspects, the transceiver device is adapted to derive the configuration based on a CSI-RS resource and/or based on a CSI report, e.g., based on a content thereof and/or based on a used resource.

According to a sixtieth aspect when referring back to any one of the first to fifty-ninth aspects, the transceiver device is to identify a CSI report using a CSI-ReportConfig configuration in RRC.

According to a sixty-first aspect when referring back to the sixtieth aspect, the CSI report is associated with a CSI-RS being one of triggered, scheduled, periodic, semi-persistent or aperiodic.

According to a sixty-second aspect when referring back to the sixtieth or sixty-first aspect, the CSI-ReportConfig is separate for CSI-RS resources of an SBFD time resource and of a non-SBFD time resource.

According to a sixty-third aspect when referring back to the sixty-second aspect, for the CSI-ReportConfig associated with CSI-RS restricted to an SBFD time resource, the transceiver device is to use only CSI-RS transmission occasions within SBFD symbols for CSI derivation.

According to a sixty-fourth aspect when referring back to the sixty-second or sixty-third aspect, for the CSI-ReportConfig associated with CSI-RS restricted to an SBFD time resource the transceiver device is to use CSI-RS transmission occasions within SBFD symbols and/or within non-SBFD symbols for CSI derivation.

According to a sixty-fifth aspect when referring back to any one of the sixty-second to sixty-fourth aspects, for the CSI-ReportConfig associated with CSI-RS restricted to a non-SBFD time resource, the transceiver device is to use only CSI-RS transmission occasions within non-SBFD symbols for CSI derivation.

According to a sixty-sixth aspect when referring back to any one of the sixty-second to sixty-fifth aspects, for the CSI-ReportConfig associated with CSI-RS restricted to a non-SBFD time resource, the transceiver device is to use CSI-RS transmission occasions within non-SBFD symbols and/or within SBFD symbols for CSI derivation.

According to a sixty-seventh aspect when referring back to any one of the sixty-second to sixty-sixth aspects, for the CSI-ReportConfig associated with CSI-RS being transmitted on a non-SBFD time resource and/or SBFD time resource, the transceiver device is to use for CSI derivation one or more of
CSI-RS transmission occasions restricted within non-SBFD symbols,
CSI-RS transmission occasions restricted within SBFD symbols,
CSI-RS transmission occasions within either SBFD or non-SBFD symbols,
CSI-RS transmission occasions within both SBFD and non-SBFD symbols,
CSI-RS transmission occasions within at least non-SBFD symbols,
CSI-RS transmissions occasions within at least SBFD symbols,
. . . .

According to a sixty-eighth aspect when referring back to any one of the sixtieth to sixty-fifth aspects, CSI-RS relates to a non-zero power CSI-RS, NZP CSI-RS, a zero power CSI-RS or a CSI-interference measurement, CSI-IM.

According to a sixty-ninth aspect when referring back to any one of the sixtieth to sixty-eighth aspects, the transceiver device is to omit determining or deriving the first and second configuration for resources for a CSI-RS or resources for reporting the CSI when a symbol type with which the CSI-ReportConfig is associated is provided or derived, e.g., using the configuration according to the symbol type.

According to a seventieth aspect when referring back to the sixty-ninth aspect, the transceiver device is to obtain the symbol type with which the CSI-ReportConfig is associated as being provided in or derived from at least one of CSI-ReportConfig, BWP, BWP-Downlink, BWP-DownlinkDedicated, BWP-DownlinkCommon, PDSCH-config, PDSCH-ConfigCommon, PDSCH-ServingCellConfig, servingcellconfig, servingcellconfigcommon, servingcellconfigcommonSIB, downlinkconfigcommon, DownlinkConfigCommonSIB, CSI-MeasConfig or any other IE.

According to a seventy-first aspect when referring back to any one of the sixtieth to seventieth aspects, if a symbol type with which the CSI-ReportConfig is associated is provided to the transceiver device or derived by the transceiver device the transceiver device is to operate according to the symbol type, possibly ignoring or dropping the first configuration and/or the second configuration for the resources for CSI-RS or resources for reporting the CSI . . . .

According to a seventy-second aspect when referring back to any one of the sixtieth to seventy-first aspects, the transceiver device is to
send the CSI report on non-SBFD symbols of a non-SBFD time resource, or
to send a first part of the CSI report on non-SBFD symbols of a non-SBFD time resource and a second or remaining part on one or more of
   the next available resources,
   the next non-SBFD symbols, or
   the next SBFD symbols,
to send a first part of the CSI report on SBFD symbols and a second or remaining part is sent on one or more of
   the next available resources,
   the next non-SBFD symbols, or
   the next SBFD symbols,
send the CSI report on SBFD symbols of a SBFD time resource.

According to a seventy-third aspect when referring back to any one of the sixtieth to seventy-second aspects, based on a signal or channel, e.g., PBCH/PDCCH/PDSCH/PUSCH/PUCCH, having the first configuration, the transceiver device is to determine a valid symbol type accordingly.

According to a seventy-fourth aspect when referring back to the seventy-third aspect, the transceiver device is to receive CSI-RS on both SBFD symbols and non-SBFD symbols and performs reporting only with respect to the valid symbol type of the first configuration; or wherein the transceiver device is to receive CSI-RS only on the valid symbol type and to report performs reporting only with respect to the valid symbol type of the first configuration.

According to a seventy-fifth aspect when referring back to any one of the sixtieth to seventy-fourth aspects, based on a signal or channel, e.g., PBCH/PDCCH/PDSCH/PUSCH/PUCCH, having the second configuration, the transceiver device is to be provided with or to derive a valid symbol type for the CSI report.

According to a seventy-sixth aspect when referring back to the seventy-fifth aspect, the transceiver device is to be provided with or derive a whether to use the first configuration or the second configuration for the resources for CSI-RS or resources for the CSI report.

According to a seventy-seventh aspect when referring back to any one of the sixtieth to seventy-sixth aspects, the transceiver device is to determine that a symbol type with which the CSI-ReportConfig is associated is SBFD; wherein in a case where no configuration for resources for CSI-RS is provided or in a case where the second configuration is applied, the transceiver device is to process the CSI-RS in SBFD and non-SBFD symbols; or the transceiver device is to process the CSI-RS in SBFD symbols only; or wherein the transceiver device is to determine that a symbol type with which the CSI-ReportConfig is associated is non-SBFD; wherein in a case where no configuration for resources for CSI-RS is provided or in a case where the second configuration is applied, the transceiver device is to process the CSI-RS in SBFD and non-SBFD symbols; or the transceiver device is to process the CSI-RS in non-SBFD symbols only.

According to a seventy-eighth aspect when referring back to any one of the sixtieth to seventy-seventh aspects, the transceiver device is to determine that a symbol type with which the CSI-ReportConfig is associated is SBFD; wherein in a case where no configuration for resources for the CSI report is provided or in a case where the second configuration is applied, the transceiver device is to transmit the CSI report in SBFD and non-SBFD symbols; or the transceiver device is to transmit the CSI report in SBFD symbols only; or to follow a configuration of a different channel or signal like PUSCH/PUCCH for resources for CSI report; or the transceiver device is to determine that a symbol type with which the CSI-ReportConfig is associated is non-SBFD; wherein in a case where no configuration for resources for the CSI report is provided or in a case where the second configuration is applied, the transceiver device is to transmit the CSI report in SBFD and non-SBFD symbols; or the transceiver device is to transmit the CSI report in non-SBFD symbols only; or to follow a configuration of a different channel or signal like PUSCH/PUCCH for resources for CSI report.

According to a seventy-ninth aspect when referring back to any one of the sixtieth to seventy-eighth aspects, the transceiver device is to determine that a symbol type with which the CSI-ReportConfig is associated is SBFD; wherein in a case where the first configuration is applied, the transceiver device is to process the CSI-RS in SBFD and non-SBFD symbols; or the transceiver device is to process the CSI-RS in SBFD symbols only.

According to an eightieth aspect when referring back to any one of the sixtieth to seventy-ninth aspects, the transceiver device is to determine that a symbol type with which the CSI-ReportConfig is associated is SBFD; wherein in a case where the first configuration is applied, the transceiver device is to transmit the CSI report in SBFD and non-SBFD symbols; or the transceiver device is to transmit the CSI report in SBFD symbols only; or to follow a configuration of a different channel or signal like PUSCH/PUCCH for resources for CSI report.

According to an eighty-first aspect when referring back to any one of the sixtieth to eightieth aspects, the transceiver device is to select CSI-RS resources for calculation of CSI and reporting based on a symbol type with which the CSI-ReportConfig is associated.

According to an eighty-second aspect when referring back to the eighty-first aspect, the transceiver device is to select the CSI-RS resources to process CSI-RS on both SBFD and non-SBFD symbols.

According to an eighty-third aspect when referring back to the eighty-first or eighty-second aspect, the transceiver device is to derive the symbol type with which the CSI-ReportConfig is associated in at least one of the following parameters:
resourcesForChannelMeasurement,
csi-IM-ResourcesForInterference, and
nzp-CSI-RS-ResourcesForInterference.

According to an eighty-fourth aspect when referring back to the eighty-third aspect, the transceiver device is to derive the symbol type from one of the parameters and to apply the same symbol type to at least one of the remaining parameters.

According to an eighty-fifth aspect when referring back to any one of the sixtieth to eighty-fourth aspects, in a case where a symbol type with which the CSI-ReportConfig is associated is not provided explicitly, e.g., in resourcesForChannelMeasurement, csi-IM-ResourcesForInterference and/or nzp-CSI-RS-ResourcesForInterference, the transceiver device is to be provided or to derive the signal type from a different source of information; and to apply the signal type to at least one of
resourcesForChannelMeasurement,
csi-IM-ResourcesForInterference, and
nzp-CSI-RS-ResourcesForInterference.

According to an eighty-sixth aspect when referring back to any one of the sixtieth to eighty-fifth aspects, the transceiver device is adapted to apply a symbol type with which the CSI-ReportConfig is associated and that is provided to the transceiver device or applicable for the CSI-RS resources for at least one of the parameters:
resourcesForChannelMeasurement,
csi-IM-ResourcesForInterference, and
nzp-CSI-RS-ResourcesForInterference.
   and to apply a same symbol type for the other parameter; wherein the transceiver device is to receive CSI-IM resources configured by csi-IM-ResourcesForInterference on both SBFD and non-SBFD symbols and to use the resources for CSI calculation and/or reporting.

According to an eighty-seventh aspect when referring back to any one of the sixtieth to eighty-sixth aspects, the transceiver device is adapted to simultaneously operate according to two valid CSI-ReportConfigs corresponding to the same CSI-RS resources; wherein a first CSI-ReportConfig is associated with SBFD symbols and a second CSI-ReportConfig is associated with non-SBFD symbols; wherein the first and second CSI-ReportConfig are linked.

According to an eighty-eighth aspect when referring back to the eighty-seventh aspect, the transceiver device is adapted to report a first CSI report based on the first CSI-ReportConfig and a second CSI report based on the second CSI-ReportConfig together as a single report, e.g., on PUCCH or PUSCH.

According to an eighty-ninth aspect when referring back to any one of the sixtieth to eighty-seventh aspects, the transceiver device is adapted to use resources for the CSI report that follow a symbol type with which the CSI-ReportConfig is associated, provided or derived.

According to a ninetieth aspect when referring back to any one of the sixtieth to eighty-ninth aspects, the transceiver device is adapted to operate such that resources for the CSI report do not follow a symbol type with which the CSI-ReportConfig is associated; wherein the resources for the CSI report are on at least one of SBFD symbols and non-SBFD symbols;
wherein a valid symbol type for the resources for the CSI report is provided to or derived by the transceiver device.

According to a ninety-first aspect when referring back to the ninetieth aspect, the transceiver device is to be provided with the valid symbol type in CSI-ReportConfig or a different RRC IEs like PUCCH-config or PUSCH-config for reporting on PUCCH/PUSCH.

According to a ninety-second aspect when referring back to the ninetieth or ninety-first aspect, resources for the CSI report and a symbol type with which the CSI-ReportConfig is associated are separately provided for at least one of the following types of report:
periodic,
triggered,
scheduled,
semiPersistentOnPUCCH, semiPersistentOnPUSCH, and
aperiodic.

According to a ninety-third aspect when referring back to the ninety-second aspect, based on one valid symbol type for the resources for the report is provided to the transceiver device, the transceiver device is to apply the valid symbol type to at least one of the types of report.

According to a ninety-fourth aspect when referring back to any one of the fifty-ninth to ninety-third aspects, the transceiver device is to be provided with the first configuration or the second configuration explicitly for resources for CSI-RS or resources for the CSI report; or wherein only a valid symbol type field is present for one of the resources for CSI-RS or resources for the CSI report; wherein the transceiver device is to derive the first configuration if a value is provided, and to otherwise derive the second configuration.

According to a ninety-fifth aspect when referring back to the ninety-fourth aspect, the transceiver device is adapted to be provided with or to derive whether to apply the first configuration or the second configuration, e.g., using a valid symbol type, for resources for CSI-RS only and to apply a same configuration to resources for the CSI report and vice versa.

According to a ninety-sixth aspect when referring back to the ninety-fourth or ninety-fifth aspect, the transceiver device is to be provided with or to derive whether to apply the first configuration or the second configuration from an RRC IE, e.g., in BWP, BWP-Downlink, BWP-DownlinkDedicated, BWP-DownlinkCommon, PDSCH-config, PDSCH-ConfigCommon, PDSCH-ServingCellConfig, servingcellconfig, servingcellconfigcommon, servingcellconfigcommonSIB, downlinkconfigcommon, DownlinkConfigCommonSIB, CSI-MeasConfig or CSI-ReportConfig.

According to a ninety-seventh aspect when referring back to any one of the ninety-fourth to ninety-sixth aspects, the transceiver device is to be provided with or to derive whether to apply the first configuration or the second configuration from at least one of the parameters:
-resourcesForChannelMeasurement,
csi-IM-ResourcesForInterference, and
nzp-CSI-RS-ResourcesForInterference.

According to a ninety-eighth aspect when referring back to the ninety-seventh aspect, the transceiver device is adapted to be provided with or to derive from at least one parameter, and to apply the same configuration to at least one other parameter as well.

According to a ninety-ninth aspect when referring back to any one of the ninety-fourth to ninety-eighth aspects, the transceiver device is to be provided with or to derive whether to apply the first configuration or the second configuration from a different source of information; and to apply the signal type to at least one of
resourcesForChannelMeasurement,
csi-IM-ResourcesForInterference, and
nzp-CSI-RS-ResourcesForInterference.

According to a one-hundredth aspect when referring back to any one of the ninety-fourth to ninety-ninth aspects, the transceiver device is to be provided with or to derive whether to apply the first configuration or the second configuration from any one or two of the parameters
resourcesForChannelMeasurement,
csi-IM-ResourcesForInterference, and
nzp-CSI-RS-ResourcesForInterference;
and to apply a different configuration for a remaining parameter.

According to a one-hundred-first aspect when referring back to any one of the fifty-ninth to ninety-ninth aspects, the transceiver device apply the first or second configuration for the resources for CSI-RS or resources for the CSI report based on the configuration of another channel or another signal.

According to a one-hundred-second aspect when referring back to any one of the fifty-ninth to ninety-ninth aspects, the transceiver device apply a valid symbol type for the resources for CSI-RS or resources for the CSI report based on the configuration of another channel or another signal.

According to a one-hundred-third aspect when referring back to any one of the fifty-ninth to one-hundred-second aspects, the transceiver device apply a same configuration and a same valid symbol type for both the CSI-RS resources and resources for the CSI report.

According to a one-hundred-fourth aspect when referring back to any one of the first to one-hundred-third aspects, the transceiver device is adapted to operate the first configuration or the second configuration for a sounding reference signal, SRS, as a configuration implemented in a different channel or signal, e.g., a PUSCH.

According to a one-hundred-fifth aspect when referring back to the one-hundred-fourth aspect, in case of the first configuration applied to the different channel or signal, the valid symbol type for SRS is the same as the valid symbol type for some other signal/channel, e.g. PUSCH.

According to a one-hundred-sixth aspect when referring back to the one-hundred-fifth aspect, the transceiver device is adapted to be provided explicitly with a valid symbol type for SRS, e.g., provided in SRS-config.

According to a one-hundred-seventh aspect when referring back to any one of the one-hundred-fourth to one-hundred-sixth aspects, the transceiver device is adapted to be provided implicitly whether to apply the first configuration or the second configuration

According to a one-hundred-eighth aspect when referring back to the one-hundred-seventh aspect, based on a valid symbol type being provided to the transceiver device, the transceiver device is to apply the first configuration and to apply the second configuration otherwise.

According to a one-hundred-ninth aspect when referring back to any one of the one-hundred-fourth to one-hundred-eighth aspects, the transceiver device is adapted to apply a same configuration and/or a same valid symbol type for a plurality or all types of SRSs; or to individually implement the configuration and/or the valid symbol.

According to a one-hundred-tenth aspect when referring back to the one-hundred-ninth aspect, the types refer to
aperiodic, or
periodic, or
triggered, or
scheduled, or
semi-persistent.

According to a one-hundred-eleventh aspect when referring back to the one-hundred-ninth or one-hundred-tenth aspect, the types of SRS refer to
wideband, e.g., wideband SRS signals are transmitted over a broader frequency bandwidth, allowing for enhanced channel estimation and improved interference rejection capabilities. Wideband SRS is designed to provide accurate channel state information across a wider frequency range for advanced signal processing and optimization, or
narrowband or subband, e.g., restricted to a frequency resource.

According to a one-hundred-twelfth aspect when referring back to any one of the one-hundred-ninth to one-hundred-eleventh aspects, the types refer to a usage of SRS:
codebook, or
non-codebook, and/or
beamforming, and/or
beam management, and/or
antenna switching and/or
antenna selection.

According to a one-hundred-thirteenth aspect when referring back to any one of the one-hundred-fourth to one-hundred-twelfth aspects, the transceiver device is adapted to operate according to a default configuration defined for SRS.

According to a one-hundred-fourteenth aspect when referring back to any one of the one-hundred-fourth to one-hundred-thirteenth aspects, the transceiver device is to interpret a configuration of a scheduling from a base station serving the transceiver device to deriving the configuration for the SRS.

A one-hundred-fifteenth aspect relates to a transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources;
wherein the transceiver device is to operate based on an association between a sounding reference signal, SRS, transmitted by the transceiver device and a first reference signal.

A one-hundred-sixteenth aspect relates to a transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources;
wherein the transceiver device is to operate based on a spatial relation between the SRS and
   a second reference signal or
   a second reference signal being the first reference signal or a different reference signal.

According to a first additional aspect when referring back to any one of the one-hundred-fifteenth aspect or the one-hundred-sixteenth aspect, the transceiver device is adapted to consider the association based on a same symbol type being used for the first reference signal, e.g., CSI-RS, and the SRS, e.g. SBFD or non-SBFD.

According to a second additional aspect when referring back to any one of the one-hundred-fifteenth aspect to the first additional aspect, the transceiver device is adapted to associate the SRS, e.g., a resource set used for the SRS, on SBFD symbols with the first reference signal being received on SBFD symbols.

According to a third additional aspect when referring back to any one of the one-hundred-fifteenth aspect to the second additional aspect, the transceiver device is adapted to associate the SRS, e.g., a resource set used for the SRS, on non-SBFD symbols with the first reference signal received on non-SBFD symbols.

According to a fourth additional aspect when referring back to any one of the one-hundred-fifteenth aspect to the third additional aspect, the transceiver device is adapted to associate the SRS, e.g., a resource set used for the SRS, with the first reference signal on any symbol type.

According to a fifth additional aspect when referring back to any one of the one-hundred-fifteenth aspect to the fourth additional aspect, the transceiver device is adapted to associate the SRS, e.g., a resource set used for the SRS, with a most recent resource used for the first reference signal, the most recent resource satisfying all timing applied conditions, e.g., the minimum gap between the last symbol of the CSI-RS and the starting symbol of SRS is ‘N’ OFDM symbols or ‘N’ time resources, where ‘N’ is defined in the specification.

According to a sixth additional aspect when referring back to any one of the one-hundred-fifteenth aspect to the fifth additional aspect, the transceiver device is adapted to calculate a precoder for a for a transmission of a sounding reference signal, SRS, in case of periodic or semi-persistent scheduling based on a CSI-RS in the same symbol type as configured for the SRS resource set.

According to a one-hundred-seventeenth aspect when referring back to the one-hundred-sixteenth aspect, the different reference signal is one of
SSB, e.g., having an SSB-ID,
CSI-RS,
A further SRS, e.g., having a different configuration, e.g., SRS-ID.

It is to be noted that in regard to the aspects, when referring back to any one of the one-hundred-fifteenth aspect to the one-hundred-seventeenth aspect and/or any one of the one-hundred-fifteenth aspect to one or more subsequent aspects, the one or more subsequent aspects being subsequent to the one-hundred-seventeenth aspect, any one of the further aspects, i.e. any one of the first additional aspect to the sixth additional aspect, are included when making the reference.

According to a one-hundred-eighteenth aspect when referring back to any one of the one-hundred-fifteenth to one-hundred-seventeenth aspects, the transmission is
based on an uplink, UL, bandwidth of an SBFD time resource or
based on an uplink, UL, bandwidth of an SBFD time resource and overlapping or partially overlapping with the downlink, DL, resources of an SBFD time resource.

According to a one-hundred-nineteenth aspect when referring back to any one of the one-hundred-fifteenth to one-hundred-eighteenth aspects, the transceiver device is to process the SRS resource only on one type of symbol, either SBFD or non-SBFD.

According to a one-hundred-twentieth aspect when referring back to the one-hundred-nineteenth aspect, the transceiver device is adapted to be provided with a resource of the first reference signal as only having one valid symbol type being a same or a different valid symbol type as that of the SRS; or adapted to be provided a resource of the first reference signal as having the signals of type of the first reference signal on both SBFD and non-SBFD symbols.

According to a one-hundred-twenty-first aspect when referring back to the one-hundred-twentieth aspect, the transceiver device is adapted to operate the association as valid based on a predefined validity condition.

According to a one-hundred-twenty-second aspect when referring back to the one-hundred-twenty-first aspect, the validity condition is related to whether the first and/or second reference signal is received within a bandwidth being similar with the UL bandwidth of the SBFD time resource of the transceiver device, e.g., in the same frequency resource.

According to a one-hundred-twenty-third aspect when referring back to the one-hundred-twenty-second aspect, the validity condition relates to a channel bandwidth of the first reference signal and the SRS being different, e.g., the difference between the starting frequency resource of the SRS and the CSI-RS is less than a specific number of frequency resources.

According to a one-hundred-twenty-fourth aspect when referring back to the one-hundred-twenty-second or one-hundred-twenty-third aspect, a frequency resource is one or more of
a channel,
a system bandwidth,
a subchannel,
a subband,
a bandwidth part, BWP,
a component carrier, CC,
one or more subcarriers,
a physical resource block, PRB,
a fixed or variable amount of bandwidth at a fixed or varying frequency/location in a frequency grid, e.g. hopping across the frequency grid on consecutive time resources,
one or more pairs or sets of frequency resources, wherein the sets of frequency resources are to be used in the same or different time resources,
a frequency comb.

According to a one-hundred-twenty-fifth aspect when referring back to any one of the one-hundred-twentieth to one-hundred-twenty-fourth aspects, the transceiver device is adapted to ignore the association or to operate as not according to the association based on a predefined invalidity condition.

According to a one-hundred-twenty-sixth aspect when referring back to the one-hundred-twenty-fifth aspect, the invalidity condition relates to a channel bandwidth of the first reference signal and the SRS being different, e.g., the difference between the starting frequency resource of the SRS and the CSI-RS is more than a specific number of frequency resources.

According to a one-hundred-twenty-seventh aspect when referring back to any one of the one-hundred-fifteenth to one-hundred-twenty-sixth aspects, one or more SRS are associated with one or more reference signals of a same or of different types.

According to a one-hundred-twenty-eighth aspect when referring back to the one-hundred-twenty-seventh aspect, at least one of the SRS is limited to a certain, i.e., predefined, configured or preconfigured time and/or frequency location within a frequency band.

According to a one-hundred-twenty-ninth aspect when referring back to the one-hundred-twenty-eighth aspect, the transceiver device is adapted to transmit the first reference signal(s) based on a localization of the SRS in frequency domain, such that a channel or subchannel is only covered by a certain fraction 1/n with n being a number >1, or by use of at least one subchannel of at least two subchannels located within the channel.

According to a one-hundred-thirtieth aspect when referring back to any one of the one-hundred-twenty-seventh to one-hundred-twenty-ninth aspects, the transceiver device is adapted to transmit a plurality of SRS within the UL bandwidth of the SBFD time resource, having one or more of
the plurality of SRS being offset in time.
the plurality of SRS being configured with a single SRS ID, and
   with frequency hopping, or
   without frequency hopping, e.g., with repetition in time domain,
the plurality of SRS being configured with multiple SRS IDs, and
   with frequency hopping, or
   without frequency hopping, e.g., with repetition in time domain.

According to a one-hundred-thirty-first aspect when referring back to the one-hundred-thirtieth aspect, the offset in time depends on a threshold, e.g., the maximum length can be, e.g., duration of the SBFD time resources.

According to a one-hundred-thirty-second aspect when referring back to the one-hundred-thirty-first aspect, a duration can be in terms of one of
absolute time, e.g., in terms of milliseconds,
fixed units, e.g., in terms of counting a number of resources, e.g., 5 SRS resources,
symbol, slots, half-slots, mini-slots, subframes, frames, radioframes, hyperframes,
type, e.g., count a certain transmission type, e.g., count the number of SBFD symbols.

According to a one-hundred-thirty-third aspect when referring back to the one-hundred-thirtieth or one-hundred-thirty-second aspect, the transceiver device is adapted to transmit a first SRS in the UL bandwidth of the SBFD time resource and to transmit a further SRS within the same symbol type, e.g., SBFD symbol, depending on a time and/or frequency position of the SRS in the symbol; or to drop the further SRS from the transmission, e.g., automatically.

According to a one-hundred-thirty-fourth aspect when referring back to any one of the one-hundred-twenty-seventh to one-hundred-thirty-third aspects, at least one SRS is associated with a single first reference signal, wherein the first reference signal and the at least one SRS are located in different parts of the frequency spectrum, e.g., in different channels and/or subchannels and/or frequency resources, e.g., in an adjacent channel.

According to a one-hundred-thirty-fifth aspect when referring back to the one-hundred-thirty-fourth aspect, an offset is defined between the first reference signal and the associated SRS in time and/or frequency domain.

According to a one-hundred-thirty-sixth aspect when referring back to the one-hundred-thirty-fifth aspect, the time and/or frequency offset is based on a threshold.

According to a one-hundred-thirty-seventh aspect when referring back to the one-hundred-thirty-sixth aspect, the time threshold is measured/defined when referring back to the one-hundred-thirty-second aspect.

According to a one-hundred-thirty-eighth aspect when referring back to the one-hundred-thirty-sixth aspect, the frequency threshold is based on a maximum amount of frequency resource when referring back to the one-hundred-twenty-fourth aspect.

According to a one-hundred-thirty-ninth aspect when referring back to any one of the one-hundred-fifteenth to one-hundred-thirty-eighth aspects, the transceiver device is adapted for the first reference signal being transmitted in the wireless communication network in a periodic or aperiodic or triggered or scheduled manner, e.g., received by the transceiver device.

According to a one-hundred-fortieth aspect when referring back to any one of the one-hundred-fifteenth to one-hundred-thirty-ninth aspects, the transceiver device is adapted according to the association depending on a point in time, when the first reference signal is transmitted.

According to a one-hundred-forty-first aspect when referring back to any one of the one-hundred-fifteenth to one-hundred-fortieth aspects, based on the first reference signal being transmitted within the same symbol of a SBFD symbol, the transceiver device is adapted to consider the first reference signal as not associated with an SRS within the same SBFD symbol.

According to a one-hundred-forty-second aspect when referring back to the one-hundred-fortieth or one-hundred-forty-first aspect, the transceiver device is adapted to consider the association if a minimum time offset or a minimum number of symbols or time resources is present between the first reference signal and the SRS.

According to a one-hundred-forty-third aspect when referring back to any one of the one-hundred-fifteenth to one-hundred-forty-second aspects, the transceiver device is adapted to consider the association based on a same symbol type being used for the first reference signal and the SRS, e.g., SBFD or non-SBFD.

According to a one-hundred-forty-fourth aspect when referring back to any one of the one-hundred-fifteenth to one-hundred-forty-third aspects, the transceiver device is adapted to consider the association based on the first reference signal transmitted in a DL part of a SBFD symbol and the SRS transmitted by the transceiver device in a non-SBFD symbol, e.g., in a number of k symbols or time resources.

According to a one-hundred-forty-fifth aspect when referring back to any one of the one-hundred-fifteenth to one-hundred-forty-fourth aspects, the transceiver device is adapted for the association to depend on a numerology, e.g., the numerology defining a minimum time gap, which defines the association.

According to a one-hundred-forty-sixth aspect when referring back to any one of the one-hundred-fifteenth to one-hundred-forty-fifth aspects, the SRS of an associated first reference signal is constraint in its frequency position; wherein the transceiver device is adapted to operate accordingly.

According to a one-hundred-forty-seventh aspect when referring back to any one of the one-hundred-fifteenth to one-hundred-forty-sixth aspects, the transceiver device is adapted to transmit the SRS within a certain frequency offset with respect to its first reference signal.

According to a one-hundred-forty-eighth aspect when referring back to any one of the one-hundred-fifteenth to one-hundred-forty-seventh aspects, the transceiver device is adapted to consider a scheduled SRS that violates a predefined offset in time and/or frequency condition with regard to the first reference signal as invalid.

According to a one-hundred-forty-ninth aspect when referring back to the one-hundred-forty-eighth aspect, the transceiver device is adapted to consider a part of the SRS violating the predefined offset in time and/or frequency condition with regard to the first reference signal as invalid; whilst to use resources of a non-violating part of the SRS.

According to a one-hundred-fiftieth aspect when referring back to the one-hundred-forty-ninth aspect, the transceiver device is adapted to puncture resources of the invalid part for a transmission.

According to a one-hundred-fifty-first aspect when referring back to the one-hundred-fiftieth aspect, the transceiver device is adapted to puncture the invalid part in case it leaks out of the transmission direction of a channel, e.g., to puncture the invalid part that falls into the DL part of a SBFD frame.

According to a one-hundred-fifty-second aspect when referring back to any one of the one-hundred-forty-ninth to one-hundred-fifty-first aspects, the transceiver device is adapted to determine whether to ignore the complete SRS schedule or only the violating part based on a criterion such as a share of the violating part with regard to the overall SRS.

According to a one-hundred-fifty-third aspect when referring back to any one of the one-hundred-fifteenth to one-hundred-fifty-second aspects, the transceiver device is adapted to transmit the SRS in full even if it partially overlapping with a DL subband of the SBFD time resource scheduled for the SRS.

According to a one-hundred-fifty-fourth aspect when referring back to any one of the one-hundred-fifteenth to one-hundred-fifty-third aspects, the transceiver device is adapted to operate according to resources of the first reference signal being absent or partially available within an UL subband where the SRS is to be transmitted.

According to a one-hundred-fifty-fifth aspect when referring back to the one-hundred-fifty-fourth aspect, the transceiver device is adapted to report a capability which indicates that the transceiver device is capable or not capable of interpolating and/or extrapolating a channel if the first reference signal and the SRS are in different channel bandwidths or on different frequency resources.

According to a one-hundred-fifty-sixth aspect when referring back to any one of the one-hundred-fifteenth to one-hundred-fifty-fifth aspects, the transceiver device is adapted to associate the SRS, e.g., a resource set used for the SRS, on SBFD symbols with the first reference signal being received on SBFD symbols.

According to a one-hundred-fifty-seventh aspect when referring back to any one of the one-hundred-fifteenth to one-hundred-fifty-sixth aspects, the transceiver device is adapted to associate the SRS, e.g., a resource set used for the SRS, on non-SBFD symbols with the first reference signal received on non-SBFD symbols.

According to a one-hundred-fifty-eighth aspect when referring back to any one of the one-hundred-fifteenth to one-hundred-fifty-seventh aspects, the transceiver device is adapted to associate the SRS, e.g., a resource set used for the SRS, with the first reference signal on any symbol type.

According to a one-hundred-fifty-ninth aspect when referring back to any one of the one-hundred-fifty-sixth to one-hundred-fifty-eighth aspects, the transceiver device is adapted to associate the SRS, e.g., a resource set used for the SRS, with a most recent resource used for the first reference signal, the most recent resource satisfying all timing applied conditions, e.g., the minimum gap between the last symbol of the CSI-RS and the starting symbol of SRS is ‘N’ OFDM symbols or ‘N’ time resources, where ‘N’ is defined in the specification.

According to a one-hundred-sixtieth aspect when referring back to any one of the one-hundred-fifty-sixth to one-hundred-fifty-ninth aspects, the transceiver device is adapted to calculate a precoder for a for a transmission of a sounding reference signal, SRS, in case of periodic or semi-persistent scheduling based on a CSI-RS in the same symbol type as configured for the SRS resource set.

According to a one-hundred-sixty-first aspect when referring back to any one of the one-hundred-fifteenth to one-hundred-fifty-ninth aspects, the transceiver device is adapted to ignore the association with the first reference signal resources on a particular symbol type.

According to a one-hundred-sixty-second aspect when referring back to the one-hundred-sixty-first aspect, the transceiver device is adapted to ignore the association, if a certain condition is satisfied.

According to a one-hundred-sixty-third aspect when referring back to the one-hundred-sixty-second aspect, the certain condition relates to one or more of:
-a channel bandwidth of the first reference signals and the SRS are different, e.g., the difference between the starting frequency resource of the SRS and the CSI-RS is more than a specific number of frequency resources;
a resource of the first reference signal is absent or partially available within an UL subband where the SRS is to be transmitted; and
the transceiver device reports a capability which indicates that the transceiver device is not capable of interpolating and/or extrapolating a channel or frequency resource if the CSI-RS and SRS are in different channel bandwidths.

A one-hundred-sixty-fourth aspect relates to a transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources; wherein the transceiver device is to transmit a sounding reference signal, SRS, and to use a frequency hopping, FH, for transmission of the SRS.

According to a one-hundred-sixty-fifth aspect when referring back to the one-hundred-sixty-fourth aspect, the transceiver device is adapted to be configured, e.g., by a base station, to transmit different SRS or different partial SRS in different frequency parts, e.g., parts of the frequency resource and in different time domain resources.

According to a one-hundred-sixty-sixth aspect when referring back to the one-hundred-sixty-fifth aspect, the time resource is one or more of
an absolute time, e.g., 13 or 28 milliseconds,
a symbol, e.g., OFDM symbols,
a slot, e.g., 14 OFDM symbols, sub-slots, half-slots, or mini-slots,
a subframe,
a radioframe,
a hyperframe.

According to a one-hundred-sixty-seventh aspect when referring back to the one-hundred-sixty-fifth or one-hundred-sixty-sixth aspect, a frequency resource is one or more of
a channel,
a system bandwidth,
a subchannel,
a subband,
a bandwidth part, BWP,
a component carrier, CC,
one or more subcarriers,
a physical resource block, PRB,
a fixed or variable amount of bandwidth at a fixed or varying frequency/location in a frequency grid, e.g. hopping across the frequency grid on consecutive time resources,
one or more pairs or sets of frequency resources, wherein the sets of frequency resources are to be used in the same or different time resources,
a frequency comb.

According to a one-hundred-sixty-eighth aspect when referring back to any one of the one-hundred-sixty-fifth to one-hundred-sixty-seventh aspects, different parts of the frequency hopped SRS are associated with different reference signal resources such as associated CSI-RS resources for precoder calculation, or comprise different spatial relations, e.g., multiple SSB-IDs, wherein a different SSB may be associated with a different beam.

According to a one-hundred-sixty-ninth aspect when referring back to any one of the one-hundred-sixty-fifth to one-hundred-sixty-eighth aspects, in a case where the SRS is valid only for one symbol type of a SBFD symbol and a non-SBFD symbol, the transceiver device is to transmit all the frequency hopped SRS resources on the valid symbol type.

According to a one-hundred-seventieth aspect when referring back to any one of the one-hundred-sixty-fifth to one-hundred-sixty-ninth aspects, in a case where the SRS is valid only for one symbol type, and at least a part of the frequency hopped SRS is scheduled differently than the valid symbol type, the device is adapted for one or more of:
dropping a frequency hopped SRS in the invalid symbol type;
postponing a frequency hopped SRS in the invalid symbol type, e.g., to the next available valid symbol;
also transmitting the frequency hopped SRS in the invalid symbol type transmitted.

According to a one-hundred-seventy-first aspect when referring back to the one-hundred-seventieth aspect, the transceiver device is adapted to also transmitting the frequency hopped SRS in the invalid symbol type transmitted; wherein frequency resources used for this transmission are frequency resources corresponding to the valid symbol type; or corresponding to the invalid symbol type with or without modifications.

According to a one-hundred-seventy-second aspect when referring back to the one-hundred-seventy-first aspect, the modifications relate to one or more of:
the valid symbol type of the SRS is SBFD and the frequency hopped SRS is on non-SBFD symbols, then the resources used for transmission of the SRS on the non-SBFD symbols is the same as the resources used for transmission of the SRS on the SBFD symbols;
the valid symbol type of the SRS is non-SBFD and the frequency hopped SRS is on non-SBFD symbols, then the resources used for transmission of the SRS on the SBFD symbols is truncated such that they are within the UL usable resource, e.g., where UL usable resources are the resources which lies in the overlapping parts of UL BWP and UL subband.

A one-hundred-seventy-third aspect relates to a transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources; wherein the transceiver device is to transmit a sounding reference signal, SRS, repeatedly and using a number of OFDM symbols in time domain.

According to a one-hundred-seventy-fourth aspect when referring back to the one-hundred-seventy-third aspect, the transceiver device is adapted to receive the number of OFDM symbols by a higher layer.

According to a one-hundred-seventy-fifth aspect when referring back to the one-hundred-seventy-third aspect, the transceiver device is configured or preconfigured with a configuration for performing the SRS transmission repeatedly.

According to a one-hundred-seventy-sixth aspect when referring back to the one-hundred-seventy-fifth aspect, the configuration includes one or more:
a number of repetitions or SRS occasions,
a period, e.g., the time between 2 SRS occasions belonging to a repetition,
a minimum time or number of occasions, e.g., the UE will wait until performing a repetition,
a maximum time or number of occasions, e.g., the UE will abort or drop a SRS occasion belonging to a repetition,
a pattern, e.g., a repetition pattern,
an absolute time, e.g., a time threshold, until a UE will transmit SRS repetitions,
symbol type, e.g., both non-SBFD and SBFD symbol, or just one of non-SBFD or SBFD symbol,

According to a one-hundred-seventy-seventh aspect when referring back to the one-hundred-seventy-fifth or one-hundred-seventy-sixth aspect, the transceiver device is to receive the configuration by one or more of
RRC IEs,
MAC CE,
PHY signalling,
Assistance information,
A higher layer configuration.

According to a one-hundred-seventy-eighth aspect when referring back to any one of the one-hundred-seventy-fifth to one-hundred-seventy-seventh aspects, the transceiver device is configured by
a base station, e.g., a gNB,
a core network entity, e.g., a CN,
another UE, e.g., via a BS or via a direction link, e.g., PC5 sidelink interface.

According to a one-hundred-seventy-ninth aspect when referring back to any one of the one-hundred-seventy-fifth to one-hundred-seventy-eighth aspects, the transceiver device is adapted for handling a repetition scheduled on a symbol being of type SBFD or of type non-SBFD, the symbol being invalid for transmitting the SRS by transmitting the repetition of the SRS on the invalid symbol; or by either dropping or postponing the repetition to a next available valid symbol.

According to a one-hundred-eightieth aspect when referring back to any one of the one-hundred-seventy-third to one-hundred-seventy-ninth aspects, the transceiver device is adapted for handling a repetition scheduled on a symbol being of type SBFD or of type non-SBFD, does not expect to receive a configuration scheduling to transmit the SRS on a symbol if the symbol is invalid for transmission of the SRS.

A one-hundred-eighty-first aspect relates to a transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources; wherein the transceiver device is to transmit a sounding reference signal, SRS; wherein the transceiver device comprises a plurality of antenna elements to perform a MIMO layer transmission, e.g., when SRS usage is beamManagement and/or wherein the transceiver device is to maintain different sounding reference signal, SRS, resource sets and to simultaneously transmit a plurality of SRS, each SRS being from a different SRS resource set.

According to a one-hundred-eighty-second aspect when referring back to the one-hundred-eighty-first aspect, the MIMO layer transmission is part of a configured or pre-configured beam management, e.g., a set of L1/L2 procedures to acquire and maintain a set of TRxP(s) and/or UE beams that can be used for DL and UL transmission/reception, which include at least following aspects: beam determination, beam measurement, beam reporting, beam sweeping.

According to a one-hundred-eighty-third aspect when referring back to the one-hundred-eighty-first aspect, the MIMO layer transmission comprises of one or more of
pre-coding,
beam steering,
beam sweeping,
beam determination,
beam measurement,
beam reporting.

According to a one-hundred-eighty-fourth aspect when referring back to the one-hundred-eighty-first aspect, a first resource set is associated with SBFD symbols and a second set is associated with non-SBFD symbols.

According to a one-hundred-eighty-fifth aspect when referring back to the one-hundred-eighty-first aspect, all resources within the resource set for SBFD comprise a valid symbol type of SBFD; and/or all resources within the resource set for non-SBFD comprise a valid symbol type of non-SBFD.

According to a one-hundred-eighty-sixth aspect when referring back to the one-hundred-eighty-fourth or one-hundred-eighty-fifth aspect, the transceiver device is adapted to not transmit/receive a configuration where SRS resources from different SRS resource sets for SBFD and non-SBFD symbols must be transmitted at the same time and/or simultaneously and/or within the same time resource and/or within the same type of symbol, e.g., a SBFD or a non-SBFD symbol.

According to a one-hundred-eighty-seventh aspect when referring back to any one of the one-hundred-eighty-fourth to one-hundred-eighty-sixth aspects, the transceiver device is adapted to receive a configuration where SRS resources from different SRS resource sets for SBFD and non-SBFD symbols are to be transmitted at the same time and/or simultaneously and/or within the same time resource and/or within the same type of symbol, e.g., a SBFD or a non-SBFD symbol.

According to a one-hundred-eighty-eighth aspect when referring back to the one-hundred-eighty-seventh aspect, the transceiver device is adapted to transmit only SRS for a single symbol type, e.g.,
if the symbol on which the SRS falls is SBFD, then the resources with respect to SBFD resource set is transmitted or
if the symbol on which the SRS falls is non-SBFD, then the resources with respect to non-SBFD resource set is transmitted.

According to a one-hundred-eighty-ninth aspect when referring back to the one-hundred-eighty-seventh or one-hundred-eighty-eighth aspect, the transceiver device is adapted to drop or postpone a subset or all the SRS resources in the symbol.

According to a one-hundred-ninetieth aspect when referring back to any one of the one-hundred-eighty-fourth to one-hundred-eighty-ninth aspects, the transceiver device is to maintain active resource set(s) of only one type, e.g., for SBFD symbols or non-SBFD symbols during a period of time.

According to a one-hundred-ninety-first aspect when referring back to any one of the one-hundred-eighty-fourth to one-hundred-ninetieth aspects, at least one a resource set is unassociated with regard to SBFD symbols and non-SBFD symbols.

According to a one-hundred-ninety-second aspect when referring back to the one-hundred-ninety-first aspect, SRS resources within the resource set is valid only for one symbol type of SBFD symbols and non-SBFD symbols or wherein SRS resources within the resource set is valid for both symbol types, SBFD and non-SBFD symbols.

According to a one-hundred-ninety-third aspect when referring back to the one-hundred-ninety-second aspect, the valid symbol type is determined by the symbol type of the first SRS to be transmitted for an SRS resource.

According to a one-hundred-ninety-fourth aspect when referring back to the one-hundred-ninety-second or one-hundred-ninety-third aspect, in case of aperiodic SRS, the valid symbol type is the symbol type in which the SRS is scheduled or explicitly informed to the transceiver device.

According to a one-hundred-ninety-fifth aspect when referring back to the one-hundred-ninety-fourth aspect, wherein all the other SRS resources within the resource set follow the same valid symbol type.

According to a one-hundred-ninety-sixth aspect when referring back to any one of the one-hundred-ninety-second to one-hundred-ninety-fifth aspects, the transceiver device is adapted to transmit the SRS resources within the resource set only in the valid symbol type.

According to a one-hundred-ninety-seventh aspect when referring back to any one of the one-hundred-ninety-second to one-hundred-ninety-sixth aspects, the transceiver device is adapted to drop or postpone SRS resources in the invalid symbols.

According to a one-hundred-ninety-eighth aspect when referring back to any one of the one-hundred-ninety-second to one-hundred-ninety-seventh aspects, the transceiver device is adapted to determine or being provided with the valid symbol type for each SRS resource.

According to a one-hundred-ninety-ninth aspect when referring back to any one of the one-hundred-eighty-fourth to one-hundred-ninety-eighth aspects, the transceiver device is adapted to not transmit/receive a configuration where SRS resources from different SRS resource sets for SBFD and non-SBFD symbols must be transmitted at the same time and/or simultaneously and/or within the same time resource and/or within the same type of symbol, e.g., a SBFD or a non-SBFD symbol.

According to a two-hundredth aspect when referring back to any one of the one-hundred-eighty-fourth to one-hundred-ninety-ninth aspects, the transceiver device is adapted to receive a configuration where SRS resources from different SRS resource sets for SBFD and non-SBFD symbols are to be transmitted at the same time and/or simultaneously and/or within the same time resource and/or within the same type of symbol, e.g., a SBFD or a non-SBFD symbol.

According to a two-hundred-first aspect when referring back to the two-hundredth aspect, the transceiver device is adapted to transmit only SRS for a single symbol type, e.g.,
if the symbol on which the SRS falls is SBFD, then the resources with respect to SBFD resource set is transmitted, or
if the symbol on which the SRS falls is non-SBFD, then the resources with respect to non-SBFD resource set is transmitted.

According to a two-hundred-second aspect when referring back to the two-hundredth or two-hundred-first aspect, the transceiver device is adapted to drop or postpone a subset or all the SRS resources in the symbol.

According to a two-hundred-third aspect when referring back to any one of the one-hundred-eighty-first to two-hundred-second aspects, the transceiver device is adapted to be configured with a SRS resource set comprising resources of different valid symbol types.

According to a two-hundred-fourth aspect when referring back to any one of the one-hundred-eighty-first to two-hundred-third aspects, the transceiver device is to be configured with separate configurations for SBFD and non-SBFD symbols for each SRS resource of a resource set; wherein both symbol types are valid for the resource set.

A two-hundred-fifth aspect relates to a transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources; wherein the transceiver device is to transmit a sounding reference signal, SRS; wherein the transceiver device comprises a plurality of antenna ports and to select at least one of the plurality of antenna ports for transmitting a sounding reference signal, SRS; wherein the transceiver device is to transmit an SRS from each of the plurality of antenna ports or a combination of antenna ports, e.g., to allow a different node such as a configuring base station to select the best antenna port or ports for communication.

According to a two-hundred-sixth aspect when referring back to the two-hundred-fifth aspect, the combination of antenna ports is selected
randomly, or
based on a configured or pre-configured pattern, e.g., antenna selection pattern, e.g., select 2 out of 4 antennas, e.g. 2T4R, e.g., selecting antenna ports having the same TCI state or which are quasi co-located, QCL.

According to a two-hundred-seventh aspect when referring back to the two-hundred-fifth or two-hundred-sixth aspect, the transceiver device is adapted to maintain separate SRS resource sets for SBFD and non-SBFD symbols.

According to a two-hundred-eighth aspect when referring back to the two-hundred-fifth or two-hundred-seventh aspect, the transceiver device is adapted to have, whilst communicating in the wireless communication network, anytime configured or active a pair of resource sets where one of the resource sets corresponds to SBFD symbols and the other corresponds to non-SBFD symbols.

According to a two-hundred-ninth aspect when referring back to the two-hundred-eighth aspect, the pair of resource sets comprise a same port configuration.

According to a two-hundred-tenth aspect when referring back to any one of the two-hundred-fifth to two-hundred-ninth aspects, the transceiver device is adapted to maintain separate configurations for SBFD and non-SBFD symbols for each SRS resource of a resource set; wherein both symbol types are valid for the resource set.

According to a two-hundred-eleventh aspect when referring back to the two-hundred-tenth aspect, the transceiver device is adapted to maintain the resource sets as being not linked to SBFD or non-SBFD symbols.

According to a two-hundred-twelfth aspect when referring back to the two-hundred-tenth or two-hundred-eleventh aspect, the transceiver device is adapted to receive explicit configurations for SBFD and non-SBFD symbols; or adapted to derive a configuration of one symbol type from the other.

According to a two-hundred-thirteenth aspect when referring back to the two-hundred-twelfth aspect, the transceiver device is adapted to derive the configuration based on a determination rule such as a rule defined in the specification.

According to a two-hundred-fourteenth aspect when referring back to any one of the two-hundred-fifth to two-hundred-thirteenth aspects, the transceiver device is adapted to maintain a common SRS resource set for both SBFD symbols and non-SBFD symbols, wherein each SRS resource within the SRS resource set comprises a valid symbol, e.g., defined and/or derived.

According to a two-hundred-fifteenth aspect when referring back to the two-hundred-fourteenth aspect, the transceiver device is adapted to maintain the resource set as being not linked to SBFD or non-SBFD symbols.

According to a two-hundred-sixteenth aspect when referring back to the two-hundred-fifteenth aspect, a valid symbol type for the SRS resource is determined by the symbol type of the first SRS to be transmitted for an SRS resource.

According to a two-hundred-seventeenth aspect when referring back to the two-hundred-fifteenth or two-hundred-sixteenth aspect, in case of aperiodic SRS, the valid symbol type is the symbol type in which the SRS is scheduled or explicitly informed to the transceiver device.

According to a two-hundred-eighteenth aspect when referring back to the two-hundred-seventeenth aspect, all the other SRS resources within the resource set follow the same valid symbol type.

According to a two-hundred-nineteenth aspect when referring back to any one of the two-hundred-fourteenth to two-hundred-eighteenth aspects, the transceiver device adapted to have, whilst communicating in the wireless communication network, anytime configured or active a pair of resources within the resource set where one of the resources corresponds to SBFD symbols and the other corresponds to non-SBFD symbols.

According to a two-hundred-twentieth aspect when referring back to the two-hundred-nineteenth aspect, the pair of resources comprise a same port number.

According to a two-hundred-twenty-first aspect when referring back to the two-hundred-nineteenth or two-hundred-twentieth aspect, a maximum value of SRS resources as indicated by a transceiver device capability is increased as compared to a legacy value.

A two-hundred-twenty-second aspect relates to a base station for operating in a wireless communication network providing a plurality of time resources in a time-frequency grid, the plurality of time resources comprising a first subset of time resources being sub-band full duplex, SBFD, time resources and a second subset of time resources being non-SBFD time resources;
wherein the base station is adapted to derive a CSI for both SBFD and non-SBFD symbols using a same SRS resource based on information which symbols are SBFD and which are non-SBFD symbols.

A two-hundred-twenty-third aspect relates to a base station for operating in a wireless communication network providing a plurality of time resources in a time-frequency grid, the plurality of time resources comprising a first subset of time resources being sub-band full duplex, SBFD, time resources and a second subset of time resources being non-SBFD time resources; wherein the base station is to operate based on an association between a sounding reference signal, SRS, transmitted by a transceiver device served by the base station and a first reference signal; and based on a spatial relation between the SRS and a second reference signal being the first reference signal or a different reference signal; based on an uplink, UL, bandwidth of an SBFD time resource; wherein the base station is adapted to schedule transmission of a reference signal such as a sounding reference signal, SRS, for a transceiver device; wherein the base station is adapted to schedule DL resources of the wireless communication network such that the base station does not transmit a DL in SRS resources overlapping with the DL resources.

According to a two-hundred-twenty-fourth aspect when referring back to the two-hundred-twenty-third aspect, the transceiver device is in accordance with one of the one-hundred-fifteenth to one-hundred-sixty-third aspects.

According to a two-hundred-twenty-fifth aspect when referring back to the two-hundred-twenty-third aspect, any configuration is provided by the base station and/or the network, e.g., the core network, CN.

A two-hundred-twenty-sixth aspect relates to a transceiver device such as a user equipment, UE, configured for operating in a wireless communication network providing a plurality of time resources in a time-frequency grid, the plurality of time resources comprising a subset of time resources being sub-band full duplex, SBFD, time resources; wherein a SBFD time resources provides for at least one uplink, UL, subband; and for at least one downlink, DL, subband; wherein the transceiver device is to receive instructions indicating a link direction associated with whether to transmit UL or receive DL in a SBFD time resource; and to operate accordingly.

According to a two-hundred-twenty-seventh aspect when referring back to the two-hundred-twenty-sixth aspect, the link direction is received with a semi-static signalling or a dynamic signalling.

According to a two-hundred-twenty-eighth aspect when referring back to the two-hundred-twenty-seventh aspect, semi-static signalling comprises one or more of
information provided in or derived from Radio Resource Configuration, RRC;
a legacy TDD dedicated configuration in RRC, e.g., TDD-UL-DL-ConfigDedicated or TDD-UL-DL-ConfigCommon;
a control signal, e.g., the control signal giving the link direction;
   and/or wherein the dynamic signalling comprises one or more of
a legacy slot format indicator (SFI),
a control signal, e.g., the control signal giving the link direction.

According to a first further aspect when referring back to any one of the two-hundred-twenty-sixth to two-hundred-twenty-eighth aspects, the transceiver device is to derive, e.g., per one or more of DL BWP, UL BWP, frequency resource, information related to a Configure Grant, CG.

According to a second further aspect when referring back to the first further aspect, the transceiver device is to obtain a configuration explicitly provided in or derived from the information related to the CG being a ConfiguredGrantConfig information.

According to a third further aspect when referring back to the second further aspect, wherein the transceiver device is to follow the configuration explicitly provided in or derived from ConfiguredGrantConfig; or to follow the configuration as provided in or derived from information related to a PUSCH and to ignore the configuration explicitly provided in or derived from ConfiguredGrantConfig.

According to a fourth further aspect when referring back to the second further aspect or the third further aspect, in absence of an explicit configuration provided in or derived from ConfiguredGrantConfig, the transceiver device is to follow a configuration as provided in or derived from information related to PUSCH.

According to a fifth further aspect when referring back to any one of the two-hundred-twenty-sixth aspect to fourth further aspect, the transceiver device is to receive at least one of: PDSCH, PDSCH repetitions, multi-PDSCH, and CSI-RS, in SBFD symbols and/or non-SBFD symbols in same slots or different slots in a given DL BWP.

According to a sixth further aspect when referring back to any one of the two-hundred-twenty-sixth aspect to fifth further aspect, the transceiver device is to transmit at least one of: PUSCH, PUSCH repetitions, multi-PUSCH, TboMS, and SRS, in SBFD symbols and/or non-SBFD symbols in same slots or different slots in a given UL BWP.

According to a two-hundred-twenty-ninth aspect when referring back to the two-hundred-twenty-seventh or two-hundred-twenty-eighth aspect, for a semi-static signalling of the link direction, e.g., using the control signal, the signalling is for every time resource, every symbol or a combination of time resources and symbols or in time resources where TDD dedicated configuration is provided or only for SBFD time resources.

It is to be noted that in regard to the aspects, when referring back to any one of the two-hundred-twenty-sixth aspect to the two-hundred-twenty-ninth aspect and/or any one of the two-hundred-twenty-sixth aspect to one or more subsequent aspects, the one or more subsequent aspects being subsequent to the two-hundred-twenty-ninth aspect, any one of the another aspects, i.e. any one of the first further aspect to the sixth further aspect, are included when making the reference.

According to a two-hundred-thirtieth aspect when referring back to any one of the two-hundred-twenty-sixth to two-hundred-twenty-ninth aspects, the transceiver device is adapted to ignore the instructions in a non-SBFD time resource, e.g., if link direction is provided for non-SBFD time resources.

According to a two-hundred-thirty-first aspect when referring back to any one of the two-hundred-twenty-sixth to two-hundred-thirtieth aspects, the transceiver device is adapted to operate according to the instructions in non-SBFD symbols and to ignore a dedicated TDD configuration, if provided.

According to a two-hundred-thirty-second aspect when referring back to any one of the two-hundred-twenty-sixth to two-hundred-thirty-first aspects, the transceiver device is adapted to receive the instructions using a TDD dedicated configuration, e.g., TDD-UL-DL-ConfigDedicated.

According to a two-hundred-thirty-third aspect when referring back to the two-hundred-thirty-second aspect, the transceiver device is adapted to receive the instructions to relate to Flexible, F, symbols only that are configured by TDD common configuration, e.g., TDD-UL-DL-ConfigCommon.

According to a two-hundred-thirty-fourth aspect when referring back to the two-hundred-thirty-third aspect, the transceiver device is adapted to use the link direction for an SFBD symbol that is indicated in the instruction.

According to a two-hundred-thirty-fifth aspect when referring back to any one of the two-hundred-twenty-sixth to two-hundred-thirty-fourth aspects, the transceiver device is adapted to receive the instructions indicating to use specific time resources for communication in a particular direction, e.g., uplink or downlink or sidelink.

According to a two-hundred-thirty-sixth aspect when referring back to any one of the two-hundred-twenty-sixth to two-hundred-thirty-fifth aspects, the specific time resources for communication in a particular direction is one or more of:
an indicated resource in time, e.g. a slot, frame, symbol or/and in frequency, e.g. a BWP, PRB, one or more subcarriers.
A resource opportunity next after or with a known difference after an indicated resource in time, e.g. a slot, frame, symbol or/and in frequency, e.g. a BWP, PRB, one or more subcarriers.
A resource opportunity with a suitable difference after an indicated resource in time, e.g. a slot, frame, symbol or/and in frequency, e.g. a BWP, PRB, one or more subcarriers, wherein the suitable difference may be decided by the transceiver device or may be random or subject to signal processing procedure, e.g. time needed to receive and decode an indication message.
A resource opportunity in regular intervals, e.g. semi-static differences in time or frequency after an indicated resource in time, e.g. a slot, frame, symbol or/and in frequency, e.g. a BWP, PRB, one or more subcarriers.
A resource opportunity in a regular or irregular interval structure derived from a functional relation, e.g. differences in time or frequency are calculated a hopping sequence.

According to a two-hundred-thirty-seventh aspect when referring back to any one of the two-hundred-twenty-sixth to two-hundred-thirty-sixth aspects, the transceiver device is adapted to use the link direction
after a minimum or maximum time gap or offset with respect to the time, the link direction indication was received.

According to a two-hundred-thirty-eighth aspect when referring back to any one of the two-hundred-twenty-sixth to two-hundred-thirty-seventh aspects, the time gap can be one or more of:
an absolute time, e.g., 13 or 28 milliseconds,
an implicit time period derived from a referenced time unit, e.g. a time gap, symbol period, sample distance, period between signal repetitions,
a symbol, e.g., OFDM symbols,
a slot, e.g., 14 OFDM symbols, sub-slots, half-slots, or mini-slots,
a subframe,
a radioframe,
a hyperframe.

According to a two-hundred-thirty-ninth aspect when referring back to the two-hundred-thirty-seventh or two-hundred-thirty-eighth aspect, the time gap is configured or pre-configured or indicated or based on UE capability.

According to a two-hundred-fortieth aspect when referring back to any one of the two-hundred-thirty-third to two-hundred-thirty-ninth aspects, the transceiver device is adapted to interpret the instructions for a non-SBFD symbol in legacy way.

According to a two-hundred-forty-first aspect when referring back to any one of the two-hundred-thirty-third to two-hundred-fortieth aspects, the transceiver device is adapted to operate according to separate link directions provided for DL symbols configured by TDD common configuration, e.g., TDD-UL-DL-ConfigCommon.

According to a two-hundred-forty-second aspect when referring back to the two-hundred-forty-first aspect, the TDD common configuration relates to SBFD symbols only; or wherein the TDD common configuration relates to both SBFD and non-SBFD symbols; wherein the transceiver device is to ignore the TDD common configuration in non-SBFD symbols.

According to a two-hundred-forty-third aspect when referring back to the two-hundred-thirty-second aspect, the transceiver device is adapted to receive the instructions to relate to DL and Flexible, F, symbols configured by TDD common configuration.

According to a two-hundred-forty-fourth aspect when referring back to the two-hundred-forty-third aspect, the transceiver device is adapted to use the link direction for an SFBD symbol that is indicated in the instruction.

According to a two-hundred-forty-fifth aspect when referring back to the two-hundred-forty-third or two-hundred-forty-fourth aspect, the transceiver device is adapted to interpret the instructions for a non-SBFD symbol in legacy way.

According to a two-hundred-forty-sixth aspect when referring back to any one of the two-hundred-twenty-sixth to two-hundred-forty-fifth aspects, the transceiver device is adapted to use a SFBD symbol of a DL subband for downlink if the link direction is DL, and to use a SFBD symbol of an UL subband for uplink, if the link direction is UL.

According to a two-hundred-forty-seventh aspect when referring back to the two-hundred-twenty-seventh aspect, the dynamic signalling comprises a legacy SFI configuration in RRC.

According to a two-hundred-forty-eighth aspect when referring back to the two-hundred-forty-seventh aspect, the transceiver device is adapted for using a downlink control information, DCI, for a dynamic scheduling of the link direction and/or the SBFD-symbols.

According to a two-hundred-forty-ninth aspect when referring back to any one of the two-hundred-twenty-sixth to two-hundred-forty-eighth aspects, the transceiver device is adapted to implement at least one collision handling rule in absence of an indicated link direction.

According to a two-hundred-fiftieth aspect when referring back to any one of the two-hundred-twenty-seventh to two-hundred-forty-ninth aspects, in case of a conflict between the semi-static or dynamic signalling of the link direction and a DCI, the transceiver device is to follow a legacy rule between TDD common, TDD dedicated, SFI and DCI; or to follow the instructions according to the DCI.

According to a two-hundred-fifty-first aspect when referring back to any one of the two-hundred-twenty-seventh to two-hundred-forty-ninth aspects, in case of a conflict between the semi-static signalling and the dynamic signalling of the link direction, the transceiver device is adapted to follow a legacy rule between TDD common, TDD dedicated and SFI.

According to a two-hundred-fifty-second aspect when referring back to any one of the two-hundred-twenty-sixth to two-hundred-fifty-first aspects, the transceiver device is adapted to operate according to a scheduling of a DCI format to receive PDSCH over multiple time resource, e.g., slots, and to receive the instructions indicating that the link direction is uplink, for at least one symbol thereof, the transceiver device is to perform PDSCH reception contradicting the link direction.

According to a two-hundred-fifty-third aspect when referring back to any one of the two-hundred-twenty-sixth to two-hundred-fifty-second aspects, the transceiver device is adapted to operate according to a scheduling of a DCI format to receive PDSCH over multiple time resource, e.g., slots, and to receive instructions for a time resource from the multiple time resources, at least one symbol from a set of symbols where the UE is scheduled for PDSCH reception in the time resource which is an uplink symbol, the UE is not expected to receive the PDSCH in the time resource.

According to a two-hundred-fifty-fourth aspect when referring back to any one of the two-hundred-twenty-sixth to two-hundred-fifty-third aspects, the transceiver device is adapted to operate according to a scheduling of a DCI format to receive PDSCH over multiple time resources, and if the link direction, indicate that, for a time resource from the multiple time resources, at least one symbol from a set of symbols where the transceiver device is scheduled for PUSCH transmission in the time resource which is a downlink symbol, the transceiver device is adapted to still transmit the PUSCH in the time resource.

According to a two-hundred-fifty-fifth aspect when referring back to any one of the two-hundred-twenty-sixth to two-hundred-fifty-fourth aspects, the transceiver device is adapted to operate according to a scheduling of a DCI format to receive PDSCH over multiple time resources, and if the link direction, indicate that, for a time resource from the multiple time resources, at least one symbol from a set of symbols where the transceiver device is scheduled for PUSCH transmission in the time resource which is a downlink symbol, the transceiver device is adapted to still receive the PDSCH in the time resource.

According to a two-hundred-fifty-sixth aspect when referring back to any one of the two-hundred-twenty-sixth to two-hundred-fifty-fifth aspects, the transceiver device is adapted to operate according to a scheduling of a DCI format to transmit PUSCH over multiple time resources, and if the link direction, indicates that, for a time resource from the multiple time resources, at least one symbol from a set of symbols where the transceiver device is scheduled for PUSCH transmission in the time resource is a downlink symbol, the transceiver device does not transmit, e.g., drops, the PUSCH in the time resource or postpones the PUSCH to another time resource.

According to a two-hundred-fifty-seventh aspect when referring back to any one of the two-hundred-twenty-sixth to two-hundred-fifty-sixth aspects, the transceiver device is adapted to operate according to a scheduling of a DCI format to transmit PUSCH over multiple time resources, and if the link direction, indicates that, for a time resource from the multiple time resources, at least one symbol from a set of symbols where the transceiver device is scheduled for PUSCH transmission in the time resource is a downlink symbol, the transceiver device will transmit PUSCH message in the time resource and will not postpone the PUSCH to another time resource.

According to a two-hundred-fifty-eighth aspect when referring back to any one of the two-hundred-twenty-sixth to two-hundred-fifty-seventh aspects, the transceiver device is adapted to receive, e.g., from a base station, explicitly or implicitly, information indicating if link direction is provided or to be used or from another UE, explicitly or implicitly, information indicating if link direction is provided, or based on an assistance message, or based on a measurement, e.g., the transceiver device detects a certain signal and predicts a link direction, e.g., using AI; and to operate accordingly.

According to a two-hundred-fifty-ninth aspect when referring back to the two-hundred-fifty-eighth aspect, the transceiver device is adapted to request the link direction from the base station or from another device, e.g., a UE; and/or adapted to report a capability information indicating a capability to use SBFD symbols.

According to a two-hundred-sixtieth aspect when referring back to any one of the two-hundred-twenty-sixth to two-hundred-fifty-ninth aspects, the transceiver device is adapted to ignore the instructions related to the link direction based on being configured with certain types of signals/channels e.g., grant free UL transmissions.

According to a two-hundred-sixty-first aspect when referring back to the two-hundred-sixtieth aspect, the transceiver device is adapted to ignore the instructions related to the link direction only within a predefined, preconfigured or predetermined period and/or during a period in which a grant free UL transmission is active.

According to a two-hundred-sixty-second aspect when referring back to the two-hundred-sixtieth or two-hundred-sixty-first aspect, the transceiver device is adapted to ignore the instructions related to the link direction completely in all symbols or only in UL symbols.

According to a two-hundred-sixty-third aspect when referring back to any one of the two-hundred-sixtieth to two-hundred-sixty-second aspects, the transceiver device is, adapted to receive, e.g., from a base station serving the transceiver device, information indicating a list of time resources and/or symbols where the link direction is not applicable; and to operate accordingly, e.g. not using these symbols.

According to a two-hundred-sixty-fourth aspect when referring back to any one of the two-hundred-sixtieth to two-hundred-sixty-third aspects, the transceiver device is adapted to determine information indicating a list of time resources and/or symbols where the link direction is not applicable; and to operate accordingly, e.g. not using these symbols.

According to a two-hundred-sixty-fifth aspect when referring back to any one of the two-hundred-sixtieth to two-hundred-sixty-fourth aspects, the transceiver device is adapted to receive, e.g., from a base station serving the transceiver device, information indicating a list of time resources and/or symbols where the link direction is not applicable; and to ignore the conflict, e.g. by still using these symbols.

According to a two-hundred-sixty-sixth aspect when referring back to any one of the two-hundred-sixtieth to two-hundred-sixty-fifth aspects, the transceiver device is adapted to determine information indicating a list of time resources and/or symbols where the link direction is not applicable; and to ignore the conflict, e.g. by still using these symbols.

According to a two-hundred-sixty-seventh aspect when referring back to any one of the two-hundred-twenty-sixth to two-hundred-sixty-sixth aspects, the link direction is valid in terms of at least one mini-slot or half-slot or at least one subslots, e.g., at least one group of symbols within a slot.

According to a two-hundred-sixty-eighth aspect when referring back to any one of the two-hundred-twenty-sixth to two-hundred-sixty-seventh aspects, the link direction is indicated for the transmission of PRACH, e.g., PRACH Msg1 or PRACH Msg3.

According to a two-hundred-sixty-ninth aspect when referring back to any one of the two-hundred-twenty-sixth to two-hundred-sixty-eighth aspects, the link direction is indicated within the PRACH procedure, e.g., within a control signal transmitted by the base station, e.g., one or more of a PRACH occasion,
a PDSCH Msg2, e.g., Random Access Response,
a PDSCH Msg4, contention resolution.

A two-hundred-seventieth aspect relates to a base station configured for operating in a wireless communication network providing a plurality of time resources in a time-frequency grid, the plurality of time resources comprising a subset of time resources being sub-band full duplex, SBFD, time resources; wherein a SBFD time resources provides for at least one uplink, UL, subband; and for at least one downlink, DL, subband; wherein the base station is to provide instructions to a transceiver device, e.g., when referring back to any one of the two-hundred-twenty-sixth to two-hundred-sixty-ninth aspects, of part 3 Link Direction Indication—UE perspective, the instructions indicating a link direction associated with whether to use the UL subband or the DL subband of a SBFD time resource.

According to a two-hundred-seventy-first aspect when referring back to the two-hundred-seventieth aspect, the base station is adapted to provide the instructions only for SBFD symbols.

According to a two-hundred-seventy-second aspect when referring back to the two-hundred-seventieth or two-hundred-seventy-first aspect, the base station is adapted to indicates to the transceiver device, explicitly or implicitly, if link direction is provided or to be used.

According to a two-hundred-seventy-third aspect when referring back to the two-hundred-seventy-second aspect, the base station is adapted to provides explicit link direction to the transceiver device when one or more of
The transceiver device explicitly requests it,
The transceiver device reports a certain capability information;
The transceiver device is within a certain geo-location, e.g., a certain distance from the base station,
The transceiver device performs a random access procedure, e.g., PRACH,
a type of service provided to the transceiver device is not of a particular type like URLLC
a measurement at the UE indicates a certain link direction.

According to a two-hundred-seventy-fourth aspect when referring back to any one of the two-hundred-seventieth to two-hundred-seventy-third aspects, the base station is, adapted to not provide the instructions related to the link direction, e.g., explicitly, the transceiver device based on grant free UL transmissions configured or the transceiver device, e.g., of a specific type or category reported by the UE, e.g., RedCap, URLLC etc.

According to a two-hundred-seventy-fifth aspect when referring back to any one of the two-hundred-seventieth to two-hundred-seventy-fourth aspects, the base station is adapted to not provide, e.g., to the transceiver device, information indicating a list of time resources and/or symbols where the link direction is not applicable.

A two-hundred-seventy-sixth aspect relates to a method to operate a transceiver device such as a user equipment, UE, in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising: according to a first configuration, restricting communication to one of the first type and the second type; and according to a second configuration, using both the first type and the second type for communication; operating according to the first configuration or the second configuration based on a received message, e.g., from a base station; and/or based on a determination result obtained by the transceiver device.

A two-hundred-seventy-seventh aspect relates to a method for operating a transceiver device such as a user equipment, UE, in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising:
operating the transceiver device based on an association between a sounding reference signal, SRS, transmitted by the transceiver device and a first reference signal.

A two-hundred-seventy-eighth aspect relates to a method for operating a transceiver device such as a user equipment, UE, in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising:
operating the transceiver device based on a spatial relation between a SRS and
a second reference signal or
a second reference signal being the first reference signal or a different reference signal.

A two-hundred-seventy-ninth aspect relates to a method for operating a base station in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising: operating the base station based on an association between a sounding reference signal, SRS, transmitted by a transceiver device served by the base station and a first reference signal; and based on a spatial relation between the SRS and a second reference signal being the first reference signal or a different reference signal; based on an uplink, UL, bandwidth of an SBFD time resource; scheduling transmission of a reference signal such as a sounding reference signal, SRS, for a transceiver device; scheduling DL resources of the wireless communication network such that the base station does not transmit a DL in SRS resources overlapping with the DL resources.

A two-hundred-eightieth aspect relates to a method for operating a transceiver device such as a user equipment, UE, in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising: transmitting a sounding reference signal, SRS, and to use a frequency hopping, FH, for transmission of the SRS.

A two-hundred-eighty-first aspect relates to a method for operating a transceiver device such as a user equipment, UE, in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising: transmitting a sounding reference signal, SRS, repeatedly and using a number of OFDM symbols in time domain.

A two-hundred-eighty-second aspect relates to a method for operating a transceiver device such as a user equipment, UE, in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising: transmitting a sounding reference signal, SRS; such that the transceiver device comprises a plurality of antenna elements to perform a MIMO layer transmission, e.g., when SRS usage is beamManagement; and/or such that the transceiver device is to maintain different sounding reference signal, SRS, resource sets and to simultaneously transmit a plurality of SRS, each SRS being from a different SRS resource set.

A two-hundred-eighty-third aspect relates to a method for operating a transceiver device such as a user equipment, UE, in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising: transmit a sounding reference signal, SRS; such that the transceiver device comprises a plurality of antenna ports and selects at least one of the plurality of antenna ports for transmitting a sounding reference signal, SRS; such that the transceiver device transmits an SRS from each of the plurality of antenna ports or a combination of antenna ports, e.g., to allow a different node such as a configuring base station to select the best antenna port or ports for communication.

A two-hundred-eighty-fourth aspect relates to a method for operating a base station in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising; deriving a CSI for both SBFD and non-SBFD symbols using a same SRS resource based on information which symbols are SBFD and which are non-SBFD symbols.

A two-hundred-eighty-fifth aspect relates to a method for operating a transceiver device such as a user equipment, UE, in a wireless communication network providing a plurality of time resources in a time-frequency grid, the plurality of time resources comprising a subset of time resources being sub-band full duplex, SBFD, time resources; wherein a SBFD time resources provides for at least one uplink, UL, subband; and for at least one downlink, DL, subband; the method comprising: receiving instructions indicating a link direction associated with whether to transmit UL or receive DL in a SBFD time resource; and to operate accordingly.

A two-hundred-eighty-sixth aspect relates to a method for operating a base station in a wireless communication network providing a plurality of time resources in a time-frequency grid, the plurality of time resources comprising a subset of time resources being sub-band full duplex, SBFD, time resources; wherein a SBFD time resources provides for at least one uplink, UL, subband; and for at least one downlink, DL, subband, the method comprising: providing instructions to a transceiver device, the instructions indicating a link direction associated with whether to use the UL subband or the DL subband of a SBFD time resource.

A two-hundred-eighty-seventh aspect relates to a computer readable digital storage medium having stored thereon a computer program having a program code for performing, when running on a computer, a method when referring back to any one of the two-hundred-seventy-sixth to two-hundred-eighty-sixth aspects.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

| Abbreviation | Definition | Further description |
|---|---|---|
| 2G | second generation | |
| 3G | third generation | |
| 3GPP | third generation partnership | |
| | project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AFOV | angular field of view | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity | |
| | optimization | |
| CHO | conditional handover | |
| CLI | cross-link interference | |
| CLI-RSS | cross-link interference received | |
| CP | control plane | |
| CP1 | control plane 1 | |
| CP2 | control plane 2 | |
| CPRI | common public radio interface | |
| CSI-IM | channel state information | |
| CSI-RS | channel state information | |
| | reference | |
| CU | central/centralized unit | |
| D2D | device-to-device | |
| DAPS | dual active protocol stack | |
| DAC | digital-to-analogue converter | |
| DC-CA | dual-connectivity carrier | |
| | aggregation | |
| DECT | digitally enhanced cordless | |
| | telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global identifier | |
| E-CID | enhanced cell ID | |
| eCPRI | enhanced CPRI | |
| EFOV | effective field-of-view | |
| eNB | evolved Node b | |
| EN-DC | e-UTRAN-New Radio dual | |
| EUTRA | enhanced UTRA | |
| E-UTRAN | enhanced UTRA network | |
| FOV | field-of-view | |
| FSS | frequency-selective surface | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity/identification | |
| IF | intermediate frequency | |
| IIOT | industrial internet of things | |
| KPI | key-performance indicator | |
| LEO | low Earth-orbit | associated with |
| | | satellites |
| LOS | line-of-sight | |
| LTE | long-term evolution | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing |
| | | E-UTRA |
| NG-RAN | either a gNB or an NG-eNB | |
| NGSO | non-geostationary orbit | |
| NIC | network interface connection | |
| NLOS | non line-of-sight | |
| NR | new radio | |
| NR-U | NR unlicensed | NR operating in |
| NTN | non-terrestrial network | |
| OAM | operation and maintenance | |
| OEM | original equipment manufacturer | |
| OTT | over-the-top | |
| oRAN | see open RAN | |
| Open RAN | open radio access network | |
| PCI | physical cell identifier | Also known as PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RE | resource element | |
| RF | radio frequency | |
| RIM | radio access network information | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile | |
| | network | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure | |
| | function | |
| SCG | secondary cell group | |
| SDU | service data unit | |
| SIB | system information block | |
| SINR | signal-to-interference-plus-noise | |
| | ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SRI | sounding reference indication | |
| SS | synchronization signal | |
| SSB | synchronization signal block | |
| SSID | service set identifier | |
| SS-PBCH | sounding signal/physical broadcast | |
| TAC | tracking area code | |
| TB | transmission block | |
| TCI | transmission configuration | |
| | indication | |
| TDD | time division duplex | |
| TN | terrestrial network | |
| TSG | technical specification group | |
| UAV | unmanned airborne vehicle | |
| UE | user equipment | |
| UL | uplink | |
| UP | user plane | |
| URLLC | ultra-reliable low latency | |
| UTRAN | universal trunked radio access | |
| V2X | vehicle-to-everything | |
| VoIP | voice over internet protocol | |
| vRAN | virtual ran | |
| WI | work item | |
| WLAN | wireless local area network | |

I/We claim:

1. A transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources;
wherein the transceiver device is to operate based on an association between a sounding reference signal, SRS, transmitted by the transceiver device and a first reference signal.

2. A transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources;
wherein the transceiver device is to operate based on a spatial relation between the SRS and
a second reference signal or,
a second reference signal being the first reference signal or a different reference signal.

3. The transceiver device of claim 1, adapted to consider the association based on a same symbol type being used for the first reference signal, e.g., CSI-RS, and the SRS, e.g., SBFD or non-SBFD.

4. The transceiver device of claim 1, adapted to associate the SRS, e.g., a resource set used for the SRS, on SBFD symbols with the first reference signal being received on SBFD symbols.

5. The transceiver device of claim 1, adapted to associate the SRS, e.g., a resource set used for the SRS, on non-SBFD symbols with the first reference signal received on non-SBFD symbols.

6. The transceiver device of claim 1, adapted to associate the SRS, e.g., a resource set used for the SRS, with the first reference signal on any symbol type.

7. The transceiver device of claim 4, adapted to associate the SRS, e.g., a resource set used for the SRS, with a most recent resource used for the first reference signal, the most recent resource satisfying all timing applied conditions, e.g., the minimum gap between the last symbol of the CSI-RS and the starting symbol of SRS is ‘N’ OFDM symbols or ‘N’ time resources, where ‘N’ is defined in the specification.

8. The transceiver device of claim 4, adapted to calculate a precoder for a for a transmission of a sounding reference signal, SRS, in case of periodic or semi-persistent scheduling based on a CSI-RS in the same symbol type as configured for the SRS resource set.

9. A transceiver device of claim 1, wherein the different reference signal is one of
SSB, e.g., comprising an SSB-ID,
CSI-RS, e.g. a CSI-RS resource or associated CSI-RS,
A further SRS, e.g., comprising a different configuration, e.g., SRS-ID.

10. A transceiver device of claim 1, wherein the transmission is
based on an uplink, UL, bandwidth of an SBFD time resource or
based on an uplink, UL, bandwidth of an SBFD time resource and overlapping or partially overlapping with the downlink, DL, resources of an SBFD time resource.

11. The transceiver device of claim 1, wherein the transceiver device is to process the SRS resource only on one type of symbol, either SBFD or non-SBFD.

12. The transceiver device of claim 11, adapted to be provided with a resource of the first reference signal as only comprising one valid symbol type being a same or a different valid symbol type as that of the SRS; or
adapted to be provided a resource of the first reference signal as comprising the signals of type of the first reference signal on both SBFD and non-SBFD symbols.

13. The transceiver device of claim 12, adapted to operate the association as valid based on a predefined validity condition.

14. The transceiver device of claim 13, wherein the validity condition is related to whether the first and/or second reference signal is received within a bandwidth being similar with the UL bandwidth of the SBFD time resource of the transceiver device, e.g., in the same frequency resource.

15. The transceiver device of claim 14, wherein the validity condition relates to a channel bandwidth of the first reference signal and the SRS being different, e.g., the difference between the starting frequency resource of the SRS and the CSI-RS is less than a specific number of frequency resources.

16. The transceiver device of claim 1, wherein one or more SRS are associated with one or more reference signals of a same or of different types.

17. The transceiver device of claim 16, wherein at least one of the SRS is limited to a certain, i.e., predefined, configured or preconfigured time, e.g., periodic or semi and/or frequency location within a frequency band.

18. The transceiver device of claim 17, adapted to transmit the first reference signal(s) based on a localization of the SRS in frequency domain, such that a channel or subchannel is only covered by a certain fraction 1/n with n being a number >1, or by use of at least one subchannel of at least two subchannels located within the channel.

19. The transceiver device of claim 16, adapted to transmit a plurality of SRS within the UL bandwidth of the SBFD time resource, comprising one or more of
the plurality of SRS being offset in time,
the plurality of SRS being configured with a single SRS ID, and
with frequency hopping, or
without frequency hopping, e.g., with repetition in time domain,
the plurality of SRS being configured with multiple SRS IDs, and
with frequency hopping, or
without frequency hopping, e.g., with repetition in time domain.

20. The transceiver device of claim 13, wherein at least one SRS is associated with a single first reference signal, wherein the first reference signal and the at least one SRS are located in different parts of the frequency spectrum, e.g., in different channels and/or subchannels and/or frequency resources, e.g., in an adjacent channel.

21. The transceiver device of claim 14,
wherein a frequency resource is one or more of
a channel,
a system bandwidth,
a subchannel,
a subband,
a bandwidth part, BWP,
a component carrier, CC,
one or more subcarriers,
a physical resource block, PRB,
a fixed or variable amount of bandwidth at a fixed or varying frequency/location in a frequency grid, e.g. hopping across the frequency grid on consecutive time resources,
one or more pairs or sets of frequency resources, wherein the sets of frequency resources are to be used in the same or different time resources,
a frequency comb.

22. The transceiver device of claim 1, adapted for the first reference signal being transmitted in the wireless communication network in a periodic or aperiodic or triggered or scheduled manner, e.g., received by the transceiver device.

23. The transceiver device of claim 1, adapted according to the association depending on a point in time, when the first reference signal is transmitted.

24. The transceiver device of claim 22, adapted to consider the association if a minimum time offset or a minimum number of symbols or time resources is present between the first reference signal and the SRS.

25. The transceiver device of claim 1, wherein the SRS of an associated first reference signal is constraint in its frequency position; wherein the transceiver device is adapted to operate accordingly.

26. A transceiver device such as a user equipment, UE, configured for operating in a wireless communication network providing a plurality of time resources in a time-frequency grid, the plurality of time resources comprising a first subset of time resources being sub-band full duplex, SBFD, time resources and a second subset of time resources being non-SBFD time resources;
wherein the transceiver device is to transmit a sounding reference signal, SRS;
wherein the transceiver device comprises a plurality of antenna elements to perform a MIMO layer transmission, e.g., when SRS usage is beamManagement and/or
wherein the transceiver device is to maintain different sounding reference signal, SRS, resource sets and to simultaneously transmit a plurality of SRS, each SRS being from a different SRS resource set.

27. The transceiver device of claim 26, wherein the MIMO layer transmission comprises of one or more of
pre-coding,
beam steering,
beam sweeping,
beam determination,
beam measurement,
beam reporting.

28. The transceiver device of claim 26, wherein all resources within the resource set for SBFD comprise a valid symbol type of SBFD; and/or all resources within the resource set for non-SBFD comprise a valid symbol type of non-SBFD.

29. The transceiver device of claim 28, adapted to transmit only SRS for a single symbol type, e.g.,
if the symbol on which the SRS falls is SBFD, then the resources with respect to SBFD resource set is transmitted or
if the symbol on which the SRS falls is non-SBFD, then the resources with respect to non-SBFD resource set is transmitted.

30. A method for operating a transceiver device such as a user equipment, UE, in a wireless communication network providing a plurality of time resources in a time-frequency grid, the plurality of time resources comprising a first subset of time resources being sub-band full duplex, SBFD, time resources and a second subset of time resources being non-SBFD time resources, the method comprising:
operating the transceiver device based on a spatial relation between the SRS and
a second reference signal or
a second reference signal being the first reference signal or a different reference signal.
